(19) United States
(12) Patent Application Publication
(10) Pub. No.: US 2022/0144517 A1
(43) Pub. Date: May 12, 2022

(54) HYDRO-LIQUID SOLUBLE FILMS, PRODUCTS AND USES THEREOF

(71) Applicant: DECOMER TECHNOLOGY INC., San Francisco, CA (US)

(72) Inventors: Mart SALUMÄE, Tallinn (EE); Kelly KANGUR, Tallinn (EE)

(21) Appl. No.: 17/622,815

(22) PCT Filed: Jun. 25, 2020
(86) PCT No.: PCT/US2020/039471

§ 371 Date: Dec. 25, 2021

Related U.S. Application Data
(60) Provisional application No. 62/865,980, filed on Jun. 25, 2019.

(51) Int. Cl. B65D 65/46; C08J 5/18; A23L 29/262; A23L 29/30; A23L 29/231; A23L 29/269; A23L 29/00

(52) U.S. Cl. CPC B65D 65/466; C08J 5/18; B65D 65/463; A23L 29/262; A23L 29/37; A23V 2002/00; A23L 29/274; A23L 29/35; A23L 29/035; C08J 2301/28; C08J 2305/06; A23L 29/231

(57) ABSTRACT

Films compositions for packaging and delivering a foodstuff, pharmaceutical, industrial, manufacturing and agricultural materials and uses are disclosed. The film can be formed from at least one biodegradable film forming agent, and at least one biodegradable plasticizer. The resulting film can be formed and shaped to a variety of film package configurations and can have multi compartments. The resulting films and film packages can be edible and substantially and/or completely soluble in a cold, cool, warm and/or hot hydro-liquid including water. The film forming agent(s) is compostable and the film has an essential absence of petrochemicals and non-biodegradable plastics/bioplastics.

### PRIORITY

This application claims priority to United States Provisional Application having U.S. Ser. No. 62/865,980, filed Jun. 25, 2019. The contents of which are incorporated herein by reference.

### FIELD

The present teachings relate to preparing films customized to the use, product contents and application for food preparation, delivery, foodstuff, flavorings, detergents, household cleaning products, stain removers, personal health and hygiene products, cosmetics, pharmaceutical packaging, delivery and administration, nutraceuticals, agricultural, manufacturing and industrial uses and environmentally friendly marking, disposal and bagging BACKGROUND

The packaging industry and society at large needs packaging materials and solutions that are eco-friendlier. The reliance on petrochemicals and the dependency on the convenience of disposable materials made entirely or predominantly of plastics has created not only an abundance of recyclable plastics creating greenhouse gases (GHGs) from the point of production to the site of collection for either transport to a recycling center, landfill, garbage barge or incineration. Thus, there remains a need for alternative for film forming and packaging materials and completely new ways of convenience packaging.

The disclosed film forming materials, compositions and products produced with the disclosed innovative films can be substantially and/or completely hydro-liquid-soluble, absent of petroleum-based ingredients that are currently used globally and can be tuned to be used for different applications from home care to food products. Moreover, the disclosed films are produced with low cost, abundant and sustainably sourced ingredients that are also biodegradable, compostable and free of chemicals forming plastic materials or microplastic waste. The current innovations meet the unmet needs for environmentally friendly and responsible film production and utilization of the films in products with no or minimal environmental footprint.

Therefore, there remains a need for creating and producing eco-friendly film packaging and barrier solutions that are convenient, biodegradable and compostable.

### INCORPORATION BY REFERENCE

All publications, references, patents, and patent applications mentioned in the document are herein incorporated by reference to the same extent as if each individual publication, reference, patent, or patent application was specifically and individually indicated to be incorporated by reference. In the event of inconsistent usages between this document and those documents so incorporated by reference, the usage in the incorporated reference should be considered supplementary to that of this document; for irreconcilable inconsistencies, the usage in this document controls.

Reference will now be made in detail to certain claims of the invention, examples of which are illustrated in the accompanying drawings. While the invention will be described in conjunction with the enumerated claims, it will be understood that they are not intended to limit those claims. On the contrary, the invention is intended to cover all alternatives, modifications, and equivalents, which can be included within the scope of the invention as defined by the claims.

### BRIEF DESCRIPTION OF THE DRAWINGS

FIGS. 1A and 1B depict a water-soluble film fashioned from one embodiment of the disclosed films. FIG. 1A is at time 0 seconds and FIG. 1B is after 15 seconds in the water.

FIGS. 2A and 2B depict a water-soluble flavoring package fashioned from one embodiment of the disclosed films. FIG. 2A is at time 0 seconds and FIG. 2B is after the package was immersed in water for 20 seconds.

FIGS. 3A and 3B depict a blendable pre-measured superfood package fashioned from one embodiment of the disclosed films. FIG. 3A is at time 0 seconds when the package was added to water in a countertop blender and FIG. 3B is after the package was blended in water for 10 seconds.

FIGS. 4A and 4B depict a water-soluble detergent pod fashioned from one embodiment of the disclosed films. FIG. 4A is at time 0 seconds and FIG. 4B is after the pod was immersed in water for 60 seconds.

FIGS. 5A, 5B and 5C depict a hot water-soluble package encasing uncooked rice from one embodiment of the disclosed films. FIG. 5A illustrates the filled pre-measured food package, FIG. 5B is the food package submersed in hot water at time zero. FIG. 4C depicts the package after immersion in hot water for 15 seconds.

### DETAILED DESCRIPTION OF VARIOUS EMBODIMENTS

Before the present compositions and methods are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting.

The disclosed films as barriers, packaging and delivering materials offer unique solutions to the dependency on the use and production of polluting plastics and the reliance on petrochemicals for raw materials known to contribute to GHGs. GHGs are generated throughout the sourcing, manufacturing and disposal of packaging waste. The disclosed and claimed film compositions being essential absent of petroleum-based materials instantaneously eliminates carbon entering into an active carbon cycle and provides films that can dissolve readily in hydro-liquids including water, are free of non-degradable bioplastics, can be biodegradable, can be compostable, are eco-friendly, nontoxic, can be edible, and formulated without petroleum-based ingredients and petrochemicals. Additionally, films formulated without animal-based resources precludes raising livestock which are known to generate high levels of GHG emissions.

Sourcing of sustainable sourced plant-based materials, as well as leftover plant-based materials from other uses including, but are not limited to, corn stover/husks, sugarcane, fruit and vegetable pulp, wood harvesting and milling materials, plant-based raw materials that were used in ethanol production, grain silage and milling remnants and the like decrease wastes that might otherwise be composted. Moreover, film forming materials using plant-based materials utilizes less water and electricity for film production and therefore produces an eco-friendly film product.

Absent petroleum-based materials and petrochemicals in the disclosed films results in no production of micro-plastics and use of single-use products in a convenient yet more eco-friendly way when compared to petroleum-based products as well as precluding transfer of infectious agents The use of the disclosed films for unit-dose packages resulting in consistent product volume delivered, potential for increased product concentration which can decrease water transport, more units/package (e.g. concentrated or powdered beverage packages, concentrated detergents) which reduces excess consumption, waste, transportation costs and so GHG emissions.

The disclosed films, which can be edible, offer the unique advantage of also being a film to deliver, within the film composition, a foodstuff, etc. Moreover, the selection of film forming agent(s) for the film composition can also be supplemental cleaning agents in a detergent pod, as well as a delivery tool of powdered toothpaste, mouth wash, cosmetic scrubs and other consumable products. Such products would not contribute to landfill waste, and the film becomes an integral and functioning agent of the consumable product. The films offer the advantage of being colorable and fragment for commercial attractiveness and marketing appeal.

The disclosed innovative films can be used as packaging and/or barrier materials made from alternative materials that are sourced from sustainable resources, eco-friendly and so achieving environmental, societal and regulatory improvements and objectives. The products produced from the disclosed films create new ways for convenience packaging which can eliminate generation of refuse added to landfill waste as well as reduce fear of infectious agent transfer. The disclosed packaging, delivery and barrier films can be formulated for biodegradable and compostable properties. As a result, the disclosed films can be the antithesis of petroleum-based products. Moreover, the disclosed films have tensile strength comparable with petroleum-based products, stretch from 0.1-100 mega pascals and can range from complete transparency to opaque as the end use dictates. Also included in the disclosed films' compositions can be ingredients that can make the base material more suitable for various applications by inclusion of additives, including but not limited to, preservatives, fillers, disintegrants, foodstuff(s), coloring and flavoring agents, nutritional supplements, stickiness reducing powders, dissolution reducers, viscosity reducers and the like as known to one of skill in the art.

The film forming agent(s) and additive(s) in the disclosed innovative film forming compositions can be adapted for different applications including, but not limited to containing detergents, home care, personal care, agriculture products, food products, convenience cooking, pharmaceuticals, manufacturing and industrial components and products, and eco-friendly environmental marking and stewardship as well as yet to be envisioned new materials and novel products. Moreover, in stark contrast to currently used materials sourced from petroleum or animals, that can be expensive, do not have sufficient properties and/or are not feasible to produce the disclosed films are formulated with materials and ingredients that are abundant, low cost and sustainably produced.

### Definitions

Unless defined otherwise, all technical and scientific terms used herein have the same meaning as commonly understood by one of ordinary skill in the art to which this invention belongs. As used herein, the recited terms have the following meanings. The following definitions are included to provide a clear and consistent understanding of the specification and claims. Any methods and materials similar or equivalent to those described herein can be used in the practice or testing of the disclosed invention, as it will be understood that modifications and variations are encompassed within the spirit and scope of the instant disclosure.

References in the specification to “one embodiment,” “an embodiment,” “another embodiment,” and the like, indicate that the described embodiment can include a particular aspect, feature, structure, moiety, or characteristic, but every embodiment may not necessarily include the particular aspect, feature, structure, moiety, or characteristic. Moreover, such phrases are not necessarily referring to the same embodiment. Further, when a particular aspect, feature, structure, moiety, or characteristic is described in connection with an embodiment, it is submitted that it is within the knowledge of one of ordinary skill in the art to effect or connect such aspect, feature, structure, moiety, or characteristic in connection with other embodiments whether or not explicitly described.

It is further noted that the claims may be drafted to exclude an optional element. As such, this statement is intended to serve as antecedent basis for the use of exclusive terminology, such as “solely,” “only,” “other than”, and the like, in connection with any element described herein, and/or the recitation of claim elements or use of “negative” limitations.

The term “and/or” means any one of the items, any combination of the items, or all of the items with which this term is associated. The phrases “one or more” and “at least one” when read in context of its usage are readily understood by one of skill in the art, particularly. For example, the phrase can mean one, two, three, four, five, six, ten, 100, or any upper limit approximately 10, 100, or 1000 times higher than a recited lower limit.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percentages or carbon groups) includes each specific value, integer, decimal, or identity within the range as if each numerical value and sub-range is explicitly recited. As a non-limiting example, each range discussed herein can be readily broken down into a lower third, middle third and upper third, as well as nested ranges within a larger range. As will also be understood by one skilled in the art, all language such as “up to”, “at least”, “greater than”, “less than”, “more than”, “or more”, and the like, include the number recited and such terms refer to ranges that can be subsequently broken down into sub-ranges

For example, a range of “about 1% to about 5%” or “about 0.1% to 5%” should be interpreted to include not just about 1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The term “about” as used herein can allow for a degree of variability in a value or range, for example, within 10%, within 5%, or within 1% of a stated value or of a stated limit of a range. For example, “about 50” percent can in some embodiments carry a variation from 45 to 55 percent. In yet another example, “about 10.0 wt. %” can be between 9.5 wt. % and 10.5 wt. %.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

For integer ranges, the term “about” can include one or two integers greater than and/or less than a recited integer at each end of the range. Unless indicated otherwise herein, the term “about” Is Intended to include values, e.g., weight percentages, proximate to the recited range that are equivalent in terms of the functionality of the individual ingredient, element, the composition, or the embodiment. The term about can also modify the end-points of a recited range as discuss above in this paragraph.

In this document, the terms “a,” “an,” or “the” are used to include one or more than one unless the context clearly dictates otherwise. Thus, for example, a reference to “a component” includes a plurality of such components, so that a component Z includes a plurality of components Z. The term “or” Is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; Information that is relevant to a section heading may occur within or outside of that particular section.

In the methods or processes described herein, the steps can be carried out in any order without departing from the principles of the invention, except when a temporal or operational sequence is explicitly recited.

Furthermore, specified steps can be carried out concurrently unless explicit claim language recites that they be carried out separately. For example, a claimed step of doing A and a claimed step of doing B can be conducted simultaneously within a single operation, and the resulting process will fall within the literal scope of the claimed process.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The phrase “Agricultural item” as used herein can refer to a seed, seed strip, seedling, plant pod for automated gardening systems, sprout, vegetable, fruit, herb, legume, spice, nut, and fertilizer composition. A film of the present invention encasing and/or used to enclose an agricultural item(s) can be used to improve ease of plants, hydration, resist drought, frost, mold, mildew, UV-A and UV-B rays and other adverse environmental factors encountered by an agricultural item during agricultural processes including, but not limited to, planting, growing, harvesting, shipment, transport, storage, and extending shelf-life, as would be understood by one of skill in the art of growing, harvesting, preserving, shipping and transporting agricultural products.

Biodegradable* “When a biodegradable article fabricated with the film(s) of the present invention are buried in a soil, it can be degraded by bacteria, microorganisms or the like. Therefore, the biodegradable article of the present invention would not cause an environmental pollution problem by their waste product, contrary to a container made by general-purpose synthetic plastic. A period of time required for decomposition may vary depending on the composition of the product, environmental condition, and the like. However, it would be in the range of several weeks to several months. Potentially, 6-12 weeks, 12-26 weeks, 30 to 40 weeks, 50 weeks, 12-14 months, 14-18, 18-20 and 20-36 months. Furthermore, depending on the type of product, it can be used as a feed or fertilizer instead of burying it in the soil.” *JP Gilico Nutrition Osaka, JP U.S. Pat. No. 9,963,581B2.

The term “blendable” as used herein can refer to the opening and/or tearing of the disclosed film(s) with the concomitant dissolution and/or pulverization and the release of the contents or composition of the film's/films' packaging, packet(s), and/or pad(s) by blending, shaking, processing, e.g., using a blender, container, food processor, juicer, grinder, pressure cooker, multicooker, mixer and convenience cooking apparatus in the presence of a liquid including, but not limited to, In a hydro-liquid including water. The blendable package, blendable packet and blendable pad can also undergo dissolution in a liquid by immersion and/or boiling, mixing, shaking, stirring, and/or by chemical, physical and/or mechanical means.

The terms “compostable packaging” and “compost packaging” are used interchangeably and can refer to the ability of the disclosed film and packaging ability to biologically decompose and disintegrate in one or more of a commercial and/or industrial composting facility and under home composting conditions. The compostability of the disclosed films and packaging configurations and uses can have broad impacts as an eco-friendly material.

The terms “blend,” “mix,” “chop,” “mince,” “beat,” “froth,” “whip,” “puree,” “crush,” “grind,” “emulsify,” “pound,” and “liquefy” can be used interchangeably and can refer to the processing of an item, including but not limited to an edible item, through at least one mechanical action and/or physical action of an individual holding or machine equipped with for example, including, but not limited to, a blade, whisk, beater (e.g., by rotation), by an action such as pounding and/or forcing the item through an opening including, but not limited to, a sieve, colander, chinols, grinder, strainer, mesh, and filter to break-up and/or disorientate an item.

The phrase “mechanical action” as used herein can refer to an action, including but not limited to, “blend,” “mix,” “chop,” “mince,” “beat,” “froth,” “whip,” “puree,” “crush,” “grind,” “emulsify,” and “liquefy,” “pounding,” “straining,” and “forcing” through a sieve, colander, chinols, strainer, mesh, filter or the physical action of an individual or machine equipped with a blade, whisk, beater (e.g., by rotation) and pestle to break-up and/or disorientate an item. Additionally, the agitation of a washing machine, tearing, twisting, squeezing, pulling, mastication, and food processing a packet or package made with the innovative films disclosed herein are also a form of mechanical action.

The phrase “cellulose derivative” as used herein in reference to a type of “film forming agent” refers to both the cellulose derivatives, the salts and cross-linked versions thereof. Thus, for example, carboxymethyl cellulose (CMC), a cellulose derivative, refers to both the derivative, carboxymethyl cellulose and the salt form thereof, e.g., carboxymethyl cellulose sodium CMC-Na), carboxymethyl cellulose calcium (CMC-Ca).

The phrase “modified starch” as used herein in reference to a type of “film forming agent” refers to both the starch and modified starch, the salts and/or cross-linked versions thereof. Thus, for example, carboxymethyl starch (CMS), a modified starch, refers to both the modified starch, carboxymethyl starch (CMS) and the salt form thereof, e.g., carboxymethyl starch sodium and carboxymethyl calcium.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture, in vitro, or in vivo.

The chemical reaction between the film packaging and a hydro-liquid can be affected by the pH of the hydro-liquid. The hydro-liquid can be acidic, pH below 6.6, neutral, pH 6.6-7.3, or basic, pH 7.3 and above. As used herein, the term “hydro-liquid” can be understood to also support the water solubility and/or dissolution of the film packaging when brought into contact with the “hydro-liquid”.

The term “delivering” as used herein can refer to transporting the disclosed film package, pad, pod, pouch, packet, capsule and other recited configurations herein containing within the film composition and/or encased by the film packaging a foodstuff or consumable that can be released from the film packaging through undergoing at least one of ingesting, adding, preparing, dispensing, opening, extracting, aliquoting squeezing, tearing, dissolution, dissolving, disintegrating either enacted by the end-user or an action or reaction experienced by the packaging.

The term “edible item” as used herein can refer to any coloring, flavoring, food and/or item consumed and/or ingested by an entity that is a member of the Animalia, Plantae, Fungi, Protista and Monera kingdoms.

The term “film forming agent” as used herein can include, but is not limited to, polymers such as polysaccharides obtained from natural substances such as locust bean gum, gum arabic, Fenugreek gum, sodium alginate, xanthan gum, guar gum, tamarind gum, tara gum, gellan gum, psyllium seed gum, dextran, tragacanth gum, konjac gum, cassia gum, gum Arabic, gum Arabic, gum karaya, starch including, but not limited to starch from potato, corn, tapioca and rice; modified starch such as carboxymethyl starch sodium (CMS-Na), cross-linked CMS (sodium starch glycolate), ethoxylated starch, hydroxypropylated starch; hydrolyzed starch such as dextrins, maltodextrin; pullulan, pectin and its salts, including sodium pectinate; semisynthetic polymers such as crystalline cellulose, methylcellulose (MC), ethylcellulose (EC), ethyl methyl cellulose, ethyl hydroxyethyl cellulose (and sodium salt), carboxymethyl cellulose (CMC), carboxymethyl cellulose sodium (CMC-Na), carboxymethyl cellulose calcium, cross-linked CMC (croscarmellose, and sodium salt), hydroxyethylcellulose (HEC), hydroxypropyl cellulose (HPC), hydroxypropylmethylcellulose (HPMC), hydroxyethyl methyl cellulose (HEMC), low-substituted hydroxypropyl cellulose. Also included are aquatic based materials extracted, isolated or derived from agar, carrageenan, sodium alginate and propylene glycol alginate (PSA) and animal-based materials such as gelatin, casein, chitin and chitosan.

It is to be understood that film forming materials as used herein can be used interchangeably and can be, In many cases, functional equivalents of one another.

The terms “enclosed”, “encased,” and “encase” are used interchangeably and as used herein can refer to containing by the disclosed film forming a “package” of at least one item including, but not limited to a foodstuff, flavoring, coloring, additive, detergent, household cleaning product, stain remover, personal health, hygiene product, cosmetic, pharmaceutical nutraceuticals, wellness, agricultural, ingredient and/or component used in manufacturing and industrial processes. The material can be contained within the disclosed films used to form a sealed packet, dose unit package and/or fusion/sealing of at least one layer and/or edge(s) of the disclosed film over and upon itself at the perimeters, positioning and/or layering at least a first layer of the film atop and/or perpendicular to the first layer or a second film layer and fusing/sealing at least one edge of the first film to itself and/or to the edge and/or surface of the second film.

The terms “sealing” and “fusing” can be used interchangeably and as used herein can refer to the joining together/attaching/melting opposing edges, surfaces and edge to a surface of one or more film(s) by application of at least one of sealing process including, but not limited to heat, pressure, moisture, UV light beam, infrared light beam, and laser light beam and combinations thereof. The resulting seal can be impervious to penetration by external fluids and contents sealed within the joined film edges, surface and/or film edge to a film surface are averted from leaking out of the sealed film to the external environment or migrating between film compartments within a package having at least two compartments sharing at least one common film layer separating the at least two compartments.

The terms “film” and “film composition” can be used interchangeably and as used herein, can refer to an article having a much smaller thickness compared with other planar surface dimensions and having a thickness that can be: 0.01 mm, 0.02 mm, 0.03 mm, 0.04 mm, 0.05 mm, 0.06 mm, 0.065 mm 0.07 mm 0.075 mm, 0.08, 0.085, 0.09 mm, 0.095 mm, 0.1 mm, 0.11 mm, 0.12 mm, 0.13 mm, 0.14 mm, 0.15 mm, 0.02 mm, 0.25 mm, 0.3 mm, 0.35 mm, 0.4 mm, can be greater than 0.45 mm, greater than 0.5 mm, greater than 0.6 mm, greater than: 0.7 mm, 0.75 mm, 0.8 mm, 0.85 mm, 0.9 mm, 0.95 mm and up to 21.0 mm to >2.0 mm to 23.0 mm to 24.0 mm and up to 5.0 mm. The film can be used as a wrap, package, packaging, pad, bag, mailer pouch, delivery tool and in a single layer or having more than one layer(s), and in combinations thereof. In one embodiment, the film composition can have a thickness of at least one of 0.01-0.09 mm, 0.01-0.5, 0.01-1, 0.01-3, 0.025-0.09, 0.03-0.08, 0.03-0.09, 0.03-0.12, 0.03-0.5, 0.03-2, 0.03-3, 0.035-0.099, 0.04-0.08, 0.04-0.09, 0.04-0.12, 0.04-0.25, 0.04-0.5, 0.04-2, 0.04-3, 0.05-0.08, 0.05-0.095, 0.05-0.1, 0.05-0.12, 0.05-0.25, 0.05-0.5, 0.05-2, 0.05-3, 0.06-0.085, 0.06-0.09, 0.06-0.1, 0.06-0.15, 0.06-0.25, 0.06-0.5, 0.06-2, 0.06-3, 0.07-0.1, 0.07-0.12, 0.07-0.15, 0.07-0.25, 0.07-2, 0.07-3, 0.08-0.12, 0.08-0.15, 0.08-0.5, 0.08-2, 0.08-3, 0.1-0.25, 0.1-0.5, 0.1-2, 0.1-3, 0.12-0.35, 0.2-0.5, 0.25-1, 0.5-2, 0.5-3, 1-3, 2-5 and 3-5 mm, 1.0 mm, 2.00 mm, 3.0 mm, 4.0 mm, and up to 5.0 mm, 3-15, and 5-18 mm.

The term “flavoring” as used herein can include but is not limited to essential oils or extracts of essential oils or extracts of menthol, wintergreen, peppermint, sweet mint, spearmint, vanillin, cherry, butterscotch, chocolate, almond, cinnamon, clove, lemon, orange, raspberry, rose, spice, violet, herbal, fruit, strawberry, grape, pineapple, vanilla, peppermint, peach, kiwi, papaya, mango, coconut, apple, coffee, plum, watermelon, nuts, green tea, grapefruit, banana, butter, or chamomile. As well as salt, pepper, onion, garlic, and saffron as known to the skilled artisan. Also envisioned are edible oils including, but is not limited to rapeseed, olive, walnut, hazelnut, almond, safflower, canola, corn, coconut, pumpkin seed, avocado, fish, omega 3, omega 6, hemp, truffle, thyme, Algae, oregano, argan, perila, lavandula, poppy seed, presscake, cherry pit, pine nut, peppermint, tarragon, vegetable, sesame, dill, grape seed, camelia seed, sunflower, manula, peanut, soybean.

The term “hydro-liquid” and can refer to any liquid used as a solvent for dissolving and/or disintegrating the disclosed films and products made therefrom. Hydro-liquids include, but are not limited to, at least one of water, vegetable juice, fruit juice, milk, cream, coffee, tea, vinegar, wine, beer, cider, spirits, broth, stock, soup and combinations thereof.

The hydro-liquid can also include, but is not limited to, water, a mixture of a prepared cement, concrete, plaster, paint, water-oil mixtures and emulsions, paper pulp, dyes, water-based mixtures, and mixtures that can have a hydro-liquid as a base.

The phrase “milk product” as used herein can refer to milk produced in a dairy as well as milk that is plant based. Plant milk products can include, but are not limited to almond milk, coconut milk, rice milk and soy milk. Dairy milk can be produced by an animal such as a cow, goat, buffalo, sheep, horse and camel. Products produced from either plant or dairy milk can include, but are not limited to yogurt, a milk, a cream, butter, cheese, curd, quark, créme fraiche and the like but is intended to also include animal or plant milk products as are known in other cultures, geographical locations and societies.

The present teachings can be implemented by the selection of biodegradable, compostable, and substantially and/or completely hydro-liquid-soluble ingredients. Such ingredients are abundant, sustainable, renewable and can substantially reduce, if not eliminate, waste materials transported to landfills or on garbage barges for disposal. The use of the disclosed films in packaging and other applications as disclosed herein, can result in reduced Green House Gas (GHG) emissions normally associated with the transport, burning, waste treatment and other refuse and waste issues including disposal methods. Importantly, the disclosed films can substantially reduce the pollution of the environment, oceans, atmosphere and beyond with microplastics which are becoming an ever more urgent concern and danger to sustaining a healthy living environment for all species.

It should be understood that the disclosed edible films should be made with materials approved for food use in humans. The material selection can be based on the approved materials within each country where the films are sold, produced as well as where the products made with the disclosed films are produced, sold and/or would be consumed.

Film-Forming Agents

The packaging industry, including films and shrink-wrap films used to wrap products including, but not limited to, foods, paper products, furniture, wrapping of pallets of goods and the like is continually challenged to convert to less polluting plastics which remain heavily dependent on petrochemicals for raw materials. Petrochemicals used in the film and packaging industries are known to contribute to GHGs which are generated throughout the sourcing, manufacturing and disposal of film and packaging waste. The majority of water-soluble films are made from polyvinyl alcohol (PVOH) polymers. PVOH is a fully synthetic polymer and film-forming agent included in water-soluble films, that are poorly soluble in water and difficult to thermoform (high molecular weight PVOHs) where as low molecular weight PVOH polymers can be too reactive to residual moisture to function in a commercial or consumer setting but can have good cold water solubility.

In contrast, the disclosed films' raw materials originate from natural and semi-synthetic polymers disclosed herein including a plant-based PVOH (pb-PVOH). Such film properties can be an important decision point for consumers when making purchases, especially for edible, health and wellness products.

Described herein are innovative film forming compositions that surprisingly solves the demand for convenience packaging and film barriers while substantially reducing GHGs, eliminating microplastic pollution and can therefore revolutionize the packaging and film packaging industry. The disclosed embodiments provide a film(s) that dissolve readily in water/hydro-liquids, is free of plastics, biodegradable, compostable, eco-friendly, nontoxic, can be edible, and has been formulated without petrochemicals. Additionally, the films of the disclosed compositions can be used in a variety of film thicknesses, including but not limited to use as a wrap, delivery tool, package, packet, packaging, bag, mailer pouch and in a single layer or having more than one layer(s), to form dividers and/or compartments and in combinations thereof, Therefore, the disclosed films can facilitate us of materials with characteristics of plastics without the accompanying issues of contributing to GHGs and wastes currently generated at the expense of planet Earth, its land, water, atmosphere and inhabitants therein.

A biodegradable film of the present invention can have one or more film forming agents that can be substantially or completely hydro-liquid-soluble including, but not limited to, polysaccharides, and derivatives thereof, heteropolysaccharides and derivatives thereof and their salts respectively, as well as materials originating and/or derived from plant, animal and vegetable-based sources. Film-forming agents can include, but are not limited to cellulose derivative(s), their salts, modified and cross-linked versions thereof including, but not limited to CMC, CMC-Na, and starch(s), CMS, CMS-Na. Additional polysaccharides and polymers include, but are not limited to: gelatin, pectins and salts thereof, guar gum, xanthan gum, pullulan, sodium alginate and croscarmellose as non-limiting examples of film forming agents that can be used both individually and in combinations thereof with or without gelling agents, plasticizers and other additives infra to formulate the films of the disclosed innovation. For edible applications, the film forming agents (or additives added into the film) can have an additional value besides just being a neutral film forming material, e.g., a nutritional value including, but not limited to, contain dietary fibers including, but not limited to, pectin, alginates, CMC, CMS and derivatives thereof, the salts and cross-linked versions thereof.

Film forming agent(s) can be present in a film composition of the present invention in any one of the following wt. % ranges based on dry film weight: 5-95, 5-15, 5-25, 5-30, 10-40, 30-90, 25-95, 25-75, 25-55, 27-55, 27-75, 27-95, 30-55, 30-70, 30-95, 35-90, 35-45, 35-50, 35-55, 35-60, 35-65, 35-75, 35-80, 35-85, 35-95, 40-50, 40-55, 40-60, 40-65, 40-70, 40-75, 40-80, 40-85, 40-90, 40-95, 45-55, 45-60, 45-65, 45-70, 45-75, 45-80, 45-85, 45-90, 45-95, 50-60, 50-65, 50-70, 50-75, 50-80, 50-85, 50-90, 50-95, 55-65, 55-70, 55-75, 55-80, 55-85, 55-90, 55-95, 60-70, 60-75, 60-80, 60-85, 60-90, 60-95, 65-75, 65-80, 65-85, 65-90, 65-95, 70-80, 70-82, 70-85, 70-90, 70-95, 75-85, 75-90, 75-95, 80-90, 80-95, 85-95, 1-99, 5-99, 25-99, 90-99 wt. % total biodegradable film forming agent based on dry film weight. In one embodiment the film forming agent comprises 30-95 wt. % by dry film weight of the film composition.

Cellulose Derivatives

Chemical reactions can selectively modify some of the hydroxyl groups within the hundreds to thousands of linked D-glucose units forming the linear cellulose polysaccharide chains. The resulting cellulose derivatives can result in alterations of properties that can prevent, obtain or improve hydro-liquid solubility and modify properties of films and solutions for a variety of applications. The polysaccharide chains of D-glucose can be reacted with a variety of organic solvents including but not limited to, chloromethane, chloroethane alone and in combination to form Alkyl cellulose ethers and salts thereof or with ethylene oxide, propylene oxide, chloromethane, chloroethane and chloroacetic acid to form hydroxyalkyl cellulose ethers and salts thereof. The salts can be sodium and/or calcium salts of the cellulose derivatives. Additionally, it is possible to include cellulose amides and salts thereof.

Non-limiting examples of cellulose derivatives include, but are not limited to, methylcellulose (MC), ethylcellulose (EC), ethyl methyl cellulose, ethyl hydroxyethyl cellulose (and sodium salt), carboxymethyl cellulose (CMC), carboxymethyl cellulose sodium salt (CMC-Na), carboxymethyl cellulose calcium, cross-linked CMC (and sodium salt), hydroxyethylcellulose (HEC), hydroxypropyl cellulose (HPC), hydroxypropylmethylcellulose (HPMC), hydroxyethyl methyl cellulose (HEMC), and low-substituted hydroxypropyl cellulose. Cellulose derivatives can be degraded by cellulase enzymes which hydrolyze glycosidic linkages. Such cellulose derivatives are readily available from, for example, Millipore Sigma, SKU Nos.: C5678, C4888, C5013, C4981, and 419273 and Fisher Scientific, Catalog No. AC332611000, CAS #9004-32-4. Cellulose derivatives can be used from between 30-99 wt. % and ranges within this range in formulating the film forming composition depending upon the use and product produced from the resulting film.

Cellulose derivatives have the advantage of being wide-spread, as they are made from cellulose, the most abundant organic polymer on Earth. Modified celluloses, such as CMC are already produced on a large scale for other uses, especially thickeners. This means that CMC is readily available, cost-effective and known to consumers. CMC is also used in vegan and gluten-free products including baking and as thickeners. Therefore, CMC can also be suitable for food product and hypoallergenic product uses.

For fast water-soluble materials, low molecular weight cellulose derivatives are preferred. The selection of the cellulose derivative can include a single cellulose derivative which has both a low molecular weight (MW) component and a high MW component. Such a cellulose derivative can be further treated to result in cross-linking of the two MW components to improve, for example but not to be limited to, a property of the film such as slowing dissolution of the film due to cross-linking, as there could be improvement in tensile strength but the film's fragility could also be a possible concern, as would be known to an artisan skilled in the art. The combination of CMC and maltodextrin in the film composition has been observed to slightly improve film dissolution. This combination and others can also be used to tune/adapt the film's dissolution temperature, rigidity, texture and possibly strength as known to the skilled artisan.

It is noted that weak acids including, but not limited to, citric acid, ascorbic acid, when included in the film composition containing a cellulose derivative film forming agent(s) results in a synergistic affect to reduce dissolution of the resulting film. The tuning can be a consequent of intra- and intermolecular cross-linking between polysaccharide molecules within cellulose as initiated by presence of weak acid in the film composition. Additionally, lowering pH by the weak acid can decrease a film's dissolution rate, for example due to neutralizing anionic groups. This ‘tuning” of the disclosed films' dissolution properties for increased, delayed and/or prolonging dissolution, can extend applications, use cases and/or shelf life of the film, barrier film and film package when containing or exposed to for example, but not limited to, a higher moisture content, e.g., about 1-10%, >10-20%, >15-25%, >20-30%, >25-35%, >30-40%, >35-45%, >40-50%, >55-65%, >60->70%, >65-75%, >70-80%, >75-85%, >80-90%, >85-95%, and >90-100% moisture of a foodstuff, consumable, and/or environmental condition(s). Similarly, a barrier film that can also be used as a mulch film made with the disclosed film, as an alternative to a petroleum-based plastic mulch film, can be tuned to withstand heavy rains, irrigation and high soil moisture for an extend period of time, perhaps as long as 2-6 months or longer. Alternatively, cross-linked forms of CMC-Na and CMS-Na also can have a greater level of film expansion, similar to if a disintegrent were included in the film composition, as dissolution rate could be slightly increased.

The disclosed packaging film composition can be tuned to be more or less soluble or resistant to solubility depending upon the moisture content of a foodstuff, consumable, and/or environmental condition(s) to which the package film can be exposed to and/or in contact with for its Intended use. The following % ranges, based on the % moisture content of an item(s) encased by the disclosed film(s) and/or the moisture as measure by humidity in the environment in which the disclosed film can be stored (either short or long term), transiently exposed, immersed, or come into contact on at least one film surface, can be: 1-10, 10-20, 15-25, 20-30, 25-35, 30-40, 35-45, 35-50, 35-55, 35-60, 35-65, 40-45, 40-50, 40-55, 40-60, 40-65, 40-70, 40-75, 40-80, 40-85, 40-90, 40-95, 45-55, 45-60, 45-65, 45-70, 45-75, 45-80, 45-85, 45-90, 45-95, 50-60, 50-60, 50-65, 50-70, 50-75, 50-80, 50-85, 50-90, 50-95, 55-65, 55-70, 55-75, 55-80, 55-85, 55-90, 55-95, 60-70, 60-75, 60-80, 60-85, 60-90, 60-95, 65-75, 65-80, 65-85, 65-90, 65-95, 70-80, 70-85, 70-90, 70-95, 75-85, 75-90, 75-95, 80-90, 80-95, 85-95, 90-99 as well as 100.0% moisture of at least one foodstuff, consumable, and/or environmental condition(s) in contact on at least one film surface of the disclosed film(s).

The film formed from one or more cellulose derivative(s) alone and/or in combination with other film forming agents and/or additives can be cold water-soluble (less than 30° C.), hot water-insoluble, or both cold, including cool (25-45° C.), warm (30-60° C.), and hot water-soluble (over 60° C.). The disclosed innovations have utilized polysaccharides and other materials supra, including, but not limited to, cellulose derivatives to develop hydro-liquid-soluble, biodegradable, compostable films for a variety of purposes. Additionally, the disclosed films can be formulated to control the rate of dissolution in a hydro liquid or due to the moisture content of materials encased within the disclosed films formed as packets, packages, and the like. Moreover, the disclosed films can be edible, based on the materials selected and the desired use case infra, and thus the disclosed films can eliminate plastics used in packaging, packaging waste and associated waste disposal issues. As a derivative of cellulose, a plant component, cellulose derivatives are both biodegradable and compostable. (//en.wikipedia.org/wiki/Cellulose).

Croscarmellose

Croscarmellose is actually sodium croscarmellose and results from internal cross-linking of carboxymethyl cellulose sodium. Cross-linking reduces hydro-liquid solubility but the material acts like a sponge to absorb many times its own weight in water and hydro-liquids. The result is a decrease in dissolution and disintegration, both useful in the drug industry for delivery and bioavailability of active ingredients for better absorption by bodily fluids (//en.wikipedia.org/wiki/Sodium_croscarmellose) and for containing high moisture ingredients over a period of weeks without leaking of the contents from a film packet formed with croscarmellose either alone or in combination as a film forming agent. As a cellulose derivative, sodium croscarmellose is biodegradable, compostable and produced from cellulose, the most abundant organic polymer on Earth, thus, a sustainable film forming material.

The inventors note that biomaterials originally from petroleum sources—such as biofuels are continuously being developed for reducing adverse environmental impact and potentially recycling agricultural waste materials, such as plastic mulch. It is in this regard that both PVOH and polyvinylpyrrolidone (PVP) as water-soluble polymeric materials could be envisioned to be used in biodegradable films if and when they are derived from plant- (pb-) or prokaryotic-based (pkb-) sources which can require genetic engineering to achieve these materials as products or by-products of processing.

Starches and Modified Starches

Starches are polysaccharides formed by joining a multitude of glucose molecules by glycosidic bonds to form the most common carbohydrate in the human diet. It is produced by plants and is used to store energy. Starch is about 20 to 30% amylose, a long, linear-chain polysaccharide of D-glucose molecules that is cold water insoluble and 70-80% amylopectin, having short, highly branched chains of α-glucose and is cold water soluble. Starch can be degraded by hydrolysis into constituent sugars by amylase enzymes. Modified starches result from chemical modification of the starch and include, but are not limited to, acid-treated- and alkaline-treated starch, carboxymethyl starch (CMS), cross-linked CMS (sodium starch glycolate), ethoxylated starch and hydroxypropylated starch. Hydrolysis of starch can result in the formation of dextrin and maltodextrin. The yeast Aureobasidium pullulans produces pullulan, a polysaccharide polymer from starch. Despite its relatively high price, pullulan is known to dissolve in water fast.

It is noted that a 50/50 mixture of CMS:cross-linked CMS can dissolve in water but has slower rate of solubility. Starches and modified starches can be used from between 30-99 wt. % and ranges within this range in formulating the film forming composition depending upon the use and product produced from the resulting film. As plant components, starches and modified starches are both biodegradable and compostable.

Gelatin

Gelatin is derived from hydrolyzed collagen, a structural protein which makes up connective tissues within the extracellular space of animals. Hydrolysis of collagen is irreversible and results in the formation of gelatin. It is used as a gelling agent in foods, medications, photographic films and papers, and cosmetics. Gelatin is readily soluble in hot water and forms a gel upon cooling but poorly dissolves in cold water. The stability of a gelatin is only within a narrow temperature range with the upper limit close to its melting point, about 35° C. and the lower point near the freezing point that ice crystallizes. At about 4° C. the viscosity of a gelatin/water mixture is at its highest when the gelatin concentration is high.

Other proteins or materials including, but not limited to, proteins derived from animals, plants, fungi and produced recombinantly can be used in the disclosed film forming compositions including, but are not limited to, casein—a phosphoprotein found in mammalian milk and salts thereof, e.g., sodium caseinate, chitin—a polysaccharide found in the exoskeleton of arthropods and in cell walls of fungi and chitosan—the glucose derivative produced from shrimp shells by treatment of chitin with an alkaline substance such as sodium hydroxide. Gelatin and other proteins and material can be used from between 30-99 wt. % and ranges within this range in formulating the film forming composition depending upon the use, encased content, and product produced with the resulting film. Gelatin is both biodegradable and compostable (//en.wikipedia.org/wiki/Gelatin).

Plant-based proteins can include, but are not limited to, soybean derived products such as tofu, tempeh and edamame, lentils, chickpeas, peanuts, almonds, spirulina, quinoa and mycoprotein. Many plant-based proteins can be made into pulps, flours and oils used in the disclosed film compositions as film forming agents, plasticizers, emulsifying agents, viscosity adjusters and the like. These plant-based proteins can also be used as food additives, nutritional and/or dietary supplements.

Pectin

The cell walls of terrestrial plants contain pectin, a heteropolysaccharide, i.e., having more than one type of monosaccharide. It is primarily isolated from citrus fruits, functions as a stabilizer in fruit juices, used in sweets and medicines. In food it is used as a gelling agent, thickening agent and stabilizer. It is generally regarded as safe for consumption in the United States. Pectin can be used from between 10-80 wt. % and ranges within this range in formulating the film forming composition depending upon the use and product produced from the resulting film. As a plant extract, pectin is both biodegradable and compostable (//en.wikipedia.org/wiki/Pectin).

Portions of the carboxyl group in the pectin molecule occur as methyl esters, and the remaining carboxyl groups exist in the form of the free acid or as its ammonium, potassium, or sodium salts including, but not limited to, e.g. sodium pectinate and in some types as the acid amide. Thus, the pectins envisioned herein can be any one of the high-ester pectins, low-ester pectins, amidated pectins, pectinic acids, and pectinates. Pectins are classified as high- vs. low-methoxy pectins (high HM-pectins vs. Low LM-pectins), with more or less than half of all the galacturonic acid esterified. Some pectins can be considered as film forming agents with a slightly lower solubility speed but higher resistance to humid environments. The film's applications determine the choice of pectins. Some pectin salts, such as the sodium salt, have been shown to have a faster dissolution rate than regular pectin.

Pectin can be produced commercially by extracting citrus peel, apple pomace, or beet pulp with hot dilute acid (pH 1.0 to 3.5, 70° C. to 90° C.). The extract can then be filtered, and pectin precipitated from the clear extract with ethanol or isopropanol, or as a copper or aluminum salt. The acid extract can be a spray- or roller-dried, or it can be concentrated to sell as liquid pectin. More information can be found at: (https://www.accessdata.fda.gov/scrits/cdrh/cfdocs/cfcfr/CFRSearch.cfm?fr=184.15 § W.

Pectin, as a soluble dietary fiber of plant origin, often produced from fruit products' manufacturing leftovers, is an example of environmentally friendly, nutritious, and healthy material for use in food, health and wellness products.

Additionally, pectin can be presumed to contribute to health benefits including, but not limited to, gut health, cholesterol, diabetes, high blood pressure, cognition, etc.

Galactomannan Polysaccharides

Galactomannans consist of a mannose backbone with galactose side groups i.e. a (1-4)-linked β-D mannopyranose backbone with links to α-D-galactose at branchpoints from the mannopyranose positions (i.e. 1-6-linked α-D-galactopyranose). Galactomannans can increase the viscosity of the water/hydro-liquid phase in food products and are used as stabilizers and thickeners in food.

Galactomannan polysaccharides can be used from between 30-99 wt. % and ranges within this range in formulating the film forming composition depending upon the use and product produced from the resulting film. Based on the ratio of mannose-to-galactose, different galactomannan gums can result (//en.wikipedia.org/wiki/Galactomannan).

Fenugreek gum: An ˜1:1 mannose:galactose ratio is found in fenugreek gum produced from the annual plant Trigonella foenum-graecum. Fresh leaves, sprouted seeds and greens are used individually and combined in curries, salads, pickles, pita bread in cuisines from the Indian subcontinent east to the Mediterranean Sea and throughout the Middle East. At low levels the roasted seeds can impart a maple syrup or caramel flavor and at higher concentrations the seeds and leaves impart the aroma of fenugreek and curry. It is used as a flavoring agent and emulsifier (//www.altrafine.com/fenugreek-gum-powder?utm_source=bing&utm_medium=cpc&utm_campaign=Altrafine Gums&utm_term=Fenugreek Gum&utm_content=Fenugreek Gum Powder).

Guar gum: The extract from guar beans is called guar gum or guaran and has a ratio of ˜2:1. It has thickening and stabilizing properties and is used in food, feed and industrial applications. It is more soluble than locust bean gum (LBG) because of extra galactose branch points but is not self-gelling like LBG (//en.wikipedia.org/wAkVGuar_gum).

Tare gum: An ˜3:1 ratio is found in tare gum, produced by grinding the endosperm separated from the seeds of the shrub or tree Tara spinose, native to Peru. It is similar to guar and locust bean gums and is used as a thickening agent and stabilizer in the food industry. A solution of tara gum is less viscous than a guar gum solution of identical concentration but is more viscous than the same concentration of a locus bean gum solution. A 1% aqueous solution of tara gum has a viscosity of 5,500 Cps with intermediate acid stability between locust bean gum and guar gum and has a high-temperature stability of up to 145° C. When tara gum is blended with starches and modified starches the blends have been found to have enhanced emulsification and stabilization properties (//en.wikipedia.org/wik/Tara_spinosa-Uses).

Locust bean gum: LBG is also known as carob gum has a ratio of ˜4:1. It is made from the seeds of the carob tree. It is dispersible in either cold or hot water and soluble in hot water (//en.wikipedia.org/wiki/Locust_bean_gum).

Cassla gum: Can be used as a flour produce from the endosperm separated from the seeds of the plant Senna obtusifolia and S. tora (also known as Cassia obtusifolia and C. tora). Cassia gum is approved for use in food in Japan and in animal (pet) food in the United States. It is used as a thickener and gelling agent and has a mannose:galatose ratio of 5:1 (//en.wikipedia.org/wiki/Cassia_gum). As components of plants, galactomannans are both biodegradable and compostable??

Xanthan Gum

Xanthan gum is produced by the fermentation of glucose and sucrose using the bacteria Xanthomonas campestris, from which its name is derived. Pentasaccharide repeat units in a molar ratio of 2:2:1 of glucose:mannose:gluouronic acid, respectively, comprise the polysaccharide. Xanthan powder is readily soluble in water and brine (//en.wikipedia.org/wiki/Xanthan_gum). Being derived from fermented simple sugars, Xanthan gum is biodegradable, compostable and a sustainable material.

Other Gums

Numerous gums are known to the skilled artisan and can be utilized in producing the disclosed films. Such gums include, but are not limited to, konjac gum, gellan gum, gum Arabic, gum tragacanth and gum karaya. These gums can be used from between 30-99 wt. % and ranges within this range in formulating the film forming composition depending upon the use and product produced from the resulting film.

Aquatic Sources of Film-Forming Materials

Film-forming materials sourced from seaweed can include, but are not limited to, agar, carrageenan and alginates. Because all (red, green and brown) algae and seaweed are sustainable natural resources the alginates derived therefrom are also biodegradable and compostable materials. Aquatic sources of film forming agents can be used from between 30-99 wt. % and ranges within this range in formulating the film forming composition depending upon the use and product produced from the resulting film.

Alginates

Algin is a polysaccharide distributed throughout the cells walls of brown algae and brown seaweeds. Sodium alginate is the sodium salt and calcium alginate is the calcium salt of alginic acid, respectively. Alginates result from alginic acid (algin) salting with metals such as sodium and calcium to form salted forms called alginates.

Alginates are approved for food use and are used extensively in textile printing, pharmaceuticals and food industries. It can be used as a thickening or gelling agent (//en.wikipedia.org/wiki/Alginic acid).

Propylene glycol alginate (PGA) is derived from kelp as an ester of alginic acid. The ester of alginic acid has some carboxyl groups esterified with propylene glycol, some have been neutralized with an appropriate alkali and others remain free.

PGA has uses in food products as an emulsifier, stabilizer and thickener and has food additive E number E405.

Plasticizers

Plasticizer(s) impart a flexibility to a film and can be incorporated in a range from 0.1-70 wt. % of the total dry weight of the film (including intervals within the range) depending on the desired mechanical properties, including, but not limited to, tensile strength, elasticity, tear-resistance or not, film formation method to be used, surfaces the film will contact during formation, film drying time, and the like as known to the skilled artisan. At higher levels of plasticizer, the film's flexibility can increase however, the tensile strength can decrease and the film's surfaces can develop a sticky feel as known to the skilled artisan. Plasticizers can be used alone and in combination from between <0.1-70 wt. % and ranges within this range in formulating the film forming composition depending upon the use and product produced from the resulting film. Examples of sugar alcohols and sugars that can be used as a plasticizer either alone or in combination include, but are not limited to, Glycerol, sorbitol, xylitol, isomalt, maltitol, mannitol, erythritol, arabitol, lactitol, threitol, ribitol, galactitol, fucitol, iditol, inositol, volemitol, maltotritol, maltotetraitol, polyglycitol, steviol and stevia, steviol glycosides, glucose, fructose, trehalose, sucralose, sucrose, maltodextrin, and polydextrose.

Weak acids can also function as plasticizers and can include, but are not limited to, citric acid, ascorbic acid as well as glycols including, but not limited to, ethylene glycol, propylene glycol, polyethylene glycol, diethylene glycol, dipropylene glycol, and triacetin.

Linear saturated dicarboxylic acids can function as plasticizers, including but not limited to oxalic acid, malonic acid, succinic acid, glutaric acid, adipic acid, pimelic acid, suberic acid, azelaic acid, sebacic acid, undecanedioic acid and dodecanedioic acid.

Plasticizer(s) can be present in a film composition of the present invention in any one of the following wt. % ranges based on dry film weight: 5-60, 0.1, 0.5, 1.0, 1.5, 2.0, 2.5, 3.0, 3.5, 4.0, 4.5, 5.0, 5.6, 6.0, 6.5, 7.0, 7.5, 8.0, 8.5, 9.0, 9.5, 10.0, 0.1-70, 1-35, 1-60, 5.0-10.0, 5.0-15.0, 5.0-20, 5.0-30, 5.0-35, 5.0-40, 5.0-45, 5.0-50, 5.0-55, 5.0-60, 5.0-70, 10-15, 10-20, 10-30, 10-35, 10-40, 10-45, 10-50, 10-60, 10-70, 15-25, 15-30, 15-35, 15-40, 15-45, 15-50, 15-55, 15-60, 15-70, 18-25, 18-28, 18-40, 20-25, 20-30, 20-35, 20-40, 20-45, 20-50, 20-55, 20-60, 20-70, 22-35, 22-45, 22-60, 25-40, 25-45, 25-50, 25-55, 25-60, 25-65, 25-70, 26-55, 30-40, 30-45, 30-50, 30-55, 30-60, 30-70, 35-45, 35-50, 35-55, 35-60, 35-70, 40-45, 40-50, 40-55, 40-60, 40-70, 45-50, 45-55, 45-60, 45-70, 50-55, 50-60, 50-70, 55-60, 55-70, 60-70, and 65-70 wt. % total of biodegradable plasticizer(s).

Additives for Use in Producing Films

The additives selected for inclusion in the disclosed innovations for biodegradable film forming compositions can be selected for adding and/or imparting desired properties to the finished film. Such properties can include, but are not limited to, hydro-liquid/water-solubility, hydro-liquid/water-insolubility, dissolution, disintegration, film: strength, stretch, flexibility, impervious to air and/or moisture penetration, viscosity and resistance to leaking due to the moisture content of the item(s) encased/contained within the film package. The formulation of the film can also have criteria to be met for ease of film formation including, but not limited to, the viscosity, concentration of the film forming agent(s) as well as its granular size, solubility, rate of gelling, preservatives, effervescent(s), emulsification and surfactant agents, softening agents to impart smooth, pliable/bendable properties, solubility reducers, anti-foaming agents, fillers, and powders to preclude tacky or stickiness added either within the film forming composition and/or on the film's surface(s). The film's appearance, color, flavor, taste, and odor can also be impacted through the use of colorants, dyes, oils, perfumes and scenting agents, sweeteners, herbs, and spices.

An additive(s) can be present in a film packaging composition of the present invention in any one of the following wt. % ranges based on dry film weight: 0.1, 0.5, 1.0, 1.5, 2.0, 2.5, 3.0, 3.5, 4.0, 4.5, 5.0, 5.6, 6.0, 6.5, 7.0, 7.5, 8.0, 8.5, 9.0, 9.5, 10.0, 0.1-5.0, 5.0-10.0, 5.0-15.0, 5.0-20, 5.0-30, 5.0-40, 5.0-50, 5.0-60, 5.0-70, 10-15, 10-20, 10-30, 10-35, 10-40, 10-45, 10-50, 10-60, 10-70, 15-25, 15-30, 15-35, 15-40, 15-45, 15-50, 15-60, 15-70, 20-25, 20-30, 20-35, 20-40, 20-45, 20-50, 20-55, 20-60, 20-70, 25-40, 25-45, 25-50, 25-55, 25-60, 25-70, 30-40, 30-45, 30-50, 30-55, 30-60, 30-70, 35-45, 35-50, 35-55, 35-60, 35-70, 40-45, 40-50, 40-60, 40-70, 40-55, 45-50, 45-55 45-60, and 45-70 wt. % of at least one additive, +/−20 wt. % of select additives, as noted infra.

Fillers

The use of fillers in the disclosed film compositions can reduce raw material costs, increase or decrease viscosity or potentially strengthen a film. Examples of fillers include, but is not limited to, gluconic acid and its salts, including potassium gluconate and sodium gluconate, and maltodextrin. Nano- and microcrystalline celluloses, corn starch, potato starch, tapioca starch, rice starch can also be used as fillers. Fillers can be used alone and in combination from between 5-60 wt. % and ranges within this range in formulating the film forming composition depending upon the use and product produced from the resulting film.

Preservatives

Preservatives can be incorporated into a film to increase shelf-life, prevent or retard microbial or fungal growth and/or oxidation and resist adverse environment effects such as moisture, fire, high heat, excessive cold which could be encountered during transport or during real-world applications and uses. Examples of materials that can have a preservative effect when incorporated into to the disclosed film forming compositions include, but are not limited to, chitosan, citric acid, ascorbic acid, maleic acid, folic acid, tartaric acid, fumaric acid, salts, sugars (see Plasticizers supra), hops, vinegar, alcohol, rosemary, castor oil, sorbates, sorbic acid, sodium sorbate, benzoates, benzoic acid, sodium benzoates, hydroxybenzoate and derivatives, sulfur dioxide and sulfites, nitrites, nitrates, lactic acid, sodium and potassium lactate salts, propionic acid and sodium propionate, ascorbic acid, sodium ascorbate, gallic acid, sodium gallate, and tocopherols as known to the skilled artisan. Preservatives can be used alone and in combination from between 0-10 wt. % and ranges within this range in formulating the film forming composition depending upon the use and product produced from the resulting film. Preservative additives can be used alone and in combination from between 0-10 wt. % and ranges within this range in formulating the film forming composition depending upon the use and product produced from the resulting film.

Disintegrants

Disintegrants function in the dissolution and solubilization of materials in a solvent or solution. They act by swelling the film, expanding the film's volume by absorption of the liquid. Examples of materials that can have a disintegrant effect when incorporated Into the disclosed film forming compositions include, but are not limited to, croscarmellose (cross-linked (Na+) CMC), sodium starch glycolate, and cross-linked polyvinylpyrrolidone (if made from plants in the future). Disintegrants can be used alone and in combination from between 0-50 wt. % and ranges within this range in formulating the film forming composition depending upon the use and product produced from the resulting film.

Effervescent Additives

The use of Effervescent additives in the disclosed film's solution compositions and/or applied on or contained within the disclosed films are envisioned. As an example, materials that can have an effervescent effect include, but are not limited to, the reaction of citric acid+sodium bicarbonate (NaHCO₃) powders. Both powders can be incorporated in the disclosed film's composition or one in the film forming composition and the other applied on the film surface or encased within the film. An effervescent frothing/bubbling is created upon solubilization of the powders that hastens dissolution of the film when exposed to a hydro-liquid. Effervescent additives can be used alone and in combination from between 0-50 wt. % and ranges within this range in formulating the film forming composition depending upon the use and product produced from the resulting film.

Viscosity Reducers

The viscosity of the disclosed film forming composition can be a consideration when considering the method for forming the film to a required thickness, shape, speed of manufacturing and so on as would be known to the skilled artisan. An increase in speed of dissolution can be achieved by including a viscosity reducer in the disclosed film's composition. Examples of materials that can have viscosity reduction effect depending on the polysaccharide, heteropolysaccharide, protein, gum, seaweed sourced or animal sourced film forming agent(s) used in the disclosed films' solution compositions include, but are not limited to, sodium chloride, lithium chloride, potassium chloride, sodium sulfate, tetra sodium phosphate, Na₄P₂O7₄, and the decahydrate form, and sodium chloride with caustic soda. Viscosity reducers can be used alone and in combination from between 0.5-50 wt. % and ranges within this range in formulating the film forming composition depending upon the use and product produced from the resulting film. It is noted that addition of a salt before a film forming agent reduces the hydro liquid's viscosity but the reverse order of addition may not produce the same viscosity effect.

Emulsifiers, Surfactants and Softening Agents

Emulsifiers can aid in the miscibility of otherwise immiscible liquids, e.g., oil and water/hydro-liquids. Surfactants can add in reducing the surface tension between two liquids, between a gas and a liquid and between a liquid and a solid.

Surfactants can act as detergents, dispersants, wetting agents, emulsifiers and foaming agents. Softening agents can decrease the rigidity and fragility of the disclosed films imparting ease of bending, passing around, over or under small diameters and folding without cracking or tearing. Examples of materials that can have an emulsifying, surfactant or softening effect when incorporated into the disclosed film forming compositions include, but are not limited to, lecithins extracted from soy, sunflower, rapeseed, cottonseed, eggs, milk and the like, polysorbates, polyoxyethylene alkyl ethers, polyoxyethylene castor oil derivatives, glycerol monostearate, and the mono and diglycerides of fatty acids. Emulsifiers, surfactants and softening agents can be used alone and in combination from between 0.1-5 wt. % and ranges within this range in formulating the film forming composition depending upon the use and product produced from the resulting film.

Solubility Reducers

Solubility reducers can be used to aid in the dissolving of a solute in a solvent. The solute chemical substance and the solvent can be a solid, liquid or a gas. Weak acids can act to lower pH, decreasing solubility and dissolution similar to using cross-linked film forming agents to slow dissolution/solubility. For example, in case of CMC/CMS, lowering the pH causes partial neutralization of the anionic COO⁻ group into the neutral COOH group. Examples of weak acid include, but are not limited to, citric acid, acetic acid, maleic acid, folic acid, tartaric acid, fumaric acid, lactic acid, dilute phosphoric acid, sodium and potassium lactate salts, ascorbic acid, and sodium ascorbate. In addition, the following materials can also reduce/retard solubility: croscarmellose (cross-linked (Na+) CMC), sodium starch glycolate, lecithins extracted from soy, sunflower, rapeseed, cottonseed, eggs, milk, malonic acid, and the like, calcium salts including, but not limited to calcium lactate, calcium chloride and so on and potentially a plant-based, cross-linked polyvinylpyrrolidone. It is noted that malonic acid can result in the cross-linking of corn and potato starches to produce a biodegradable thermoplastic (//en.wikipedia.org/wikVMalonic_acid). Solubility reducers can be used alone and in combination from between 0.1-70 wt. % and ranges within this range in formulating the film forming composition depending upon the use and product produced from the resulting film.

Edible Anti-Stickiness Powders

Powders to reduce the tackiness or stickiness of the disclosed films can be added during film forming composition preparation and/or in post-film formation processing, for ease of handling and the like as would be known to the skilled artisan. Examples of materials that can facilitate the feeling of a smooth and/or non-sticky film surface can include, but are not limited to, edibles such as corn starch, potato starch, tapioca starch, rice starch, silicon dioxide and the like. Edible powder can be used alone and in combination from between 0.1-15 or 1.0-55 wt. % and ranges within this range in formulating the film forming composition depending upon the use and product produced from the resulting film.

Non-Edible Anti-Stickiness Powders

Powders to reduce the tackiness or stickiness of the disclosed films can add during film forming composition preparation and/or in post-film formation processing, ease of handling and the like as would be known to the skilled artisan. Examples of materials that can facilitate the feeling of a smooth and/or non-sticky film surface can include, but are not limited to, talc as well as corn starch, potato starch, tapioca starch, rice starch, silicon dioxide and the like. The powder(s) can be used alone and in combination from between 0.1-15 or 1.0-55 wt. % and ranges within this range in formulating the film forming composition depending upon the use and product produced from the resulting film.

Anti-Foaming Agents

Agents that reduce or eliminate foaming (Defoamer agents) and preclude bubbles from forming in the disclosed film can help provide a film of uniform appearance and eliminate potential weak points, pin holes or breakage prone areas in the film. Examples of anti-foaming agents are known to the skilled artisan and can include, but are not limited to oil-based anti-foam agents including, but not limited to oils insoluble in the foaming medium (except silicone oil), vegetable oil and mineral oil; powder-based anti-foam agents can be oil based defoamer surrounding/on a particulate such as silica and can be added to powdered compositions of detergent, plaster and cement; water-based anti-foam agents including, but not limited to sodium hydrogen carbonate, sodium carbonate, magnesium carbonate, potassium carbonate, and calcium carbonate and ammonium hydrogen carbonate, and ammonium carbonate; silicon-based anti-foaming agents such as polyethylene glycol and polypropylene glycol. In addition, auxiliary foaming agents can include calcium dihydrogen pyrophosphate, dipotassium hydrogen phosphate, disodium hydrogen phosphate L-ascorbic acid, L-aspartic acid, galacturonic acid, glucuronic acid, L-glutamic acid, monosodium fumarate, potassium L-bitartrate, potassium aluminum sulfate, potassium dihydrogen phosphate, sodium dihydrogen phosphate, and sodium DL-malate. The anti-foaming agent(s) can be used alone and in combination from between 0.1-5 wt. % and ranges within this range in formulating the film forming composition depending upon the use and product produced from the resulting film.

Edible Enhancements

The disclosed films can encase/surround foods, nutritional and wellness supplements. Additionally, also envisioned are additives that enhance the taste, scent and visual appeal of the disclosed films. Such film enhancements can be used in the disclosed film compositions at an amount between about 0.1-51 wt. % of the dried film weight.

Natural and/or synthetic coloring, dye, flavoring and scenting agents can augment the functionality of the disclosed films to provide pleasing aesthetics. Such enhancements can provide coloring to the films using for example, vegetable-based and fruit-based dyes including but not limited to beet, carrot, red pepper, grape, blueberry, tomato, and plum juices. Additionally, herbs and spices such as saffron, mustard, indigo, and turmeric can impart color to the film.

The coloring, dye, flavoring and scenting agents can be mixed into the film composition to impart a color, scent or taste to the film. Perfumes and scenting agents that impart an odor can include, but are not limited to, herbs such as mint, rosemary, basil, oregano, dill and spices such as cinnamon, nutmeg, ginger, allspice, sandlewood, as well as oils of lemon, orange, lavender, rose, lilac, jasmine and the like. Not only can vegetables, fruits, herbs, spices and flowers impart color and/or scent but they can also provide flavorings to the disclosed films. Examples of flavorings include, but are not limited to, essential oils or extracts of menthol, wintergreen, peppermint, sweet mint, spearmint, vanillin, cherry, butterscotch, chocolate, almond, cinnamon, clove, raspberry, spice, violet, herbal, fruit, strawberry, grape, pineapple, vanilla, peppermint, peach, kiwi, papaya, mango, coconut, apple, coffee, plum, watermelon, nuts, green tea, grapefruit, banana, butter, or chamomile, as well as mixes of powders from fruits, nuts, vegetables, berries, superfoods, dried eggs, and the like. As well as salt, pepper, onion, garlic, and saffron as known to the skilled artisan.

Sweeteners can be natural, artificial, and water-soluble/hydro-liquid sweeteners. Natural sweeteners can be monosaccharides, disaccharides, polysaccharides, and polyols as known to the skilled artisan as well as natural, high intensity sweeteners such as stevia, and steviosides. It is noted that the sweeteners monellin, and glycyrrhizin and Lo Han Kuo may not yet have been approved globally for use.

Nutritional and Health Supplements

Supplementing the disclosed film's compositions, used for packaging food items, with added vitamins, minerals, herbs and spices or activated charcoal can increase nutritional value to the food item(s) within the package. A nutritional supplement(s) can be used alone and in combination from between 0.1-51 wt. % and ranges within this range in formulating the film composition depending upon the use and product produced from the resulting film.

Additionally, wellness supplements that restore, improve and maintain the microbiota of an individual, can be included in the film's composition, packaged within the disclosed film when formed as a packet, container, capsule and/or placed between layers of the disclosed films. Such supplements include preblotics that induce the growth and activity of beneficial bacteria and fungi including the gut microbiome, probiotics which are live microorganisms that can restore and improve the gut microbiota and activated charcoal for toxin absorption. A wellness supplement(s) can be used alone and in combination from between 0.1-10 wt. % and ranges within this range in formulating the film composition depending upon the use and product produced from the resulting film.

Selection of Film-Forming Agents:

The viscosity of the film forming agent can range from 1 cPs at 10 wt. % solution to around 10,000 cPs but could be up to about 50,000 to 150,000 cPs or more while a film forming agent used at 1 wt. % solution could have a higher viscosity because less liquid is need to dissolve the material. Higher viscosities provide films with stronger mechanical properties but films with lower viscosities enable the option to increase the concentration of the solution which results in higher production rates for solution casting due to smaller quantities of the required solvent. Additionally, using more than one film forming agent, for example and not to be viewed as limiting, a combination of CMC and maltodextrin was found to slightly improve film dissolution. Combinations of film forming agents can also be used to tune/adapt the film's dissolution temperature, rigidity, texture, stretch and shrink properties and the like as would be known to the skilled artisan.

Of note; the order of combining film forming agents/materials can also impact the viscosity. A non-limiting example is the inclusion of sodium chloride in the film composition. Adding NaCl before the film forming agent CMS-Na can result in the viscosity markedly decreasing. However, adding CMS-Na before adding NaCl can have minimal impact on viscosity of the film composition.

A skilled artisan can understand that film forming agents including, but not limited to, those disclosed herein can be used interchangeably and can be, In many cases, functional equivalents of one another.

Table 1 provides non-limiting examples of film forming agents for use in films having controlled solubility, in ingestible consumable food product(s), and delivery applications including, but not limited to, edible, flavoring/water-soluble, including hydro-liquid soluble packaging, blendable and pre-measured packaging. Also included are pharmaceutical packaging and delivery applications. Water-solubility temperatures for cold: 1-25° C., cool: 25-35° C., warm: 35-50° C., hot: >50-100° C. Reduced dissolution in a hydro-liquid of many film forming agents can be improved with the use of 0.1-70 wt. % of a solubility reducer, supra or a weak acid supra, e.g., citric acid as well as the salts of the acids as known to the skilled artisan. In Table 1, “X” designates the materials that can be preferred to be used as a film-forming agent, E for edible and CS when a controlled solubility reducer can also be incorporated in the film composition where a water solubility reducer such as a weak acid and salts thereof at 0.1-70 wt. % assists in creating a film for the indicated use(s).

TABLE 1
Controlled Solubility, Ingestible and Delivery Films

| | | | | | Edible = E | | | |
|---|---|---|---|---|---|---|---|---|
| | | | | | (CS = with a | Pharma- | | |
| Film-Forming Agent | | | | | controlled | ceutical | | Pre- |
| Cellulose derivatives | Wt. % | Water Solubility | Solubility Temp. | Use | solubility reducer) | Medication | Blendable | Measured |
| carboxymethyl cellulose | 25.99 | YES | cold/warm/hot | X | E, (CS with adds, | X | X | X |
| (CMC) (and sodium salt) | | | | | acid salts: 0.1- | | | |
| | | | | | 70 wt. %) | | | |
| cross-linked CMC (and | 25-99 | limited | | X | E, (CS with acids, | X | X | X |
| sodium salt, CMC-Na, | | | | | acid salts: 0.1- | | | |
| and calcium salt, CMC- | | | | | 70 wt. %) | | | |
| Ca), carboxymethyl | | | | | | | | |
| starch (CMS) (and | | | | | | | | |
| sodium salt | | | | | | | | |
| croscarmellose | | | | | | | | |
| methylcellulose (MC) | 25-99 | YES | cold/warm | X | | X | | |
| ethylcellulose (EC) | 25-99 | limited/ | | | | | | |
| | | insoluble | | | | | | |
| ethyl methyl cellulose | 25-99 | limited/ | | | | | | |
| | | insoluble | | | | | | |
| hydroxyethyl cellulose | 25-99 | YES | cold/warm/hot | X | E | | X | X |
| (HEC) | | | | | | | | |
| hydroxypropyl cellulose | 25-99 | YES | cold/warm | | | | | |
| (HPC) | | | | | | | | |
| hydroxyethyl methyl | 25-99 | YES | cold/warm | X | | | | |
| cellulose (HEMC) | | | | | | | | |
| hydroxypropy methyl | 25-99 | YES | cold/warm | X | E, (CS with acids, | X | X | X |
| cellulose (HPMC) | | | | | acid salts: 0.1- | | | |
| | | | | | 70 wt. %) | | | |
| ethyl hydroxyethyl | 25-99 | limited/ | | | | X | | |
| cellulose | | insoluble | | | | | | |
| pectins and salts thereof | 25-99 | YES | cold/warm/hot | | E, (CS with acids, | | X | X |
| (including sodium | | | (different versions) | X | acid salts: 0.1- | | | |
| pectinate | | | | | 70 wt. %) | | | |
| Xanthan gum | 25-99 | YES | cold/warm/hot | X | E | | X | X |
| pullulan | 25-99 | YES | cold/warm/hot | X | E | X | X | X |
| Starch | 25-99 | YES | warm/hot | X | E, CS | X | X | X |
| (potato, corn, tapioca, | | | | | | | | |
| rice) | | | | | | | | |
| Dextrins, including: | | | | | | | | |
| maltodextrin | 25-99 | YES | cold/warm/hot | X | | | X | X |
| Modified starches, | | | | | | X | | |
| including: | | | | | | | | |
| carboxymethyl starch | 25-99 | YES | cold/warm/hot | X | E, CS (with acids, | X | X | X |
| | | | | | acid salts: 0.1- | | | |
| | | | | | 70 wt. %) | | | |
| cross-linked CMS | 25-99 | limited | | X | E, CS (with acids, | X | X | X |
| (sodium starch glycolate) | | | | | acid salts: 0.1- | | | |
| | | | | | 70 wt. %) | | | |
| ethoxylated starch | 25-99 | YES | cold/warm/hot | | | X | | |
| hydroxypropylated starch | 25-99 | YES | cold/warm/hot | | | | | |
| Fenugreek gum | 25-99 | YES | hot | X | | | X | X |
| locust bean gum | 25-99 | YES | warm/hot | X | | | X | X |
| guar gum | 25-99 | YES | cold/warm/hot | X | E | X | X | X |
| tara gum | 25-99 | YES | warm/hot | | | | | |
| konjac gum | 25-99 | YES | hot | | | | | |
| gellan gum | 25-99 | YES | hot | | | | | |
| cassia gum | 25-99 | YES | cold/warm/hot | X | | | X | |
| gum Arabic | 25-99 | YES | cold/warm/hot | X | | X | X | |
| gum tragacanth | 25-99 | YES | cold/warm/hot | | | | | |
| gum karaya | 25-99 | limited/ | | | | | | |
| | | insoluble | | | | | | |
| Seaweed-based: | | | | | | | | |
| agar | 25-99 | YES | hot | X | E | | X | X |
| carrageenan | 25-99 | YES | cold/warm/hot | X | E | X | X | |
| | | | (different versions) | | | | | |
| (sodium) alginate | 25-99 | YES | cold/warm/hot | X | E (with calcium | X | X | X |
| | | | | | salts: 0.1-70 wt. %) | | | |
| propylene glycol alginate | 25-99 | YES | cold/warm/hot | X | E | X | X | X |
| (PGA) | | | | | | | | |
| Animal-based: | | | | | | | | |
| gelatin (protein) | 25-99 | YES | warm/hot | X | E | X | X | X |
| casein | 25-99 | YES | cold/warm/hot | X | E | X | X | X |
| chitin | 25-99 | limited/ | | | E | | X | |
| | | insoluble | | | | | | |
| chitosan | 25-99 | limited/ | | | E | | X | |
| | | insoluble | | | | | | |
| Plant-based polyvinyl | 25-99 | YES | cold/warm/hot | X | E | X | X | X |
| alcohol | | | | | | | | |

Table 2 provides non-limiting examples of film forming agents for use in non-edible applications including, but not limited to detergent, cleaning, home and personal care, agricultural, industrial, manufacturing, and environmental/marking/bagging packaging. Water-solubility temperatures for cold: <30° C., warm: 30-60° C., hot: >60° C. Reduced dissolution in a hydro-liquid of many film forming agents can be improved with the use of 0.1-70 wt. % of a solubility reducer, supra or a weak acid supra, e.g. citric acid as well as the salts of the acids as known to the skilled artisan. In Table 2, “X” designates the use of a film-forming agent and where a water solubility reducer such as a weak acid and salts thereof at 0.1-70 wt. % assists in creating a film for the indicated use(s).

TABLE 2
Biodegradable, Durable/Tasteless Films

| | | | | Industrial & | Cleaning/Home | | Environmental |
|---|---|---|---|---|---|---|---|
| Film-Forming Agent | | Water | Solubility | Manu- | & Personal | | Marking |
| Cellulose derivatives | Wt. % | Solubility | Temp. | facturing | Care | Agricultural | Bagging |
| carboxymethyl | 25-99 | YES | cold/warm/ | X | X | X (or with | X (with acids, |
| cellulose (CMC) (and | | | hot | | | acids, acid | acid salts, acid |
| sodium salt, CMC-Na, | | | | | | salts, acid | cross-linkers: |
| and calcium salt | | | | | | cross-linkers: | 0.1-70 wt. % ) |
| CMC-Ca) | | | | | | 0.1-70 wt. %) | |
| cross-linked CMC | 25-99 | limited | | X | X | X (or with | X (with acids, |
| (and sodium salt), | | | | | | acids, acid | acid salts: 0.1- |
| croscarmellose | | | | | | salts: 0.1- | 70 wt. %) |
| | | | | | | 70 wt. %) | |
| methylcellulose (MC) | 25-99 | YES | cold/warm | X | | | |
| ethylcellulose (EC) | 25-99 | limited/ | | | | | |
| | | insoluble | | | | | |
| ethyl methyl cellulose | | limited/ | | | | | |
| | | insoluble | | | | | |
| hydroxyethyl cellulose | 25-99 | YES | cold/warm/ | X | X | X | X |
| (HEC) | | | hot | | | | |
| hydroxypropyl | 25-99 | YES | cold/warm | X | | | |
| cellulose (HPC) | | | | | | | |
| hydroxyethyl methyl | 25-99 | YES | cold/warm | | | | |
| cellulose (HEMC) | | | | | | | |
| hydroxypropyl methyl | 25-99 | YES | cold/warm | X | X | X (or with | |
| cellulose (HPMC) | | | | | | acids, acid | |
| | | | | | | salts, acid | |
| | | | | | | cross-linkers: | |
| | | | | | | 0.1-70 wt. %) | |
| ethyl hydroxyethyl | 25-99 | limited/ | | | | | |
| cellulose | | insoluble | | | | | |
| pectins and salts | 25-99 | YES | cold/warm/ | X | X | X (or with | X (with acids, |
| thereof | | | hot (different | | | acids, acid | acid salts, acid |
| | | | versions) | | | salts, acid | cross-linkers: |
| | | | | | | cross-linkers: | 0.1-70 wt. %) |
| | | | | | | 0.1-70 wt. %) | |
| xanthan | 25-99 | YES | cold/warm/ | X | X | | |
| | | | hot | | | | |
| pullulan | 25-99 | YES | cold/warm/ | X | X | X (or with | |
| | | | hot | | | acids, acid | |
| | | | | | | salts, acid | |
| | | | | | | cross-linkers: | |
| | | | | | | 0.1-70 wt. %) | |
| Starch | 25-99 | YES | warm/hot | X | X | X (or with acid | X (with acid |
| (potato, corn, tapioca, | | | | | | cross-linker | cross-linker |
| rice) | | | | | | 20-40 wt. %) | 20-40 wt. %) |
| dextrins, including: | | | | | | | |
| maltodextrin | 25-99 | YES | cold/warm/ | X | | | |
| | | | hot | | | | |
| modified starches, | | | | | | | |
| including: | | | | | | | |
| carboxymethyl starch | 25-99 | YES | cold/warm/ | X | X | X (or with | X (with acids, |
| (CMS) | | | hot | | | acids, acid | acid salts, acid |
| | | | | | | salts, acid | |
| | | | | | | cross-linkers: | cross-linkers: |
| | | | | | | 0.1-70 wt. %) | 0.1-70 wt. %) |
| cross-linked CMS | 25-99 | limited | | X | X | X (or with | X (with acids, |
| sodium starch | | | | | | acids, acid | acid salts, acid |
| glycolate) | | | | | | salts, acid | cross-linkers: |
| | | | | | | cross-linkers: | 0.1-70 wt. %) |
| | | | | | | 0.1-70 wt. %) | |
| ethoxylated starch | 25-99 | YES | cold/warm/ | | | | |
| | | | hot | | | | |
| hydroxypropylated | 25-99 | YES | cold/warm/ | | | | |
| starch | | | hot | | | | |
| Fenugreek gum | 25-99 | YES | warm/hot | X | | | |
| locust bean gum | 25-99 | YES | warm/hot | | | | |
| guar gum | 25-99 | YES | cold/warm/ | X | X | X (or with | |
| | | | hot | | | acids, acid | |
| | | | | | | salts, acid | |
| | | | | | | cross-linkers: | |
| | | | | | | 0.1-70 wt. %) | |
| tara gum | 25-99 | YES | warm/hot | | | | |
| konjac gum | 25-99 | YES | hot | | | | |
| gellan gum | 25-99 | YES | hot | | | | |
| cassia gum | 25-99 | YES | cold/warm/ | | | | |
| | | | hot | | | | |
| gum Arabic | 25-99 | YES | cold/warm/ | X | | X (or with | X (or with |
| | | | hot | | | acids, acid | acids, acid |
| | | | | | | salts, acid | salts, acid |
| | | | | | | cross-linkers: | cross-linkers: |
| | | | | | | 0.1-70 wt. %) | 0.1-70 wt. %) |
| gum tragacanth | 25-99 | YES | cold/warm/ | | | | |
| | | | hot | | | | |
| gum karaya | 25-99 | limited/ | | | | | |
| | | insoluble | | | | | |
| Seaweed-based: | | | | | | | |
| agar | 25-99 | YES | hot | | | | |
| carrageenan | 25-99 | YES | cold/warm/ | X | X | | |
| | | | hot | | | | |
| | | | different | | | | |
| | | | versions) | | | | |
| (sodium) alginate | 25-99 | YES | cold/warm/ | X | X | X (or with | X (with calcium |
| | | | hot | | | calcium salts: | salts: 40- |
| | | | | | | 0.1-70 wt. %) | 60 wt. %) |
| propylene glycol | 25-99 | YES | cold/warm/ | X | X | X (or with | |
| alginate (PGA) | | | hot | | | acids, acid | |
| | | | | | | salts, acid | |
| | | | | | | cross-linkers: | |
| | | | | | | 0.1-70 wt. %) | |
| Animal-based: | | | | | | | |
| gelatin (protein) | 25-99 | YES | warm/hot | X | X | X | X |
| casein | 25-99 | YES | cold/warm/ | X | X | X | X |
| | | | hot | | | | |
| chitin | 25-99 | limited/ | | X | | X | X |
| | | insoluble | | | | | |
| chitosan | 25-99 | limited/ | | X | | X | X |
| | | insoluble | | | | | |
| Plant-based polyvinyl | 25-99 | YES | cold/warm/ | X | E | X | X |
| alcohol | | | hot | | | | |

Table 3 provides non-limiting examples of wt. % of film forming agents and plasticizers for use in A. Blendable Packages, B. Home and Personal Care Products, C. Honey (sweetener) and Flavoring Packets, D. Orally Consumable Packages, E. The combination of C and D, E. Film, F. Pre-measured Food & Flavoring Packets, and G. Edible Packages and Pads. Ranges in brackets ( ) can indicate wt. % range for the optimum total ingredient(s) amount. Underlined ranges indicate the about minimum and about maximum wt. % for the designated film product's composition. Ranges in italics represent the about minimum and about maximum wt. % for films where the foodstuff or consumable is represented in the film's composition in a high degree.

TABLE 3
Film Product Composition wt. % Ranges for Film Forming Agents and Plasticizers

| | FF AGENT wt. % | PLASTICISER wt. % | OTHER wt. % |
|---|---|---|---|
| PRODUCT | (main (but not limited to)) | (main (but not limited to)) | (optional samples) |
| A. BLENDABLE | (50-80) 45-80, 45-85, 40-85, 40-90, 35-95, | 5-35, 15-45, 18-25, (18-28), | Coloring/Flavoring/ |
| PACKAGES & PADS | 35-45, 45-55, 50-60, 60-70, 70-80, 80-90, | 15-25, 15-30, 10-40, 10-30, | Nutritional/Foodstuff fill: |
| (e.g. blendable superfood | 25-95, 25-55, 30-95, 35-85, 50-85, 45-95, | 20-30, 20-40, 10-50, 10-60, | 20-51, 10-35, 0.1-55, 5-40, 0-75 |
| and smoothie packages) | 50-90, 50-95, 25-75 | 5-60 | |
| a) Transparent | (70-80) 65-85, 65-90, 50-90 | (as previous) | (as previous) |
| b) Colored | (55-65) 50-70, 45-70, 45-95 | (as previous) | (as previous) |
| c) Fill dominance | (35-50) 30-50, 35-55, 25-55 | (as previous) | (as previous) |
| B. HOME AND PERSONAL | (40-90), 25-95, 25-55, 30-95, 35-45, 45-55, | 10-60, 5-35, 15-45, 18-25, | Coloring/Active |
| CARE PRODUCTS | 50-60, 60-70, 35-85, 50-85, 45-95, 50-90, | (18-28), 15-25, 15-30, | ingredient/Consumable fill: |
| | 50-95, 25-75 | 10-40, 10-30, 20-30, 20-40, | 20-51, 10-35, 0.1-55, 5-40, 0-75 |
| | | 10-50, 10-60, 5-10, 5-60 | |
| a) Higher elasticity | (50-70) 45-70, 40-75, 25-55 | (30-50), 30-60, 25-55, | (as previous) |
| | | 25-60, 25-65 | |
| b) Lower elasticity | (75-95) 70-90, 70-95, 60-95 | (10-30), 10-30, 5-30 | (as previous) |
| C. HONEY (Sweetener) | (70-82) 60-80, 60-95, 50-90 25-95, 30-95, | (18-28), 20-30, 20-40, | Coloring/Flavoring/ |
| AND FLAVORING | 25-55, 35-45, 45-55, 50-60, 60-70, 35-85, | 15-25, 15-30, 15-40, 10-40, | Nutritional/Foodstuff fill: |
| PACKETS (e.g. water- | 50-85, 45-95, 50-90, 50-95, 25-75 | 10-50, 10-60, 5-60 | 20-51, 10-35, 0.1-55, 5-40, 0-75 |
| soluble honey packages) | | | |
| D. ORALLY | (40-70) 40-75, 25-55, 35-45, 45-55, 50-60, | (18-28), 20-30, 20-40, | Solubty reducer: |
| CONSUMABLE PACKAGES | 60-70, 35-80, 25-95, 30-95, 35-85, 50-85, | 15-25, 15-30, 15-40, 10-40, | 30-50, 20-50, 10-65, |
| (e.g. yoghurt balls, | 45-95, 50-90, 50-95, 25-75 | 10-50, 10-60, 5-60 | 0-65, 0.1-60; |
| medicine pkg., food | | | Coloring/Flavoring/ |
| supplements, etc) | | | Nutritional/Foodstuff fill: |
| | | | 20-51, 10-35, 0.1-55, 5-40, 0-75 |
| E. FILM | (70-82), 65-90, 25-55, 35-45, 45-55, 50-60, | 5-35, 15-45, 18-25, (18-28), | Coloring/Flavoring/ |
| (wraps, bags, | 60-70, 40-85, 40-95, 35-95, 25-95, 30-95, | 15-25, 15-30, 10-40, 10-30, | Nutritional/Foodstuff/Active |
| pouches, packaging,) | 35-85, 50-85, 45-95, 50-90, 50-95, 25-75 | 20-30, 20-40, 10-50, 10-60, | ingredient/Consumable fill: |
| | | 5-60 | 20-51, 10-35, 0.1-55, 5-40, 0-75 |
| F. PRE-MEASURED FOOD | (70-82) 65-85, 65-90, 50-90, 25-95, 25-55, | 5-35, 15-45, 18-25, (18-28), | Coloring/Flavoring/ |
| & FLAVORING PACKETS | 30-95, 35-85, 50-85, 45-95, 50-90, 50-95, | 15-25, 15-30, 10-40, 10-30, | Nutritional/Foodstuff fill: |
| (e.g. water-soluble boiling | 25-75 | 20-30, 20-40, 10-50, 10-60, | 20-51, 10-35, 0.1-55, 5-40 0-75 |
| packages for grains and | | 5-60 | |
| other foods) | | | |
| G. EDIBLE | (50-85) 45-80, 45-85, 40-85, 40-90, 35-95, | 5-35, 15-45, 18-25, (18-28), | Coloring/Flavoring/ |
| PACKAGES & PADS | 35-45, 45-55, 50-60, 60-70, 70-80, 80-90, | 15-25, 15-30, 10-40, 10-30, | Nutritional/Foodstuff fill: |
| | 25-95, 25-55, 30-95, 35-85, 50-85, 45-95, | 20-30, 20-40, 10-50, 10-60, | 20-51, 10-35, 0.1-55, 5-40, 0-75 |
| | 50-90, 50-95, 25-75 | 5-60 | |

The selection of film forming agents can also consider the end use and/or product contained either within the film's composition, the film as a covering, linear sheeting, and/or moisture barrier. The film can deliver a product for use in food, home care, personal care, hygiene, health and beauty aids, agricultural uses, pharmaceutical, medication delivery, food and nutritional supplement aids, and bags and pouches formed from the disclosed innovative film(s) for ecological and environmental transport, packing in/out by hikers and providing natural decomposition and degradation of compostable materials and having an essential absence of polluting chemicals leaching into soils and waters. To illustrate, the disclosed films can have applications for both food transport as well as being edible and so capable of both minimizing food packaging waste and/or used to package a product produces a unit package for delivery of a consistent food, flavoring, agricultural, pharmaceutical, food and/or nutritional supplement mixture as well as the disclosed films forming bags and pouches for delivery of the product.

Providers (for industrial production) are chosen for offering high quality and high purity products with required certifications regarding production methods, product category, regulatory approval for use in food and the like, and for the geographical location where the product can be used.

Food and Nutritional Products Produced Using the Disclosed Edible Films

The present teachings can be employed, for example, in industrial packaging applications including but not limited to food preparation, delivery, flavoring, convenience cooking, wellness products, including but not limited to, nutritional supplement(s), wellness supplement(s), food supplement(s), medicinal food(s), pharmaceutical(s), and nutraceutical supplement(s) and as disposable packaging containing the afore mentioned as well as including, but not limited to, premeasured colorings, flavorings, foodstuff ingredients, condiments, and agricultural uses. The packaged food product(s) can be used to deliver pre-measured food and flavoring ingredients for uses including, but are not limited to, dyes, pigment(s), anti-foaming agent(s), emulsifier(s), rennet (used in cheese making), yeast (for beer, wine and bread making), bacteria (in yogurt, cheese, fermented vegetables, fruits) and molds (cheese, and the like). The packaged food product(s) can have a total weight including, but not limited to, from 0.2 g, 0.3 g, 0.4 g, and 0.5 g to 21.0 g, 0.5-5.0 g, 1.0-3.0 g, 3-6 g, 8.0 g, 10.0 g, 7-15 g, 7-30 g, 15-150 g, ≥1 g to 20 g, ≥5 g to 15 g, ≥5 g to 50 g, ≥40 g to 100 g, ≥7 g to 150 g, ≥10 g to 200 g, ≥100 g to 500 g, ≥200 g to 1000 g, ≥1000 g to 10.0 kg, ≥10.0 kg to 100.0 kg and ranges within each of these ranges.

The film package formed by the disclosed films can have at least one film forming agent and frequently, at least one plasticizer in the film's composition. The resulting packaging formed by the film forming composition can have many functions, including that it can be dissolved in hydro-liquids including water (cool, cold, hot or cold, warm and hot), can be orally consumed. Additionally, the film packages can be tuned to dissolve in hot, or cold or both as well as cool and/or warm temperatures of hydro-liquids including water, depending on the end use of the contents. Surprisingly, the package can also be used both to encase a foodstuff alone or in combination as an edible food ingredient including when it has one or more of a dietary fiber including, but not limited to, pectins and salts thereof, alginates, CMC and salts thereof, CMS, plant-based polysaccharide(s), which can be a soluble or insoluble dietary fiber separately and/or in combination with one or more of a flavoring, herb, spice, coloring, nutritional supplement(s), wellness supplement(s), food supplement(s), medicinal food(s), pharmaceutical(s), and nutraceutical supplement(s) Incorporated into the film packaging composition wherein the film composition can be made from natural ingredients recognized by regulatory authorities as safe to ingest/consume.

Additionally, packaging made with the disclosed edible films can encase one or more of a flavoring(s), herb(s) and/or spice(s) and/or at least one foodstuff including, but not limited to, fresh, frozen, dried, freeze-dried, dehydrated, pickled, powdered, granulated, irradiated, liquid, gelled, oiled, smoked, sugared, compressed, dehydrated, and salted foodstuff(s), a powder, dry ingredient, sweetener(s), high moisture foodstuff(s), oil(s), grain(s), fresh vegetable(s), fruit(s), meat(s), nut(s), food supplement(s), medicinal food(s), pharmaceutical(s), nutraceutical supplement(s) encased within the pre-measured packet/package along with or without pre-measured food item(s) including, but not limited to, spice, flavoring, coffee, tea, cocoa, condiment, nutritional supplement(s), wellness supplement(s), food supplement(s), medicinal food(s), pharmaceutical(s), and nutraceutical supplement(s) in a vacuum-packed film package. The package can also be tom, twisted or pulled open in a conventional way and then thrown away without creating landfill/plastic waste. Too, the film package could be filled with a powder as a pre-measured serving including, but not limited to, a superfood, smoothie, vitamin(s), mineral(s), protein(s) and beverage powder(s) and nutrition and/or wellness supplement(s) including but not limited to vitamins, minerals, probiotics, prebiotics, oils, flavorings, colorant(s), psychoactive drugs, medicinal food(s), nutraceuticals.

The products produced utilizing the disclosed films can have the advantage of offering convenience by having pre-measured quantities of a filled food product. The packaged food products can be used for human and/or animal (including domestic pets, farm, zoological parks and preserves and wildlife animals) consumption or frozen for later consumption. Additionally, the film package offers the advantage of single contact use to preclude potential transmission of infections agents by eliminating sharing of film packages' contents when made to contain single-use foodstuff(s), product(s) and consumable(s).

Therefore, the contents can be packaged in a biodegradable and edible film packaging material of the disclosed innovations, wherein the whole package, following use and/or delivery of the food product/serving/supplement disintegrates and/or can be easily mixed during preparation, providing convenience, mess-free experience, pre-measured quantities of the foodstuff, extend shelf-life of foodstuffs when used in for example, but not limited to, vacuum-packaging, and eco-friendliness as the package does not produce any waste if dissolved, blended or otherwise consumed or when tom open in a conventional way and thrown away as it will decompose and is biodegradable.

The film forming agents in the film composition can be polysaccharide fibers which rather than being health neutral can be materials that can contribute to healthy products as soluble or insoluble dietary fiber. Additionally or alternatively, the film composition can have incorporated into the film one or more of a foodstuff to improve the packaging appearance by seeming more appetizing and less similar to conventional plastic packaging but also for increasing the nutritional value of the edible packaging product by including the foodstuff which is consumed with the film.

A. Blendable Packages and Pads

The package formed by the disclosed films can have at least one film forming agent and at least one plasticizer in the film's composition. The resulting packaging formed by the film composition can have many functions, meaning that it can be dissolved/soluble in a cold, cool, warm, hot or cold and hot hydro-liquids including water, can be orally consumed (i.e., edible) and/or the film package can also be used as a food ingredient if it has a flavoring, herb or spice incorporated into the film composition. Alternatively, the package can also be tom, twisted, and/or pulled open in a conventional way, the food product extracted, then the package thrown away without creating plastic waste. The blendable package or pad can disperse its contents either by opening and/or tearing of the disclosed film(s) with their concomitant dissolution and/or pulverization of the film's packaging, packet(s), and/or pad(s) by blending, shaking in a process including, but not limited to, use of a blender, container, food processor, juicer, grinder, pressure cooker, multicooker, mixer and convenience cooking apparatus often, but not necessarily, in the presence of a liquid including, but not limited to, a hydro-liquid including water. The products produced from the disclosed films can have the advantage of offering convenience by having pre-measured quantities of a filled food product. The packaged/pad food products can be used for human and/or animal (including domestic pets, farm, zoo and wildlife animals) consumption or frozen for later consumption.

In one embodiment the blendable packages and pads can be used for preparing a food or beverage including, but not limited to, a smoothie, milk or its alternative cocktail, ice-cream cocktail, non-alcoholic cocktail, alcoholic cocktail, soup, puree. In one embodiment the food or beverage can be prepared by at least one of dissolving in a hydro-liquid with concomitant blending with a blender, juicer, food processor, grinder, multicooker, shaking, and stirring. In another embodiment, the blendable packages and pads can contain at least one of a pre-measured foodstuff including, but not limited to, nutritional supplement(s), wellness supplement(s), medicinal food(s), food supplement(s), pharmaceutical(s), nutraceutical supplement(s), coloring/flavoring agent(s), and fragrance/odor agent(s).

One non-limiting example can be blendable packages and pads, where the film and/or film layers can be formed into a packet/pouch/pad by e.g., heat sealing and/or other fusing methods described supra. The film can be folded upon itself and then filled with including, but not limited to, e.g., smoothie powder and/or superfood powder and/or food supplements in a form including, but not limited to, powdered and/or crushed forms. The product can be, but is not limited to, a purpose including, but not limited to, detoxifying, improving an Individual's energy, immunity, digestion, brain activity, beauty, as is known to one skill in the art of health of nutritional supplements. The packaged food product can include, but is not limited to, powdered, dried, granulated, fresh, frozen food products including, but not limited to, fruits, vegetables, plants, nuts, seeds, sprouts, powdered milk and alternatives thereof, as well as non-powdered food e.g., oil, grains, and the like. The packaged food product(s) can have a total weight ranging from 0.2 g, 0.3 g, 0.4 g, and 0.5 g to ≥1.0 g, 0.5-5.0 g, 1.0-3.0 g, 3-6 g, 8.0 g, 10.0 g, 7-15 g, 7-30 g, 15-150 g, ≥1 g to 20 g, ≥5 g to 15 g, ≥5 g to 50 g, ≥40 g to 100 g, ≥7 g to 150 g, ≥10 g to 200 g, ≥100 g to 500 g, ≥200 g to 1000 g, ≥1000 g to 10.0 kg, 210.0 kg to 100.0 kg g and ranges within each of these ranges. The film for the packaged food product can be one or more of transparent, colorless, colored with a colorant including, but not limited to, fruit, berry, vegetable and microbial extracts, juices, pigments, and powders as well as adding a colorant into the enclosure resulting from forming the film into any one of a pad, package, packet, pouch, pillow, 3D shape including, but not limited to, e.g., sphere, tablet, envelope, film, bag, geometric object, unit dose package and a capsule or another enclosure as would be known to the skilled artisan in the packaging arts. The possible planar shapes of pads include, but are not limited to, rectangle, square, triangle, circle, oval, leaf and other shapes, symbols and the like.

In one embodiment, blendable packages and pads can have as a film forming agent a polysaccharide(s) because they are biodegradable, can be edible, dissolve in hydro-liquids including water, can be compostable, can be tom open to empty the contents and the packaging can be disposed without creating landfill waste. In addition to polysaccharides, pb-PVOH can be used as a film forming agent, alone or In combination with polysaccharide(s) because it can be biodegradable, compostable and environmentally responsible.

In one embodiment, the film forming agent(s) for the blendable packages and pads can include, but are not limited to, a film composition having at least one of pectin and salts thereof, sodium pectinate, CMC including salts, cross-linked and modified forms thereof, alginates, sodium alginate, pullulan, HPMC, guar gum, xanthan, starch, CMS including salts, cross-linked and modified forms thereof, agar, gelatin, starch, cellulose, casein, and pb-PVOH and as disclosed in Table 1.

Film forming agent(s), either as a single film forming agent or in combinations of two or more film forming agents, can be present in a film composition of the present invention in any one of the following wt. % ranges based on dry film weight: 5-95, 5-15, 5-25, 5-30, 10-40, 30-90, 25-95, 25-75, 25-55, 27-55, 27-75, 27-95, 30-55, 30-70, 30-95, 35-90, 35-45, 35-50, 35-55, 35-60, 35-65, 35-75, 35-80, 35-85, 35-95, 40-50, 40-55, 40-60, 40-65, 40-70, 40-75, 40-80, 40-85, 40-90, 40-95, 45-55, 45-60, 45-65, 45-70, 45-75, 45-80, 45-85, 45-90, 45-95, 50-60, 50-65, 50-70, 50-75, 50-80, 50-85, 50-90, 50-95, 55-65, 55-70, 55-75, 55-80, 55-85, 55-90, 55-95, 60-70, 60-75, 60-80, 60-85, 60-90, 60-95, 65-75, 65-80, 65-85, 65-90, 65-95, 70-80, 70-82, 70-85, 70-90, 70-95, 75-85, 75-90, 75-95, 80-90, 80-95, 85-95, 1-99, 5-99, 25-99, 90-99 wt. % of total biodegradable film forming agent(s). In one embodiment the film forming agent(s) comprises 30-95 wt. % by dry film weight of the film composition. In one embodiment, blendable packages and pads can have in the film composition at least one film forming agent ranging from 5-95, 5-15, 5-25, 5-30, 10-40, 30-90, 25-95, 25-75, 25-55, 27-55, 27-75, 27-95, 30-55, 30-70, 30-95, 35-90, 35-45, 35-50, 35-55, 35-60, 35-65, 35-75, 35-80, 35-85, 35-95, 40-50, 40-55, 40-60, 40-65, 40-70, 40-75, 40-80, 40-85, 40-90, 40-95, 45-55, 45-60, 45-65, 45-70, 45-75, 45-80, 45-85, 45-90, 45-95, 50-60, 50-65, 50-70, 50-75, 50-80, 50-85, 50-90, 50-95, 55-65, 55-70, 55-75, 55-80, 55-85, 55-90, 55-95, 60-70, 60-75, 60-80, 60-85, 60-90, 60-95, 65-75, 65-80, 65-85, 65-90, 65-95, 70-80, 70-82, 70-85, 70-90, 70-95, 75-85, 75-90, 75-95, 80-90, 80-95, 85-95, 1-99, 5-99, 25-99, 90-99 wt. % of total biodegradable film forming agent(s) based on dry film weight.

In another embodiment, blendable packages and pads can have as a plasticizer a sugar glycol because each is edible, economical, GRAS accepted and abundant. In yet another embodiment the plasticizer can be a sugar, such as glucose or fructose. In yet another embodiment, the plasticizer can be a weak acid including, but not limited to, citric acid and ascorbic acid because each is water soluble, GRAS accepted, edible and can promote polymer cross-linking.

In one embodiment, the plasticizer(s) for the blendable packages and pads can include, but are not limited to, a film composition having at least one of glycerol, sorbitol, xylitol, propylene glycol, citric acid, and ascorbic acid.

In one embodiment, blendable packages and pads can have in the film composition at least one plasticizer ranging from at least one of 15-45 1-60, 5-10, 5-35, 5-50, 5-60, 10-30, 10-35, 10-40, 10-50, 10-60, 15-25, 15-30, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) based on dry film weight.

In one embodiment, the blendable packages and pads can have a film thickness (mm) of at least one of. ?): 0.01-3, 0.025-0.09, 0.03-0.12, 0.035-0.099, 0.04-0.25, 0.05-0.095, 0.05-0.12, 0.05-0.5, 0.06-0.085, 0.06-0.15, 0.07-2, 0.1-0.5, 0.12-0.35, 0.2-0.5, 0.25-1, 1-3, 2-5, 3-15, 5-18 mm.

In one embodiment, the blendable packages and pads can have at least one of 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-75, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming agent(s) based on dry film weight of at least one of pectin and salts thereof, sodium pectinate, CMC including salts, cross-linked and modified forms thereof, alginates, sodium alginate, pullulan, HPMC, guar gum, xanthan, starch, CMS including salts, cross-linked and modified forms thereof, agar, gelatin, starch, cellulose, casein, and pb-PVOH and at least one of 15-45 1-60, 5-10, 5-35, 5-50, 5-60, 10-30, 10-35, 10-40, 10-50, 10-60, 15-25, 15-30, 15-45, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) by dry film weight including, but not limited to, at least one of glycerol, sorbitol, xylitol, propylene glycol, citric acid, glucose, fructose and ascorbic acid and wherein the blendable package and/or pad can have a thickness of at least one of: 0.01-3, 0.025-0.09, 0.03-0.12, 0.035-0.099, 0.04-0.25, 0.05-0.095, 0.05-0.12, 0.05-0.5, 0.06-0.085, 0.06-0.15, 0.07-2, 0.1-0.5, 0.12-0.35, 0.2-0.5, 0.25-1, 1-3, 2-5, 3-15, 5-18 mm and wherein the blendable package and/or pad can have a total weight including, but not limited to, from 0.2 g, 0.3 g, 0.4 g, and 0.5 g to ≥1.0 g, 0.5-5.0 g, 1.0-3.0 g, 3-6 g, 8.0 g, 10.0 g, 7-15 g, 7-30 g, 15-150 g, ≥1 g to 20 g, ≥5 g to 15 g, ≥5 g to 50 g, ≥40 g to 100 g, ≥7 g to 150 g, ≥10 g to 200 g, ≥100 g to 500 g, ≥200 g to 1000 g, ≥1000 g to 10.0 kg, ≥10.0 kg to 100.0 kg because the blendable package and/or pad readily dissolves in a blender or similar apparatus in 3, 5, 7, 8, and 10, 20, and 30 seconds for blendable film packages and about 5, 7, 10, 12, 15, 18, 20, 25, 30, 35-45, 45-0, and 60-90 seconds or less depending on pad thickness, rapidly breaks up during blending releasing contents either encased by and/or embedded within the film forming the blendable packages and/or pads composition and thereby provide consistent delivery of the contents and no waste from the packaging or pad film due to their being compostable.

B. Home and Personal Care Products

The present teachings can be employed, for example, in industrial, home and personal care packaging and delivery applications including but not limited to detergents, household cleaning products, stain removers, personal health and hygiene products, cosmetics, pharmaceutical delivery and administration, agricultural uses and environmentally friendly marking, disposal and bagging. The film packaging for industrial, home and personal care products delivering consumable product(s) can have a total weight including, but not limited to: 0.2 g, 0.3 g, 0.4 g, and 0.5 g to ≥1.0 g, 0.5-5.0 g, 1.0-3.0 g, 3-6 g, 8.0 g, 10.0 g, 7-15 g, 7-30 g, 15-150 g, ≥1 g to 20 g, ≥5 g to 15 g, ≥5 g to 50 g, ≥40 g to 100 g, ≥7 g to 150 g, ≥10 g to 200 g, ≥100 g to 500 g, ≥200 g to 1000 g, ≥1000 g to 10.0 kg, ≥10.0 kg to 100.0 kg, and (≥100.0 kg to 1000.0 kg.

Film packaging and delivery products for industrial, home and personal care can be made with the disclosed films and the properties of the disclosed film(s) can be at least one of water-soluble (hot, cold, hot and cold) and tearable. The film product can be a Unit-Dose Package (pod) for uses including, but not limited to, 1) detergents (powders, tablets, gels and mixtures thereof), and fabric softeners, stain removers, fabric sizing, 2) dishwasher powders, tablets, gels, spot-free rinses and mixtures thereof, 3) other cleaning products including, but not limited to, cleaning and chemical mixtures for cleaning and maintaining pool, toilet, floor, window, exterior aluminum, vinyl siding, cement, brick sidewalks and driveway surface, cleaning chemicals in the forms of powders, tablets, gels or mixtures thereof, and 4) agriculture dispersal of feeds, fertilizers, herbicides, and insecticides. In one embodiment, the film packaging is soluble in one or more of a cold, cool, warm and hot hydro-liquid including, but not limited to water. Additional hydro-liquids can include, but are not limited to, cement, concrete, plaster, paint, water-oil mixtures, an emulsion, paper pulp, dyes, water-based mixtures, hydro-liquid based mixtures and at various water temperatures including, but not limited to, cool, warm, hot, cold or cold and hot. Depending on the film composition for package and delivery of products consumed in industrial, home and personal care products the film package dissolution can be faster at elevated water temperatures. The package can be tom, twisted, and/or pulled open in a conventional way and be thrown away without creating landfill and/or plastic waste. The film package filled with its contents offers a product having the advantage of providing convenience and safety by having pre-measured quantities of the filled product, e.g., pool chemicals for maintaining pH, chlorine levels and so on to limit inhalation and/or topical exposure when handling, preventing content waste, and offering eco-friendly options. Additionally, the film composition can comprise the consumable which can i) improve the film package's appearance, ii) function as a neutral/filler material for the film's composition and iii) delivers the consumable for its intended use.

Water-soluble unit-dose packages can deliver cleaning ingredients including, but not limited to, detergent and dishwashing ingredients, pool, toilet, floor, window cleaning chemicals in the forms of powders, tablets, gels or mixtures thereof and agricultural fluids as described supra. The package can be intended to dissolve in any water temperature (although the dissolution can be faster at elevated water temperatures).

In one embodiment, the film composition for use in industrial, home and personal care packaging can have a film forming agent that can be at least one of a cellulose derivative, a starch derivative and a gum including, but not limited to, a carboxymethylated organic compound, including but not limited to carboxymethyl cellulose and carboxymethyl starch, hydroxyethyl cellulose, hydroxypropylmethylcellulose, xanthan gum, Arabic gum, guar gum, pullulan, pectins and salts thereof, including sodium pectinate, alginates, including sodium alginate, derivatives and modified forms thereof. In another embodiment, the film forming agent can be a polysaccharide, including but not limited to, at least one of a cellulose, a modified cellulose, a starch and a modified starch because both celluloses, starches, gums and polysaccharides are biodegradable, compostable, dissolve in hydro-liquids including water, can be compostable, can be tom open to empty the contents, and the packaging can be disposed without creating landfill or plastic waste.

Industrial packaging: The plant-based film composition for use in Industrial packaging and delivery can have a film forming agent that can be at least one of CMC including salts, cross-linked CMC, modified cellulose and modified CMC forms thereof, CMS including salts, cross-linked CMS, modified starch and modified CMS forms thereof, HEC, HPMC, croscarmellose, sodium starch glycolate, corn starch, potato starch, tapioca starch, rice starch, guar gum, alginates, sodium alginate, pectins and salts thereof, sodium pectinate, xanthan gum, pullulan, casein and pb-PVOH. Additional film forming agents for use in non-edible applications including, but not limited to detergent, cleaning, home and personal care, agricultural, Industrial, manufacturing, and environmental/marking/bagging packaging are listed in Table 2, supra.

In one embodiment, the packaging for industrial packaging and delivery can have in the film composition at least one film forming agent ranging from at least one of 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming agent(s) based on dry film weight. Additional ranges for film forming agents for use in non-edible applications including, but not limited to detergent, cleaning, home and personal care, agricultural, industrial, manufacturing, and environmental/marking/bagging packaging are listed in Tables 2-3, supra.

In another embodiment, the film composition for use in industrial, home and personal care packaging can have in the film composition a sugar glycol as a plasticizer including, but not limited to, glycerol, propylene glycol, xylitol, sorbitol, polyethylene glycol, and steviol glycoside because each is economical, GRAS accepted and abundant. In yet another embodiment the plasticizer can be a sugar, such as glucose or fructose. In yet another embodiment, the plasticizer can be a weak acid including, but not limited to, citric acid and ascorbic acid because each is water soluble, GRAS accepted and can promote polymer cross-linking and act to decrease film dissolution. Additional plasticizers for use in non-edible applications including, but not limited to detergent, cleaning, home and personal care, agricultural, industrial, manufacturing, and environmental/marking/bagging packaging are listed in Table 2, supra.

In one embodiment, the film composition for use in industrial packaging and delivery can have as a plasticizer at least one of 15-45 1-60, 5-10, 5-35, 5-50, 5-60, 10-30, 10-35, 10-40, 10-50, 10-60, 15-25, 15-30, 15-45, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) by dry film weight including, but not limited to, citric acid, ascorbic acid, glycerol, propylene glycol, xylitol, sorbitol, polyethylene glycol, polypropylene glycol, glucose, fructose, malonic acid, and steviol glycoside.

In one embodiment, the packaging for industrial packaging and delivery can have in the film composition at least one plasticizer ranging from at least one of 15-45 1-60, 5-10, 5-35, 5-50, 5-60, 10-30, 10-35, 10-40, 10-50, 10-60, 15-25, 15-30, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) based on dry film weight. Additional ranges for plasticizers for use in non-edible applications including, but not limited to detergent, cleaning, home and personal care, agricultural, industrial, manufacturing, and environmental/marking/bagging packaging are listed in Tables 2-3, supra.

In one embodiment, the industrial, packaging and delivery can have a film thickness (mm) of at least one of 0.0.01-0.09 mm, 0.01-0.5, 0.01-1, 0.01-3, 0.025-0.09, 0.03-0.08, 0.03-0.09, 0.03-0.12, 0.03-0.5, 0.03-2, 0.03-3, 0.035-0.099, 0.04-0.08, 0.04-0.09, 0.04-0.12, 0.04-0.25, 0.04-0.5, 0.04-2, 0.04-3, 0.05-0.08, 0.05-0.095, 0.05-0.1, 0.05-0.12, 0.05-0.25, 0.05-0.5, 0.05-2, 0.05-3, 0.06-0.085, 0.06-0.09, 0.06-0.1, 0.06-0.15, 0.06-0.25, 0.06-0.5, 0.06-2, 0.06-3, 0.07-0.1, 0.07-0.12, 0.07-0.15, 0.07-0.25, 0.07-2, 0.07-3, 0.08-0.12, 0.08-0.15, 0.08-0.5, 0.08-2, 0.08-3, 0.1-0.25, 0.1-0.5, 0.1-2, 0.1-3, 0.12-0.35, 0.2-0.5, 0.25-1, 0.5-2, 0.5-3, 1-3, 2-5 and 3-5 mm.

Industrial products and materials packaged in the disclosed films used for industrial, packaging and delivery can have a total weight including, but not limited to, from 0.2 g, 0.3 g, 0.4 g, and 0.5 g to ≥1.0 g, 0.5-5.0 g, 1.0-3.0 g, 3-6 g, 8.0 g, 10.0 g, 7-15 g, 7-30 g, 15-150 g, ≥1 g to 20 g, ≥5 g to 15 g, ≥5 g to 50 g, ≥ 40 g to 100 g, ≥7 g to 150 g, 10 g to 200 g, 100 g to 500 g, ≥200 g to 1000 g, 1000 g to 10.0 kg, 10.0 kg to 100.0 kg, 100.0 kg to 1000.0 kg and ranges within each of these ranges.

In one embodiment, the film composition of films for industrial packaging and delivery can have at least one of 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming (FF) agent(s) based on dry film weight of the FF agent of at least one of CMC including salts and cross-linked forms thereof, pullulan, guar gum, alginates, and HPMC, HEC pectins and salts thereof, xanthan gum, casein, gelatin, CMS including salts and cross-linked forms thereof, and pb-PVOH; at least one of 15-45 1-60, 5-10, 5-35, 5-50, 5-60, 10-30, 10-35, 10-40, 10-50, 10-60, 15-25, 15-30, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) by dry film weight including, but not limited to, at least one of glycerol, sorbitol, xylitol, propylene glycol, polyethylene glycol, citric acid, glucose, fructose, maleic acid and ascorbic acid in the film composition of films for industrial packaging and delivery. The films for industrial packaging and delivery can have a thickness of at least one of 0.01-3, 0.025-0.09, 0.03-0.12, 0.035-0.099, 0.04-0.25, 0.05-0.095, 0.05-0.12, 0.05-0.5, 0.06-0.085, 0.06-0.15, 0.07-2, 0.1-0.5, 0.12-0.35, 0.2-0.5, 0.25-1, 1-3, 2-5 mm and wherein the products and material of industry and manufacturing plus the industrial packaging and delivery film packaging can have a total weight including, but not limited to, from 0.2 g, 0.3 g, 0.4 g, and 0.5 g to ≥1.0 g, 0.5-5.0 g, 1.0-3.0 g, 3-6 g, 8.0 g, 10.0 g, 7-15 g, 7-30 g, 15-150 g, ≥1 g to 20 g, ≥5 g to 15 g, ≥5 g to 50 g, ≥40 g to 100 g, ≥7 g to 150 g, ≥10 g to 200 g, ≥100 g to 500 g, ≥200 g to 1000 g, ≥1000 g to 10.0 kg, ≥10.0 kg to 100.0 kg and ≥100.0 kg to 1000.0 kg because the film packaging used for industrial packaging and delivery can be torn, twisted or pulled open in a conventional way to access and retrieve contents encased by the film packaging for industrial packaging and delivery and thereby provides consistent delivery of the contents and no waste from the film packaging which can be thrown away without creating landfill/plastic waste as the film can be composted.

Home and personal care products: The plant-based film composition for use in making a film for packaging and delivery of home and personal care products can have a film forming agent that can be at least one of CMC including salts, cross-linked CMC, modified cellulose and modified CMC forms thereof, CMS including salts, cross-linked CMS, modified starch and modified CMS forms thereof, HEC, HPMC, croscarmellose, sodium starch glycolate, corn starch, potato starch, tapioca starch, rice starch, guar gum, alginates, sodium alginate, pectins and salts thereof, sodium pectinate, xanthan gum, pullulan, casein and pb-PVOH.

Alternatively, the film forming agent can be a cellulose derivative alone or in combination with other film forming agent(s) supra. The cellulose derivatives can be suitable for use when the product filling contains enzymes other than cellulase. CMC containing films have an additional effect as CMC can act as an active ingredient of the detergent by being a dirt suspension agent and therefore can be superior for use as a film forming agent in laundry and other cleaning applications versus PVOH which serves only a packaging purpose.

Alternatively, the film forming agent can be a starch derivative, e.g. carboxymethyl starch either alone or in combination with other film forming agent(s) supra. The starch derivatives are best suitable to be used when the product filling contains enzymes other than amylase. CMS has an additional effect by acting as an active ingredient of the detergent by being a dirt suspension agent and therefore is superior for the use as a film forming agent in laundry and other cleaning applications verses PVOH which serves only a packaging purpose.

Alternatively, the film forming agent can be guar gum alone or in combination with other film forming agent(s) supra including, but not limited to, other (non)-starch-or-cellulose-derivative film forming agents. Guar gum is best suitable to be used when the product filling contains enzymes other than mannanase.

Alternatively, the film forming agent can be xanthan gum alone or in combination with other film forming agent(s) supra including, but not limited to, other (non)-starch-or-cellulose-derivative film forming agents. Commercially available xanthan gum has a high, thick viscosity making it difficult to use at e.g., 25,000 to 250,000 cPs. The future availability of a low viscosity xanthan gum could be easier to use in the disclosed film forming compositions as xanthan can be highly resistant to most industrially used enzymes found in detergents and other cleaning materials.

Products made with the disclosed films can be at least one of water-soluble (hot, cold, hot and cold) and tearable. The products can be used in personal care packaging applications including, but not limited to, personal health and hygiene products, cosmetics, disposable diapers and undergarments.

The disclosed films can be used alone as, e.g., a toilet seat cover, facial tissue or in the production of disposable diapers, disposable toddler training pants, disposable sanitary napkins, and disposable briefs and/or panties, all of which can be biodegradable and compostable in industrial composts and/or buried in soil, or through exposure to water at any one of a cold to hot temperature or/or tearable. Formulation of the disclosed films to contain and resist dissolution of high moisture content materials contained within the disclosed films provides ecologically and environmentally non-polluting consumable products.

Products made with the disclosed films can be at least one of water-soluble (hot, cold, hot and cold), tearable, and biodegradable. The product can be unit-dose or bulk packages for personal care products including, but not limited to, toothpaste, shower gels, shaving gels, soaps, shampoos and cream rinses, mousses, creams, lotions, moisturizers sunscreens, scrubs, bath salts, bath bombs, activated charcoal, and the like. In another embodiment the product contains a premeasured quantity of the product required for a single dose. The product can be a barrier film, for use in e.g., a disposable diaper, brief or pantie. The film package can further optionally be dissolved in a hydro-liquid (hot, cold or cold and hot) and/or dissolved when rubbing wet hands together due to abrasion. Alternatively, the film package can further optionally be torn, twisted, and/or pulled open in a conventional way and thrown away without creating plastic waste. The product can have the advantage of offering convenience by having pre-measured quantities of e.g., a cosmetic product, as a moisture containment article, and its packaging can be biodegradable and compostable.

In one embodiment the product can be an oral care package including, but not limited to, at least one of a toothpaste or mouthwash in the form of paste, powder, gel or other concentrated form. In one embodiment the product dissolves easily in mouth or in contact with hydro-liquids. In one embodiment the product dissolves best at the pH values of saliva, typically within a range of pH 6.2-7.4.

The plant-based film composition for use in making a film for packaging and delivery of home and personal care products can have a film forming agent that can be at least one of CMC including salts, cross-linked CMC, modified cellulose and modified CMC forms thereof, CMS including salts, cross-linked CMS, modified starch and modified CMS forms thereof, HEC, HPMC, croscarmellose, sodium starch glycolate, corn starch, potato starch, tapioca starch, rice starch, guar gum, alginates, sodium alginate, pectins and salts thereof, sodium pectinate, xanthan gum, pullulan, casein and pb-PVOH.

Alternatively, the film forming agent can be a cellulose derivative alone or in combination with other film forming agent(s) supra. The cellulose derivatives can be suitable for use when the product filling contains enzymes other than cellulase. CMC containing films have an additional effect as CMC can act as an active ingredient of the detergent by being a dirt suspension agent and therefore can be superior for use as a film forming agent in laundry and other cleaning applications versus PVOH which serves only a packaging purpose.

Alternatively, the film forming agent can be a starch derivative, e.g. carboxymethyl starch either alone or in combination with other film forming agent(s) supra. The starch derivatives are best suitable to be used when the product filling contains enzymes other than amylase. CMS has an additional effect by acting as an active ingredient of the detergent by being a dirt suspension agent and therefore is superior for the use as a film forming agent in laundry and other cleaning applications verses PVOH which serves only a packaging purpose.

Alternatively, the film forming agent can be guar gum alone or in combination with other film forming agent(s) supra including, but not limited to, other (non)-starch-or-cellulose-derivative film forming agents. Guar gum is best suitable to be used when the product filling contains enzymes other than mannanase.

Alternatively, the film forming agent can be xanthan gum alone or in combination with other film forming agent(s) supra including, but not limited to, other (non)-starch-or-cellulose-derivative film forming agents. Commercially available xanthan gum has a high, thick viscosity making it difficult to use at e.g., 25,000 to 250,000 cPs. The future availability of a low viscosity xanthan gum could be easier to use in the disclosed film forming compositions as xanthan can be highly resistant to most industrially used enzymes found in detergents and other cleaning materials.

In one embodiment, the film packaging of products for home and personal care can have in the film composition at least one film forming agent ranging from at least one of 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-75, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming agent(s) based on dry film weight.

In one embodiment, the packaging of products for home and personal care can have in the film composition at least one film forming agent ranging from at least one of 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-75, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming agent(s) based on dry film weight.

In one embodiment, the film packaging of products for home and personal care can have in the film composition a plasticizer(s) including, but not limited to, at least one of glycerol, sorbitol, xylitol, propylene glycol, polyethylene glycol, citric acid, glucose, fructose, maleic acid and ascorbic acid.

In one embodiment, the packaging of products for home and personal care products can have in the film composition at least one plasticizer ranging from at least one of 15-45 1-60, 5-10, 5-35, 5-50, 5-60, 10-30, 10-35, 10-40, 10-50, 10-60, 15-25, 15-30, 15-45, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) by dry film weight including.

In one embodiment, the film packaging of products for home and personal care can have a film thickness (mm) of at least one of 0.01-0.09 mm, 0.01-0.5, 0.01-1, 0.01-3, 0.025-0.09, 0.03-0.08, 0.03-0.09, 0.03-0.12, 0.03-0.5, 0.03-2, 0.03-3, 0.035-0.099, 0.04-0.08, 0.04-0.09, 0.04-0.12, 0.04-0.25, 0.04-0.5, 0.04-2, 0.04-3, 0.05-0.08, 0.05-0.095, 0.05-0.1, 0.05-0.12, 0.05-0.25, 0.05-0.5, 0.05-2, 0.05-3, 0.06-0.085, 0.06-0.09, 0.06-0.1, 0.06-0.15, 0.06-0.25, 0.06-0.5, 0.06-2, 0.06-3, 0.07-0.1, 0.07-0.12, 0.07-0.15, 0.07-0.25, 0.07-2, 0.07-3, 0.08-0.12, 0.08-0.15, 0.08-0.5, 0.08-2, 0.08-3, 0.1-0.25, 0.1-0.5, 0.1-2, 0.1-3, 0.12-0.35, 0.2-0.5, 0.25-1, 0.5-2, 0.5-3, 1-3, 2-5 and 3-5 mm.

Home and personal care products packaged in the disclosed films can have a total weight including, but not limited to, from 0.2 g, 0.3 g, 0.4 g, and 0.5 g to ≥1.0 g, 0.5-5.0 g, 1.0-3.0 g, 3-6 g, 8.0 g, 10.0 g, 7-15 g, 7-30 g, 15-150 g, ≥1 g to 20 g, ≥5 g to 15 g, ≥5 g to 50 g, ≥ 40 g to 100 g, ≥7 g to 150 g, ≥10 g to 200 g, ≥100 g to 500 g, ≥200 g to 1000 g, ≥1000 g to 10.0 kg, ≥10.0 kg to 100.0 kg, ≥100.0 kg to 1000.0 kg and ranges within each of these ranges.

In one embodiment, the film composition of films for packaging home and personal care products can have at least one of 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-75, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming agent(s) based on dry film weight of a FF agent including, but not limited to, at least one of CMC including salts and cross-linked forms thereof, pullulan, guar gum, alginates, and HPMC, HEC, pectins and salts thereof, casein, gelatin, CMS including salts and cross-linked forms thereof, xanthan gum and pb-PVOH; at least one of 15-45 1-60, 5-10, 5-35, 5-50, 5-60, 10-30, 10-35, 10-40, 10-50, 10-60, 15-25, 15-30, 15-45, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) by dry film weight including, but not limited to at least one of glycerol, sorbitol, xylitol, propylene glycol, polyethylene glycol, citric acid, glucose, fructose, maleic acid and ascorbic acid in the film composition of films for packaging home and personal care products. The films for packaging home and personal care products can have a thickness of at least one of 0.01-3, 0.025-0.09, 0.03-0.12, 0.035-0.099, 0.04-0.25, 0.05-0.095, 0.05-0.12, 0.05-0.5, 0.06-0.085, 0.06-0.15, 0.07-2, 0.1-0.5, 0.12-0.35, 0.2-0.5, 0.25-1, 1-3, 2-5 mm, and a gross weight including, but not limited to, from 0.2 g, 0.3 g, 0.4 g, and 0.5 g to ≥1.0 g, 0.5-5.0 g, 1.0-3.0 g, 3-6 g, 8.0 g, 10.0 g, 7-15 g, 7-30 g, 15-150 g, ≥1 g to 20 g, ≥5 g to 15 g, ≥5 g to 50 g, ≥40 g to 100 g, ≥7 g to 150 g, ≥10 g to 200 g, ≥100 g to 500 g, ≥200 g to 1000 g, ≥1000 g to 10.0 kg, ≥10.0 kg to 100.0 kg, ≥100.0 kg to 1000.0 kg because the film packaging for home and personal care products can be torn, twisted or pulled open in a conventional way to access and retrieve contents encased by the film packaging for home and personal care products and thereby provides consistent delivery of the contents and no waste from the film packaging which can be thrown away without creating landfill/plastic waste as the film can be composted.

C. Honey (Sweetener) and Flavoring Packets

The disclosed films can be used in the production of pre-measured honey (sweetener) and flavoring packets and/or flavorings that can be dissolved in either hot, cold or hot and cold hydro-liquids including water, and/or torn, twisted, and/or pulled open in a conventional way. Additionally, the film packets can be tuned to dissolve in hot or cold hydro-liquids including water or both depending on the end use of the contents. The product can also be orally consumed. Additionally, there can also be additives including, but not limited to, at least one of, sticky or jellied food products, honey, syrups, edible sports/energy gels, beverage concentrates as well as flavorings, herbs/spices, sugar, salt/pepper, curry, food colorants and combinations thereof, superfood/smoothie/protein powders, ground materials (possibly from freeze-dried solutions) for making tea/coffee/cocoa/hot chocolate, but also juices, soft drinks, beverage powders and the like, powders or ground forms of tea, coffee, hot chocolate, milk, cream, cocoa, flavorings but also juices, soft drinks, beverage powders and the like, oils including, but not limited to, lemon, hazelnut, almond, and other nuts, colorants and so on. The shape can include, but is not limited to, spherical, oval, and rectangular and other 3D shapes. Individual packets can be covered with anti-stickiness powder to avoid packets from sticking together.

In one embodiment, the film composition for the honey (sweetener) and flavoring packets can have a film forming agent that is plant based, biodegradable, compostable, and free of petrochemicals including, but not limited to, CMC including salts and cross-linked forms thereof, pullulan, alginates, guar gum, HPMC, starch, pectins and salts thereof, pb-PVOH, and CMS including salts and cross-linked forms thereof. In another embodiment the film composition for the honey (sweetener) and flavoring packets can have a film forming agent that can be a protein including, but not limited to, casein and gelatin. The film forming agent(s) for the honey (sweetener) and flavoring packets can have a film composition having a total wt. % of biodegradable film forming agent(s) based on dry film weight of one or more film forming agents of at least one of 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of at least one of CMC including salts, cross-linked and modified forms thereof, pullulan, alginates, guar gum, HPMC, casein, gelatin, pb-PVOH, starch, pectins and salts thereof and CMS including salts and cross-linked forms thereof.

In one embodiment, the film forming agent(s) for the honey (sweetener) and flavoring packets can include, but are not limited to, a film composition having at least one of CMC including salts, cross-linked and modified forms thereof, pullulan, alginates, guar gum, HPMC, casein, gelatin, pb-PVOH, and CMS including salts, cross-linked and modified forms thereof.

In one embodiment, honey (sweetener) and flavoring packets can have in the film composition at least one film forming agent ranging from, 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-75, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming agent(s) based on dry film weight.

In another embodiment, honey (sweetener) and flavoring packets can have as a plasticizer a sugar glycol including, but not limited to, glycerol, xylitol, sorbitol, and propylene glycol because each is edible, economical, GRAS accepted and abundant. In yet another embodiment the plasticizer can be a sugar, such as glucose or fructose. In yet another embodiment, the plasticizer can be a weak acid including, but not limited to, citric acid and ascorbic acid because each is water soluble, GRAS accepted, edible and can promote polymer cross-linking to aid in retarding film packaging solubility.

In one embodiment, the plasticizer(s) for the honey (sweetener) and flavoring packets can include, but are not limited to, a film composition having at least one of glycerol, sorbitol, xylitol, citric acid, ascorbic acid, glucose, fructose and propylene glycol.

In one embodiment, honey (sweetener) and flavoring packets can have in the film composition at least one plasticizer ranging from at least one 15-45 1-60, 5-10, 5-35, 5-50, 5-60, 10-30, 10-35, 10-40, 10-50, 10-60, 15-25, 15-30, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) by dry film weight including, but not limited to,

In another embodiment, the film composition for honey (sweetener) and flavoring packets can have a thickness (mm) of at least one of 0.01-0.09 mm, 0.01-0.5, 0.01-1, 0.01-3, 0.025-0.09, 0.03-0.08, 0.03-0.09, 0.03-0.12, 0.03-0.5, 0.03-2, 0.03-3, 0.035-0.099, 0.04-0.08, 0.04-0.09, 0.04-0.12, 0.04-0.25, 0.04-0.5, 0.04-2, 0.04-3, 0.05-0.08, 0.05-0.095, 0.05-0.1, 0.05-0.12, 0.05-0.25, 0.05-0.5, 0.05-2, 0.05-3, 0.06-0.085, 0.06-0.09, 0.06-0.1, 0.06-0.15, 0.06-0.25, 0.06-0.5, 0.06-2, 0.06-3, 0.07-0.1, 0.07-0.12, 0.07-0.15, 0.07-0.25, 0.07-2, 0.07-3, 0.08-0.12, 0.08-0.15, 0.08-0.5, 0.08-2, 0.08-3, 0.1-0.25, 0.1-0.5, 0.1-2, 0.1-3, 0.12-0.35, 0.2-0.5, 0.25-1, 0.5-2, 0.5-3, 1-3, 2-5 and 3-5 mm.

In one embodiment, honey (sweetener) and flavoring packets can have at least one 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming agent(s) based on dry film weight including, but not limited to at least one of CMC including salts and cross-linked forms thereof, pullulan, guar gum, alginates, and HPMC, pectins and salts thereof, casein, gelatin, CMS including salts and cross-linked forms thereof, and pb-PVOH; at least one of 15-45 1-60, 5-10, 5-35, 5-50, 5-60, 10-30, 10-35, 10-40, 10-50, 10-60, 15-25, 15-30, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) by dry film weight including, but not limited to at least one of glycerol, sorbitol, xylitol, propylene glycol, citric acid, glucose, fructose and ascorbic acid in the honey (sweetener) and flavoring packets having a thickness of at least one of 0.8 mm, 0.85 mm, 0.9 mm, 0.95 mm, and 1.0 mm and wherein the can have a total weight including, but not limited to, from 0.2 g, 0.3 g, 0.4 g, and 0.5 g to ≥1.0 g, 0.5-5.0 g, 1.0-3.0 g, 3-6 g, 8.0 g, 10.0 g, 7-15 g, 7-30 g, 15-150 g, ≥1 g to 20 g, ≥5 g to 15 g, ≥5 g to 50 g, 40 g to 100 g, 27 g to 150 g, ≥10 g to 200 g, ≥100 g to 500 g, ≥200 g to 1000 g, ≥1000 g to 10.0 kg, ≥10.0 kg to 100.0 kg because the honey (sweetener) and flavoring packets readily dissolve in 20, 25, 30, 35-45, 45-60, and 60-75 seconds or less, rapidly breaks up with heating in 2-4 minutes, releasing contents either embedded within and/or encased by the honey (sweetener) and flavoring packets' composition and thereby provide consistent delivery of the contents and no waste from the honey (sweetener) and flavoring packets ‘film due to their being compostable.

D. Orally Consumable Packages

The disclosed films as packaging material with limited or negligible water solubility can be used as an external packaging material for consumable food products, such as meat, sweets (chocolate, candies, and the like), pre-measured packages/snacks/beverages with high water-content food products, including, but not limited to, dairy products (including but not limited to yogurts, cheese), soft drinks, alcoholic drinks, sticky or jellied food products, honey, syrups, jams, edible sports/energy gels. The packaging for orally consumable foods and filling can be surrounded by a film composition having plant-based material(s) that has low or negligible water-solubility but can be edible. The product can be orally consumed, solubilized in a hydro-liquid including water or physically opened. The shape of the package can be spherical, oval, rectangular, capsule and other 3D shapes. The water-solubility of the packaging material can be tuned from low to negligible solubility according to the moisture/water-content of the food(s) and/or filling(s) packaged/encased by the disclosed films. Additionally, the film packaging material can be formulated for oral consumption, environmental temperature and/or moisture content, shelf-life and/or storage.

A non-limiting example can be orally consumable yogurt (or other milk product) packages. These snacks use film forming agents, and optionally solubility reducers, to create a film that withstands the moisture/water-content of the yogurt. The package can be formulated to withstand the high moisture/water-content for as long as the shelf life of the product (up to a few months) and often can be stored in the refrigerator but dissolves easily in the gut. The thickness of the film can be not less than 0.01 to 0.5 mm and up to 1 to 2 mm. The shape of the package can be spherical, oval, rectangular and other shapes.

The orally consumable product(s) can have a total weight including, but not limited to, ranges from 0.2 g, 0.3 g, 0.4 g, and 0.5 g to ≥1.0 g, 0.5-5.0 g, 1.0-3.0 g, 3-6 g, 8.0 g, 10.0 g, 7-15 g, 7-30 g, 15-150 g, ≥1 g to 20 g, ≥5 g to 15 g, ≥5 g to 50 g, ≥40 g to 100 g, ≥7 g to 150 g, ≥10 g to 200 g, ≥100 g to 500 g, ≥200 g to 1000 g, ≥1000 g to 10.0 kg, ≥10.0 kg to 100.0 kg and ranges within each of these ranges.

Orally consumable packets can contain edible sports gels, syrups and concentrated beverages can be a delivery/carrier medium for the contents encased within the film packaging of oral consumables and the film packaging can be tuned to be orally consumed, dissolved in either hot, cold or hot and cold hydro-liquids including water, and/or torn, twisted, and/or pulled open in a conventional way to release the film packet's contents without creating plastic waste. The shape of the package can be spherical, oval, rectangular or 3D other shapes.

Orally consumable packets can also contain (strong) alcoholic beverages, colorants, flavoring additives, syrups and other additives that can be carried/delivered by the film packaging for oral consumables disclosed herein. The film packets for oral consumables can have a composition tuned for use as an external packaging material with limited or negligible water solubility for packaging fillings/consumables having >10% moisture/water content, can be edible, formulated from plant-based materials, biodegradable, compostable, easily dissolving in the gut, stable under refrigeration, dissolvable in either hot, cold or hot and cold hydro-liquids including water, and/or torn, twisted, and/or pulled open in a conventional way to release the film package's contents and does not create landfill or plastic waste. The shape of the packaging for oral consumables can be spherical, oval, rectangular or 3D other shapes.

In one embodiment, the film composition for the packaging of oral consumables can have a film forming agent that can be plant based, can be tuned for use as an external packaging material for limited or negligible water solubility, can be edible, easily dissolving in the gut, stable under refrigeration, moisture/water resistant, biodegradable, compostable, and free of petrochemicals.

In one embodiment, the packaging for oral consumables can have in the film forming composition at least one film forming agent including, but not limited to, CMC including salts, cross-linked and modified forms thereof, pullulan, alginates, guar gum, HPMC, casein, gelatin, pectins and salts thereof, pb-PVOH, and CMS including salts and cross-linked forms thereof. In another embodiment the film composition for the oral consumable packets can have a film forming agent that can be a protein including, but not limited to, casein and gelatin. The film forming agent(s) for the oral consumable packets can have a film composition having a total wt. % based on dry film weight of one or more film forming agents of 35-95 wt. % of at least one of CMC including salts, cross-linked and modified forms thereof, pullulan, alginates, guar gum, HPMC, casein, gelatin, pectins and salts thereof, pb-PVOH and CMS including salts and cross-linked forms thereof.

Film forming agent(s) can be present in a film composition of the present invention in any one of the following wt. % ranges based on dry film weight: 5-95, 5-15, 5-25, 5-30, 10-40, 30-90, 25-95, 25-75, 25-55, 27-55, 27-75, 27-95, 30-55, 30-70, 30-95, 35-90, 35-45, 35-50, 35-55, 35-60, 35-65, 35-75, 35-80, 35-85, 35-95, 40-50, 40-55, 40-60, 40-65, 40-70, 40-75, 40-80, 40-85, 40-90, 40-95, 45-55, 45-60, 45-65, 45-70, 45-75, 45-80, 45-85, 45-90, 45-95, 50-60, 50-65, 50-70, 50-75, 50-80, 50-85, 50-90, 50-95, 55-65, 55-70, 55-75, 55-80, 55-85, 55-90, 55-95, 60-70, 60-75, 60-80, 60-85, 60-90, 60-95, 65-75, 65-80, 65-85, 65-90, 65-95, 70-80, 70-82, 70-85, 70-90, 70-95, 75-85, 75-90, 75-95, 80-90, 80-95, 85-95, 1-99, 5-99, 25-99, 90-99 wt. % of total biodegradable film forming agent. In one embodiment the film forming agent comprises 30-95 wt. % by dry film weight of the film composition.

In one embodiment, the packaging for oral consumables can have in the film composition at least one film forming agent ranging from at least one of 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming agent(s) based on dry film weight.

In another embodiment, the packaging for oral consumables can have as a plasticizer a sugar glycol including, but not limited to, glycerol, xylitol, sorbitol, and propylene glycol because each is edible, economical, GRAS accepted and abundant.

In yet another embodiment the plasticizer can be a sugar, such as glucose or fructose. In yet another embodiment, the plasticizer can be a weak acid including, but not limited to, citric acid and ascorbic acid because each is water soluble, GRAS accepted, edible and can promote polymer cross-linking to aid in retarding film packaging solubility.

In one embodiment, the packaging for oral consumables can have in the film composition a plasticizer(s) including, but not limited to, at least one of glycerol, sorbitol, xylitol, propylene glycol, citric acid, glucose, fructose and ascorbic acid.

In one embodiment, the packaging for oral consumables can have in the film composition at least one plasticizer ranging from at least one of 15-45 1-60, 5-10, 5-35, 5-50, 5-60, 10-30, 10-35, 10-40, 10-50, 10-60, 15-25, 15-30, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) by dry film weight.

In one embodiment, the packaging for oral consumables can have in the film composition at least one solubility reducer(s) including, but not limited to, at least one of citric acid, acetic acid, maleic acid, folic acid, tartaric acid, fumaric acid, lactic acid, dilute phosphoric acid, sodium and potassium lactate salts, ascorbic acid, and sodium ascorbate. In addition, the following materials can also reduce/retard solubility: croscarmellose (cross-linked (Na+) CMC), sodium starch glycolate, lecithins extracted from soy, sunflower, rapeseed, cottonseed, eggs, milk, malonic acid, and the like, calcium salts including, but not limited to calcium lactate, calcium chloride and the like, and potentially a plant-based, cross-linked polyvinylpyrrolidone. The lowering of the pH with a weak acid can promote polymer crosslinking which can slow solubility but the decrease in pH can also retard the solubility rate of the film forming agent(s) used for orally consumable packaging. Additional potential solubility reducers can be found in Table 1 for use with orally consumable products.

In one embodiment, the packaging for oral consumables can have in the film composition at least one solubility reducer(s) ranging from at least one of 0.1-70 wt. % 0.1-10, 10-15, 15-25, 25-30, 30-50, 20-50, 0.1-65, 10-65, and 25-70 wt. % based on dry film weight.

In another embodiment, the film composition for producing packaging for oral consumables can have a thickness (mm) of at least one of 0.01-0.09 mm, 0.01-0.5, 0.01-1, 0.01-3, 0.025-0.09, 0.03-0.08, 0.03-0.09, 0.03-0.12, 0.03-0.5, 0.03-2, 0.03-3, 0.035-0.099, 0.04-0.08, 0.04-0.09, 0.04-0.12, 0.04-0.25, 0.04-0.5, 0.04-2, 0.04-3, 0.05-0.08, 0.05-0.095, 0.05-0.1, 0.05-0.12, 0.05-0.25, 0.05-0.5, 0.05-2, 0.05-3, 0.06-0.085, 0.06-0.09, 0.06-0.1, 0.06-0.15, 0.06-0.25, 0.06-0.5, 0.06-2, 0.06-3, 0.07-0.1, 0.07-0.12, 0.07-0.15, 0.07-0.25, 0.07-2, 0.07-3, 0.08-0.12, 0.08-0.15, 0.08-0.5, 0.08-2, 0.08-3, 0.1-0.25, 0.1-0.5, 0.1-2, 0.1-3, 0.12-0.35, 0.2-0.5, 0.25-1, 0.5-2, 0.5-3, 1-3, 2-5 and 3-5 mm.

In one embodiment, oral consumable packets can have at least one of 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming agent(s) based on dry film weight including, but not limited to, at least one of CMC including salts, cross-linked and modified forms thereof, pullulan, alginates, guar gum, HPMC, casein, gelatin, pectins and salts thereof, pb-PVOH, and CMS including salts, cross-linked and modified forms thereof, and at least one of 15-45 1-60, 5-10, 5-35, 5-50, 5-60, 10-30, 10-35, 10-40, 10-50, 10-60, 15-25, 15-30, 15-45, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) by dry film weight including, but not limited to, at least one plasticizer of glycerol, sorbitol, xylitol, propylene glycol, citric acid, glucose, fructose and ascorbic acid. In one embodiment, the oral consumable packets can contain in the film composition at least one of 30-50, 20-50, 0.1-65, 10-65 wt. % of a solubility reducer of at least one of citric acid, acetic acid, maleic acid, folic acid, tartaric acid, fumaric acid, lactic acid, dilute phosphoric acid, sodium and potassium lactate salts, ascorbic acid, and sodium ascorbate. In addition, the following materials can also reduce/retard solubility: croscarmellose (cross-linked (Na+) CMC), sodium starch glycolate, lecithins extracted from soy, sunflower, rapeseed, cottonseed, eggs, milk, malonic acid, and the like, calcium salts including, but not limited to calcium lactate, calcium chloride and the like, and potentially a plant-based, cross-linked polyvinylpyrrolidone. In another embodiments, the oral consumable packets can be at least one of 0.01-3, 0.025-0.09, 0.03-0.12, 0.035-0.099, 0.04-0.25, 0.05-0.095, 0.05-0.12, 0.05-0.5, 0.06-0.085, 0.06-0.15, 0.07-2, 0.1-0.5, 0.12-0.35, 0.2-0.5, 0.25-1, 1-3, 2-5 mm thick and wherein the can have a total weight including, but not limited to, from 0.2 g, 0.3 g, 0.4 g, and 0.5 g to ≥1.0 g, 0.5-5.0 g, 1.0-3.0 g, 3-6 g, 8.0 g, 10.0 g, 7-15 g, 7-30 g, 15-150 g, ≥1 g to 20 g, ≥5 g to 15 g, ≥5 g to 50 g, ≥40 g to 100 g, ≥7 g to 150 g, ≥10 g to 200 g, ≥100 g to 500 g, ≥200 g to 1000 g, ≥1000 g to 10.0 kg, ≥10.0 kg to 100.0 kg. The packaging for oral consumables packets readily dissolve in the gut, rapidly breaks up during blending releasing contents encased by the oral consumable packets' and thereby provide consistent delivery of the encased contents. The packaging for oral consumables packets can be plant based, can be tuned for use as an external packaging material for limited or negligible water solubility, can be edible, moisture/water resistant, easily dissolving in the gut, stable under refrigeration, biodegradable, compostable, does not create landfill or plastic waste, and is substantially free of petrochemicals the oral consumable packets' can provide consistent delivery of the contents and no waste from the packet's film due to their being compostable.

E. FILM Packaging for use as Wraps, Bags, Pouches,

Pre-measured materials encased in film packages for use as wraps, bags and pouches can contain and deliver animal food for, including, but not limited to, pets, farm, zoo, zoological parks and aquatic animals like fish, amphibians and reptiles. The film packaging can be torn, twisted, and/or pulled open in a conventional way, dissolved in hot, cold or hot and cold hydro-liquids including water, as well as orally consumed. The disclosed film packaging compositions can also be formulated as sprayable, biodegradable, compostable and orally consumable films for fruits, vegetables and other food products to preserve, prevent oxidation and/or premature ripening.

The disclosed film packaging for use as wraps, bags and pouches can also be used in production processes which would otherwise degrade or destroy the film packages' contents. Film packaging with pre-measured content(s) can be formulated to have resistance to heating, high shear mixing and the like. Thus, the film packages for use as wraps, bags and pouches can enable gradual and/or delayed dissolution and release of contents/additives used in manufacturing processes. As a result, the disclosed film packaging can be formulated to withstand production processes that would otherwise degrade the encased contents/additives when it can be otherwise desired that the contents can be delivered/exert their effect(s) in conjunction with gradual and/or delayed film packaging dissolution. Such contents can include but are not limited to food additives including, but not limited to pro- and prebiotics.

The film packages for use as wraps, bags and pouches can have a composition tuned for use as an external packaging material with limited or negligible water solubility for packaging fillings/consumables having >10% moisture/water content, can be edible, formulated from plant-based materials, biodegradable, compostable, easily dissolving in the gut, stable under refrigeration, dissolvable in either hot, cold or hot and cold hydro-liquids including water, and/or torn, twisted, and/or pulled open in a conventional way to release the film package's contents and does not create landfill or plastic waste. The shape of the packaging for film packages for use as wraps, bags and pouches can be spherical, oval, rectangular, pillow, or other 3D shapes.

In one embodiment, the film composition for film packages for use as wraps, bags and pouches can have a film forming agent that can be plant based, can be tuned for use as an external packaging material for limited or negligible water solubility, can be edible, easily dissolving in the gut, stable under refrigeration, moisture/water resistant, biodegradable, compostable, and free of petrochemicals.

In one embodiment, the packaging for film packages for use as wraps, bags and pouches can have in the film forming composition at least one film forming agent including, but not limited to, CMC including salts, cross-linked and modified forms thereof, pullulan, alginates, guar gum, HPMC, pb-PVOH, and CMS including salts and cross-linked forms thereof. In another embodiment the film composition for film packages for use as wraps, bags and pouches can have a film forming agent that can be a protein including, but not limited to, pectins and salts thereof, casein and gelatin. The film forming agent(s) for film packages for use as wraps, bags and pouches can have a film composition having a total wt. % based on dry film weight off 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming agent(s) based on dry film weight wt. % of one or more film forming agents of at least one of CMC including salts, cross-linked and modified forms thereof, pullulan, alginates, guar gum, HPMC, pectins and salts thereof, casein, gelatin, pb-PVOH and CMS including salts and cross-linked forms thereof. Additional ranges for plasticizers for use in non-edible applications including, but not limited to detergent, cleaning, home and personal care, agricultural, industrial, manufacturing, and environmental/marking/bagging packaging are listed in Tables 1 and 3, supra.

In one embodiment, the packaging for film packages for use as wraps, bags and pouches can have in the film composition at least one film forming agent ranging from at least one of 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming agent(s) based on dry film weight.

In another embodiment, the packaging for film packages for use as wraps, bags and pouches can have as a plasticizer a sugar glycol including, but not limited to, glycerol, xylitol, sorbitol, and propylene glycol because each is edible, economical, GRAS accepted and abundant. In yet another embodiment the plasticizer can be a sugar, such as glucose or fructose. In yet another embodiment, the plasticizer can be a weak acid including, but not limited to, citric acid and ascorbic acid because each is water soluble, GRAS accepted, edible and can promote polymer cross-linking to aid in retarding film packaging solubility.

In one embodiment, the packaging for film packages for use as wraps, bags and pouches can have in the film composition a plasticizer(s) including, but not limited to, at least one of glycerol, sorbitol, xylitol, propylene glycol, citric acid, and ascorbic acid.

In one embodiment, the packaging for film packages for use as wraps, bags and pouches can have in the film composition at least one plasticizer ranging from at least one of 15-45 1-60, 5-10, 5-35, 5-50, 5-60, 10-30, 10-35, 10-40, 10-50, 10-60, 15-25, 15-30, 15-45, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) by dry film weight.

In one embodiment, the packaging for film packages for use as wraps, bags and pouches can have in the film composition at least one solubility reducer(s) including, but not limited to, at least one of citric acid, acetic acid, maleic acid, folic acid, tartaric acid, fumaric acid, lactic acid, dilute phosphoric acid, sodium and potassium lactate salts, ascorbic acid, and sodium ascorbate. In addition, the following materials can also reduce/retard solubility: croscarmellose (cross-linked (Na+) CMC), sodium starch glycolate, lecithins extracted from soy, sunflower, rapeseed, cottonseed, eggs, milk, malonic acid, and the like, calcium salts including, but not limited to calcium lactate, calcium chloride and the like, and potentially a plant-based, cross-linked polyvinylpyrrolidone. The lower of the pH with a weak acid can promote polymer crosslinking which can slow solubility but the decrease in pH can also retard the solubility rate of the film forming agent(s) use for orally consumable packaging. Additional potential solubility reduces can be found in Table 1 for use with orally consumable products.

In one embodiment, the packaging for film packages for use as wraps, bags and pouches can have in the film composition at least one solubility reducer(s) ranging from at least one of 0.1-70 wt. % 0.1-10, 10-15, 15-25, 25-30, 30-50, 20-50, 0.1-65, 10-65, and 25-70 wt. % based on dry film weight.

In another embodiment, the film composition for producing film packages for use as wraps, bags and pouches can have a thickness (mm) of at least one of 0.01-0.09 mm, 0.01-0.5, 0.01-1, 0.01-3, 0.025-0.09, 0.03-0.08, 0.03-0.09, 0.03-0.12, 0.03-0.5, 0.03-2, 0.03-3, 0.035-0.099, 0.04-0.08, 0.04-0.09, 0.04-0.12, 0.04-0.25, 0.04-0.5, 0.04-2, 0.04-3, 0.05-0.08, 0.05-0.095, 0.05-0.1, 0.05-0.12, 0.05-0.25, 0.05-0.5, 0.05-2, 0.05-3, 0.06-0.085, 0.06-0.09, 0.06-0.1, 0.06-0.15, 0.06-0.25, 0.06-0.5, 0.06-2, 0.06-3, 0.07-0.1, 0.07-0.12, 0.07-0.15, 0.07-0.25, 0.07-2, 0.07-3, 0.08-0.12, 0.08-0.15, 0.08-0.5, 0.08-2, 0.08-3, 0.1-0.25, 0.1-0.5, 0.1-2, 0.1-3, 0.12-0.35, 0.2-0.5, 0.25-1, 0.5-2, 0.5-3, 1-3, 2-5 and 3-5 mm.

In one embodiment, film packages for use as wraps, bags and pouches can have at least one of 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming agent(s) based on dry film weight including, but not limited to, a film forming agent of at least one of CMC including salts, cross-linked and modified forms thereof, pullulan, alginates, guar gum, HPMC, pectins and salts thereof, casein, gelatin, starch, pb-PVOH, and CMS including salts, cross-linked and modified forms thereof, and at least one 15-45 1-60, 5-10, 5-35, 5-50, 5-60, 10-30, 10-35, 10-40, 10-50, 10-60, 15-25, 15-30, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) by dry film weight including, but not limited to a plasticizer of at least one of glycerol, sorbitol, xylitol, propylene glycol, citric acid, glucose, fructose and ascorbic acid. In one embodiment, the film packages for use as wraps, bags and pouches can contain in the film composition at least one of 30-50, 20-50, 0.1-65, 10-65 wt. % of a solubility reducer of at least one of citric acid, acetic acid, maleic acid, folic acid, tartaric acid, fumaric acid, lactic acid, dilute phosphoric acid, sodium and potassium lactate salts, ascorbic acid, and sodium ascorbate. In addition, the following materials can also reduce/retard solubility: croscarmellose (cross-linked (Na+) CMC), sodium starch glycolate, lecithins extracted from soy, sunflower, rapeseed, cottonseed, eggs, milk, malonic acid, and the like, calcium salts including, but not limited to calcium lactate, calcium chloride and the like, and potentially a plant-based, cross-linked polyvinylpyrrolidone. In another embodiments, the film packages for use as wraps, bags and pouches can be at least one of 0.01-3, 0.025-0.09, 0.03-0.12, 0.035-0.099, 0.04-0.25, 0.05-0.095, 0.05-0.12, 0.05-0.5, 0.06-0.085, 0.06-0.15, 0.07-2, 0.1-0.5, 0.12-0.35, 0.2-0.5, 0.25-1, 1-3, 2-5 mm thick and wherein the can have a total weight including, but not limited to, from 0.2 g, 0.3 g, 0.4 g, and 0.5 g to ≥1.0 g, 0.5-5.0 g, 1.0-3.0 g, 3-6 g, 8.0 g, 10.0 g, 7-15 g, 7-30 g, 15-150 g, ≥1 g to 20 g, ≥5 g to 15 g, ≥5 g to 50 g, ≥40 g to 100 g, ≥7 g to 150 g, ≥10 g to 200 g, ≥100 g to 500 g, ≥200 g to 1000 g, ≥1000 g to 10.0 kg, ≥10.0 kg to 100.0 kg. The packages for use as wraps, bags and pouches readily dissolve in the gut, rapidly break up during blending releasing contents encased by the film packages for use as wraps, bags and pouches and thereby provide consistent delivery of the encased contents. The packaging for film packages for use as wraps, bags and pouches can be plant based, can be tuned for use as an external packaging material for limited or negligible water solubility, can be edible, moisture/water resistant, easily dissolving in the gut, stable under refrigeration, biodegradable, compostable, does not create landfill or plastic waste, and is substantially free of petrochemicals the film packages for use as wraps, bags and pouches can provide consistent delivery of the contents and no waste from the film packages used as wraps, bags and pouches due to their being compostable.

F. Pre-Measured Food & Flavoring Packets

The disclosed films can be used in the production of pre-measured food and flavoring packets and/or flavorings that can be dissolved in either hot, cold or hot and cold hydro-liquids including water, and/or torn, twisted, and/or pulled open in a conventional way. The pre-measured food package products can contain, for example, dry ingredients, including, but not limited to, pasta, rice, noodles, millet, buckwheat, flour, soup (powders) and combinations thereof. Additionally, added to the dry ingredients as well can be dried vegetables/fruits, oils which can be mixed with herbs, spices, seeds, flavorings and other additives, alcohol-beverages, sticky or jellied food products, including but not limited to honey, syrups, edible sports/energy gels, beverage concentrates as well as flavorings, herbs/spices, sugar salt/pepper, curry, food colorants and combinations thereof, superfood/smoothie/protein powders, ground materials (possibly from freeze-dried solutions) for making tea/coffee/cocoa/hot chocolate, but also juices, soft drinks, beverage powders and the like. The disclosed films can also be formed as pre-measured packages or bags for use in dispensing pre-measured food for animals, including farm and domestic animals/pets, aquatic animals including fish, mammals, reptiles and opened by tearing with teeth, claws and can be orally consumed. Also envisioned are products produced with the disclosed films for containing, delivering, transporting defined amounts of any food item. The combinations could be in a single packet or package within a multi-compartment/pouch film package having individual pouches/compartments within a packet or package for separation, selective use of less than all or all of each individual pouch's contents.

Additionally, the produced package can be dissolved in hot, cold or cold and hot hydro-liquids including water and can be made from biodegradable and compostable film material and/or be substantially or completely soluble in a hydro-liquid. Alternatively, the produced package can dissolve in cold water but can be intended to dissolve in hot water, if the enclosed food is to be cooked prior to consumption. The package, following release of the film package contents contained therein, can be thrown away without creating plastic waste and/or it can be dissolved while boiling. A non-limiting example is a pre-measured package encasing dried soup ingredients accompanied with at least one of a vegetable(s), flavoring(s) and oil(s).

Another example can be a pre-measured package encasing rice or pasta with or without flavoring that dissolves when boiled. Yet another example can be a possibly dry, pre-measured porridge accompanied with at least one of a flavoring(s), sweetener(s) and oil(s). Another example can be a package of only flavorings, such as herbs and spices or oils intended to be used with noodles or ramen. Powdered ingredients for use in smoothie, superfood, vitamins, minerals, protein, and beverage preparations can be encased in a pre-measured food package. The package can also be opened by tearing, twisting, squeezing and/or pulling in a conventional way in addition to shaking, mixing, stirring and blender blades.

The package can be: 1) dissolved in cold, cool, warm, hot or cold and hot hydro-liquids, including water 2) torn, twisted, and/or pulled open in a conventional way 3) crushed in a blender and 4) orally consumed. Also, additives, such as nutritional supplements (vitamins, minerals, pro- and pre-biotics) oils, flavorings, colorants, herbs, spices and the like can be added either in the film composition and/or encased within the film package.

It is also envisioned that the disclosed film which forms the package can be formulated to better withstand humid environmental conditions and would not dissolve or become too sticky during storage and handling. Thus, a polysaccharide including, but not limited to, a cross-linked cellulose-based, pectin-based and/or a starch-based film forming agent can be considered due to each agent having the ability to swell and absorb moisture of these agents. In addition, a solubility reducer, as described supra, such as citric acid and other weak acids can also be used for the same purpose.

Pre-measured packages of powders or ground material for making beverages, including coffee, tea, cocoa, hot chocolate and also juices, soft drinks, and the like can be dissolved in either hot, cold or hot and cold hydro-liquids including water and/or can be torn, twisted, and/or pulled open in a conventional way. A non-limiting example can be water-soluble packages of beverage powder which enable making soft drinks, juices and other drinks.

In one embodiment, the film composition for edible pre-measured food and flavoring packets can have a film forming agent that can be a polysaccharide because they can be biodegradable, compostable, and free of petrochemicals.

In one embodiment, the film composition for the pre-measured food and flavoring packets can have a film forming agent that is plant based, biodegradable, compostable, and free of petrochemicals including, but not limited to, CMC including salts and cross-linked forms thereof, pullulan, alginates, guar gum, HPMC, pectins and salts thereof, pb-PVOH, gelatin, casein, and CMS including salts and cross-linked forms thereof. The film forming agent(s) for the pre-measured food and flavoring packets can have a film composition having a total wt. % based on dry film weight of one or more film forming agents of 35-95 wt. %.

In another embodiment, edible pre-measured food and flavoring packets can have in the film composition a sugar glycol as a plasticizer including, but not limited to, glycerol, xylitol, sorbitol, and propylene glycol, because each is edible, economical, GRAS accepted and abundant. In yet another embodiment the plasticizer can be a sugar, such as glucose or fructose. In yet another embodiment, the plasticizer can be a weak acid including, but not limited to, citric and ascorbic acid because each is water soluble, GRAS accepted, edible and can promote polymer cross-linking.

In one embodiment, pre-measured food and flavoring packets can have in the film composition at least one biodegradable film forming agent ranging from 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming agent(s) based on dry film weight.

In another embodiment, pre-measured food and flavoring packets can have as a plasticizer a sugar glycol including, but not limited to, glycerol, xylitol, sorbitol, and propylene glycol, because each is edible, economical, GRAS accepted and abundant. In yet another embodiment, the plasticizer can be a weak acid including, but not limited to, citric and ascorbic acid because each is water soluble, GRAS accepted, edible and can promote polymer cross-linking.

In one embodiment, the plasticizer(s) for the pre-measured food and flavoring packets can include, but are not limited to, a film composition having at least one of glycerol, sorbitol, xylitol, propylene glycol, citric acid, and ascorbic acid.

In one embodiment, pre-measured food and flavoring packets can have in the film composition at least one biodegradable plasticizer ranging from at least one of 15-45 1-60, 5-10, 5-35, 5-50, 5-60, 10-30, 10-35, 10-40, 10-50, 10-60, 15-25, 15-30, 15-45, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) by dry film weight.

In one embodiment, the pre-measured food and flavoring packets can have a film thickness (mm) of at least one of 0.01-0.09 mm, 0.01-0.5, 0.01-1, 0.01-3, 0.025-0.09, 0.03-0.08, 0.03-0.09, 0.03-0.12, 0.03-0.5, 0.03-2, 0.03-3, 0.035-0.099, 0.04-0.08, 0.04-0.09, 0.04-0.12, 0.04-0.25, 0.04-0.5, 0.04-2, 0.04-3, 0.05-0.08, 0.05-0.095, 0.05-0.1, 0.05-0.12, 0.05-0.25, 0.05-0.5, 0.05-2, 0.05-3, 0.06-0.085, 0.06-0.09, 0.06-0.1, 0.06-0.15, 0.06-0.25, 0.06-0.5, 0.06-2, 0.06-3, 0.07-0.1, 0.07-0.12, 0.07-0.15, 0.07-0.25, 0.07-2, 0.07-3, 0.08-0.12, 0.08-0.15, 0.08-0.5, 0.08-2, 0.08-3, 0.1-0.25, 0.1-0.5, 0.1-2, 0.1-3, 0.12-0.35, 0.2-0.5, 0.25-1, 0.5-2, 0.5-3, 1-3, 2-5 and 3-5 mm.

The pre-measured food and flavoring packets can have a total weight including, but not limited to, from 0.2 g, 0.3 g, 0.4 g, and 0.5 g to ≥1.0 g, 0.5-5.0 g, 1.0-3.0 g, 3-6 g, 8.0 g, 10.0 g, 7-15 g, 7-30 g, 15-150 g, ≥1 g to 20 g, ≥5 g to 15 g, ≥5 g to 50 g, ≥40 g to 100 g, ≥7 g to 150 g, ≥10 g to 200 g, ≥100 g to 500 g, ≥200 g to 1000 g, ≥1000 g to 10.0 kg, ≥10.0 kg to 100.0 kg and ranges within each of these ranges.

In one embodiment, the pre-measured food and flavoring packets can have at least one of 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming agent(s) based on dry film weight based on dry film weight of a film forming agent of at least one of CMC including salts and cross-linked forms thereof, pullulan, guar gum, alginates, sodium alginate, and HPMC, pectins and salts thereof, sodium pectinate, gelatin, casein, CMS including salts and cross-linked forms thereof, and pb-PVOH; at least one 15-45 1-60, 5-10, 5-35, 5-50, 5-60, 10-30, 10-35, 10-40, 10-50, 10-60, 15-25, 15-30, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) by dry film weight including, but not limited to a plasticizer of at least one of glycerol, sorbitol, xylitol, propylene glycol, citric acid, glucose, fructose and ascorbic acid in the pre-measured food and flavoring packets having a thickness of at least one of 0.01-3, 0.025-0.09, 0.03-0.12, 0.035-0.099, 0.04-0.25, 0.05-0.095, 0.05-0.12, 0.05-0.5, 0.06-0.085, 0.06-0.15, 0.07-2, 0.1-0.5, 0.12-0.35, 0.2-0.5, 0.25-1, 1-3, 2-5 mm because the pre-measured food and flavoring packets readily dissolve in 20, 25, 30, 35-45, 45-60, and 60-75 seconds or less, rapidly breaks up with heating in 2-4 minutes, releasing contents either embedded within and/or encased by the pre-measured food and flavoring packet composition and wherein the pre-measured food and flavoring packets can have a total weight including, but not limited to, from 0.2 g, 0.3 g, 0.4 g, and 0.5 g to ≥1.0 g, 0.5-5.0 g, 1.0-3.0 g, 3-6 g, 8.0 g, 10.0 g, 7-15 g, 7-30 g, 15-150 g, ≥1 g to 20 g, ≥5 g to 15 g, ≥5 g to 50 g, ≥40 g to 100 g, ≥7 g to 150 g, ≥10 g to 200 g, ≥100 g to 500 g, ≥200 g to 1000 g, ≥1000 g to 10.0 kg, ≥10.0 kg to 100.0 kg thereby provide consistent delivery of the contents and no waste from the pre-measured food and flavoring packets' film due to their being compostable.

G. Edible Packages and Pads

The edible packages and pads can contain, for example, dry ingredients, including, but not limited to, pasta, rice, noodles, millet, buckwheat, flour, soup (powders) and combinations thereof. Additionally, added to the dry ingredients as well can be dried vegetables/fruits, oils which can be mixed with herbs, spices, seeds, flavorings and other additives, alcohol-beverages, sticky or jellied food products, including but not limited to honey, syrups, edible sports/energy gels, beverage concentrates as well as flavorings, herbs/spices, sugar salt/pepper, curry, food colorants and combinations thereof, superfood/smoothie/protein powders, ground materials (possibly from freeze-dried solutions) for making tea/coffee/cocoa/hot chocolate, but also juices, soft drinks, beverage powders and the like. The disclosed edible packages and pads can also be used for dispensing pre-measured food for animals, including farm and domestic animals/pets, aquatic animals including fish, mammals, reptiles and opened by tearing with teeth, claws and can be orally consumed. Also envisioned are products produced with the disclosed films for containing, delivering, transporting defined amounts of any food item. The combinations could be in a single packet or package within a multi-compartment/pouch film package having individual pouches/compartments within a packet or package for separation, selective use of less than all or all of each individual pouch's contents.

Additionally, the edible packages and pads can be dissolved in hot, cold or cold and hot hydro-liquids including water and can be made from biodegradable and compostable film material and/or be substantially or completely soluble in a hydro-liquid. Alternatively, the package can be torn, twisted, and/or pulled open in a conventional way to release the film package contents contained therein without creating plastic waste and/or it can be dissolved while boiling. A non-limiting example of an edible packages and pad that encases or has embedded in the film composition (pad) dried soup ingredients accompanied with at least one of a vegetable(s), flavoring(s) and oil(s). Another example can be containing ingredients such as vitamins, minerals, and protein encased or embedded in the edible package or pad, respectively. The package can also be opened by tearing, twisting, squeezing and/or pulling in a conventional way in addition to subjecting the package or pad to shaking, mixing, stirring and blender blades.

The package and pad can be: 1) orally consumed 2) crushed in a blender 3) dissolved in cold, cool, warm, hot or cold and hot hydro-liquids, including water and 4) torn, twisted, and/or pulled open in a conventional way. Also, additives, such as nutritional supplements (vitamins, minerals, pro- and pre-biotics) oils, flavorings, colorants, herbs, spices and the like can be added either in the film composition and/or encased within the edible film package.

Edible packages and pads offer several advantages including, but not limited to being biodegradable, can be edible, dissolve in hydro-liquids including water and can be compostable, can be torn open to empty the contents and the packaging can be disposed without creating landfill waste.

The disclosed edible films and pads can be used for consumable food products, such as sweets (chocolate, candies, and the like), pre-measured snacks. product can be orally consumed, solubilized in a hydro-liquid including water or physically opened. The shape of the package can be spherical, oval, rectangular, capsule, pillow and other 3D shapes. The edible film as a packaging material can be formulated for oral consumption offering convenience and free of packaging waste.

The film forming agent(s) for the edible packages/pads can be carboxymethyl cellulose (CMC) including salts and cross-linked forms thereof, a polysaccharide, hydrolyzed collagen, plant-based polyvinyl alcohol (pb-PVOH), casein. The polysaccharide can be one or more of pullulan, alginates, guar gum, xanthan gum, carrageenan, starch, agar, hydroxyethyl cellulose, hydroxypropyl methyl cellulose (HPMC), pectins and salts thereof.

Film forming agent(s) can be present in a film composition of the present invention in any one of the following wt. % ranges based on dry film weight: 5-95, 5-15, 5-25, 5-30, 10-40, 30-90, 25-95, 25-75, 25-55, 27-55, 27-75, 27-95, 30-55, 30-70, 30-95, 35-90, 35-45, 35-50, 35-55, 35-60, 35-65, 35-75, 35-80, 35-85, 35-95, 40-50, 40-55, 40-60, 40-65, 40-70, 40-75, 40-80, 40-85, 40-90, 40-95, 45-55, 45-60, 45-65, 45-70, 45-75, 45-80, 45-85, 45-90, 45-95, 50-60, 50-65, 50-70, 50-75, 50-80, 50-85, 50-90, 50-95, 55-65, 55-70, 55-75, 55-80, 55-85, 55-90, 55-95, 60-70, 60-75, 60-80, 60-85, 60-90, 60-95, 65-75, 65-80, 65-85, 65-90, 65-95, 70-80, 70-82, 70-85, 70-90, 70-95, 75-85, 75-90, 75-95, 80-90, 80-95, 85-95, 1-99, 5-99, 25-99, 90-99 wt. % of total biodegradable film forming agent(s).

wt. % of total biodegradable film forming agent. In one embodiment the film forming agent comprises 30-95 wt. % by dry film weight of the film composition.

In one embodiment, the packaging for edible packages/pads can have in the film composition at least one film forming agent ranging from at least one of 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming agent(s) based on dry film weight.

In another embodiment, the edible packets, packages/pads as water-soluble packages include, but are not limited to, 3D-shaped packages including, but not limited to, packet, pad, pouch, pillow, spherical, cuboidal, pyramidal, capsule, tear-drop and multiples and combinations thereof.

In another embodiment, the edible package and pads can have in the film composition a sugar glycol as a plasticizer including, but not limited to, glycerol, xylitol, sorbitol, and propylene glycol because each is edible, economical, GRAS accepted and abundant. In yet another embodiment the plasticizer can be a sugar, such as glucose or fructose. In yet another embodiment, the plasticizer can be a weak acid including, but not limited to, citric acid and ascorbic acid because each is water soluble, GRAS accepted, edible and can promote polymer cross-linking.

Cross-linking of film forming agents can be used to tune the solubility of the resulting product's use of the film packaging in consideration of the moisture content of the edible(s) encased by the film packaging and the moisture and/or humidity conditions of the environment that the film packaging's final use product can be exposed during shipping, storage and shelf-life.

In one embodiment, edible packages and pads can have in the film composition at least one plasticizer ranging from at least one of 15-45 1-60, 5-10, 5-35, 5-50, 5-60, 10-30, 10-35, 10-40, 10-50, 10-60, 15-25, 15-30, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) by dry film weight. Selections of film forming agents, plasticizers and wt. % amounts are further delineated in Tables 1-3.

In another embodiment, the film composition for edible packets, packages/pad can have a thickness (mm) of at least one of 0.01-0.09 mm, 0.01-0.5, 0.01-1, 0.01-3, 0.025-0.09, 0.03-0.08, 0.03-0.09, 0.03-0.12, 0.03-0.5, 0.03-2, 0.03-3, 0.035-0.099, 0.04-0.08, 0.04-0.09, 0.04-0.12, 0.04-0.25, 0.04-0.5, 0.04-2, 0.04-3, 0.05-0.08, 0.05-0.095, 0.05-0.1, 0.05-0.12, 0.05-0.25, 0.05-0.5, 0.05-2, 0.05-3, 0.06-0.085, 0.06-0.09, 0.06-0.1, 0.06-0.15, 0.06-0.25, 0.06-0.5, 0.06-2, 0.06-3, 0.07-0.1, 0.07-0.12, 0.07-0.15, 0.07-0.25, 0.07-2, 0.07-3, 0.08-0.12, 0.08-0.15, 0.08-0.5, 0.08-2, 0.08-3, 0.1-0.25, 0.1-0.5, 0.1-2, 0.1-3, 0.12-0.35, 0.2-0.5, 0.25-1, 0.5-2, 0.5-3, 1-3, 2-5 and 3-5 mm.

In another embodiment, the film composition for edible pads can have a final thickness of about 2.0-15.0 mm to about 18.0 mm. The resulting thickness can be from standard film forming techniques as known to the skilled artisan as well as by layering and then fusing films of any one or more of the thicknesses provided for edible packets and pads supra. The films to be layered to form the pad can be fused sequentially, simultaneously as known to the skilled artisan. Pad thickness can have a determinative impact on film dissolution, flexibility, mouth-feel, appearance, packaging for transport and the like.

The edible packages and pads can have a total weight including, but not limited to, from 0.2 g, 0.3 g, 0.4 g, and 0.5 g to ≥1.0 g, 0.5-5.0 g, 1.0-3.0 g, 3-6 g, 8.0 g, 10.0 g, 7-15 g, 7-30 g, 15-150 g, ≥1 g to 20 g, ≥5 g to 15 g, ≥5 g to 50 g, ≥40 g to 100 g, ≥7 g to 150 g, ≥10 g to 200 g, ≥100 g to 500 g, ≥200 g to 1000 g, ≥1000 g to 10.0 kg, ≥10.0 kg to 100.0 kg and ranges within each of these ranges

In one embodiment, the packaging for edible packages/pads can have in the film composition at least one of 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming agent(s) based on dry film weight of a film forming agent including, but not limited to, at least one of pectin and salts thereof, CMC including salts, cross-linked and modified forms thereof, alginates, pullulan, HPMC, guar gum, xanthan, starch, CMS including salts, cross-linked and modified forms thereof, and pb-PVOH and at least one of 15-45 1-60, 5-10, 5-35, 5-50, 5-60, 10-30, 10-35, 10-40, 10-50, 10-60, 15-25, 15-30, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) by dry film weight including, but not limited to, a plasticizer of at least one of glycerol, sorbitol, xylitol, propylene glycol, citric acid, glucose, fructose and ascorbic acid and wherein the edible packets and pads can have a thickness of at least one 0.01-3, 0.025-0.09, 0.03-0.12, 0.035-0.099, 0.04-0.25, 0.05-0.095, 0.05-0.12, 0.05-0.5, 0.06-0.085, 0.06-0.15, 0.07-2, 0.1-0.5, 0.12-0.35, 0.2-0.5, 0.25-1, 1-3, 2-5, 3-15, 5-18 mm, and pads can have a thickness of at least one of anyone of the previous measurements (mm), alone or in combination to reach a thickness of about 0.01-3, 0.025-0.09, 0.03-0.12, 0.035-0.099, 0.04-0.25, 0.05-0.095, 0.05-0.12, 0.05-0.5, 0.06-0.085, 0.06-0.15, 0.07-2, 0.1-0.5, 0.12-0.35, 0.2-0.5, 0.25-1, 1-3, 2-5, 3-15, 5-18 mm 12.5-15.0, and 15.0-18.0 mm; and wherein the edible package and/or pad can have a total weight including, but not limited to, from 0.2 g, 0.3 g, 0.4 g, and 0.5 g to ≥1.0 g, 0.5-5.0 g, 1.0-3.0 g, 3-6 g, 8.0 g, 10.0 g, 7-15 g, 7-30 g, 15-150 g, ≥1 g to 20 g, ≥5 g to 15 g, ≥5 g to 50 g, ≥40 g to 100 g, ≥7 g to 150 g, ≥10 g to 200 g, ≥100 g to 500 g, ≥200 g to 1000 g, ≥1000 g to 10.0 kg, ≥10.0 kg to 100.0 kg and wherein the edible package and/or pad easily breaks up during immersion, blending, shaking, chewing, boiling thereby releasing contents either encased by the and/or embedded within the edible package's contents and/or pads' composition, respectively and thereby provides consistent delivery of the contents/composition and no waste from the packaging or pad film due to their being compostable.

Pharmaceutical, Health and Nutrition Supplement Products Produced Using the Disclosed Films

Products made with the disclosed films can be at least one of soluble in a hydro-liquid including water (hot, cold, hot and cold), tearable and orally consumable. The product can be a Unit-Dose Package for pharmaceuticals, health and food supplements. The disclosed film can be shaped into a product in the form of a package, pad, capsule, spherical, oval, rectangular, tablet, pillow, 3D, and other shapes. The disclosed films can be formed into pre-measured packages containing/encasing a product filling including, but not limited to, oils, powders, sticky gels, pastes, creams, pharmaceuticals, foods, medical foods, and health supplements, tablets, gels, cough medicine, edible oils and mixtures thereof. Vitamins, minerals, bacteria, prebiotics, probiotics, nutraceuticals and other food supplements and additives can also be added. The product package can further optionally be orally consumed, dissolved in water (hot, cold, hot and cold) and can be torn, twisted, and/or pulled open in a conventional way to release the enclosed product and then thrown away without creating plastic waste. The product can have the advantage of offering convenience by having pre-measured quantities of the filled product, Unit-dose packaging, safety, convenience, reducing waste and excess consumption, and biodegradable and compostable packaging. The disclosed films for packaging such products eliminate generation of non-biodegradable or non-compostable wastes and so can be considered to be environmentally friendly.

Products made with the disclosed films can be shaped into soft and hard capsules for containing fillings including, but not limited to, pharmaceuticals, food, medical food and health supplements for delivery as at least one of powders, granules, particles, gels, pastes, creams, oils, mixtures and the like. The capsules can be orally consumed, dissolved in water or emptying the filling out of the capsule. The formulation of the disclosed film can be such that the capsule can be fast dissolving for oral consumption and/or also have slower dissolution or layers or pouches of varying film dissolution rates for dissolving in the gut instead of mouth and for interval/time-release of the filling(s).

In one embodiment, the film composition for personal care packaging and delivery of consumables (non-edible can have a film forming agent that is plant based, biodegradable, compostable, and free of petrochemicals. The film forming agent(s) for the personal care packaging and delivery packages can include, but are not limited to, a film composition having at least one of 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming agent(s) based on dry film weight including, but not limited to at least one of CMC including salts and cross-linked forms thereof, pullulan, alginates, guar gum, HPMC, HEC, casein, gelatin, pb-PVOH, and CMS including salts and cross-linked forms thereof. Additional film forming agents for use in either edible or non-edible applications including, but not limited to pharmaceutical, personal care are listed in Tables 1-3, supral.

In another embodiment, personal care packaging and delivery packages can have in the film composition a sugar glycol as a plasticizer including, but not limited to, glycerol, xylitol, sorbitol, propylene glycol and polyethylene glycol because each is, economical, GRAS accepted and abundant. In yet another embodiment the plasticizer can be a sugar, such as glucose or fructose. In yet another embodiment, the plasticizer can be a weak acid including, but not limited to, citric acid and ascorbic acid because each is water soluble, GRAS accepted, can promote polymer cross-linking and decrease dissolution. The film composition for personal care packaging and delivery packages can have at least one of 15-45 1-60, 5-10, 5-35, 5-50, 5-60, 10-30, 10-35, 10-40, 10-50, 10-60, 15-25, 15-30, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) by dry film weight including, but not limited to, glycerol, xylitol, sorbitol, propylene glycol, citric acid, glucose, fructose and ascorbic acid.

In one embodiment, the film composition of films for personal care packaging and delivery packages can have at least one of 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-75, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming agent(s) based on dry film weight of a FF agent including, but not limited to, at least one of CMC including salts and cross-linked forms thereof, pullulan, guar gum, alginates, and HPMC, HEC, pectins and salts thereof, casein, gelatin, CMS including salts and cross-linked forms thereof, xanthan gum and pb-PVOH; at least one of 15-45 1-60, 5-10, 5-35, 5-50, 5-60, 10-30, 10-35, 10-40, 10-50, 10-60, 15-25, 15-30, 15-45, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) by dry film weight including, but not limited to at least one of glycerol, sorbitol, xylitol, propylene glycol, polyethylene glycol, citric acid, glucose, fructose, maleic acid and ascorbic acid in the film composition of films for personal care packaging and delivery packages. The films for personal care packaging and delivery packages can have a thickness of at least one of 0.01-3, 0.025-0.09, 0.03-0.12, 0.035-0.099, 0.04-0.25, 0.05-0.095, 0.05-0.12, 0.05-0.5, 0.06-0.085, 0.06-0.15, 0.07-2, 0.1-0.5, 0.12-0.35, 0.2-0.5, 0.25-1, 1-3, 2-5 mm, and a gross weight including, but not limited to, from 0.2 g, 0.3 g, 0.4 g, and 0.5 g to ≥1.0 g, 0.5-5.0 g, 1.0-3.0 g, 3-6 g, 8.0 g, 10.0 g, 7-15 g, 7-30 g, 15-150 g, ≥1 g to 20 g, ≥5 g to 15 g, ≥5 g to 50 g, ≥40 g to 100 g, ≥7 g to 150 g, ≥10 g to 200 g, ≥100 g to 500 g, ≥200 g to 1000 g, ≥1000 g to 10.0 kg, ≥10.0 kg to 100.0 kg, because the film packaging for personal care packaging and delivery packages can be torn, twisted or pulled open in a conventional way to access and retrieve contents encased by the film packaging for personal care packaging and delivery packages and thereby provides consistent delivery of the contents and no waste from the film packaging which can be thrown away without creating landfill/plastic waste as the film can be composted.

Agricultural Products Produced Using the Disclosed Films

Products made with the disclosed films can be formed into Unit-dose packages containing seed, fertilizer mixtures and combinations thereof. The seeds and/or fertilizers can be additives to the disclosed film's compositions and/or can be encased by the film packaging. Alternatively, the seeds can be contained within individual pouches in a film-strip format for equidistant planting of the seeds encased with in the film's pouches. Alternatively, the film can also be used to pack plant pods for automated gardening systems. The pod can either be used with the film package and the film dissolves in water or the film packaging can be removed and thrown away without creating plastic waste and can become biodegraded compost. The disclosed films used as Unit-Dose packages can offer a convenient way for sowing, enabling inclusion of nutrition for the seeds. This can include, but is not limited to, a combination of one seed with fertilizers and/or many seeds with fertilizers. Alternatively, the disclosed films can be formulated for bulk packaging of seeds with the packaging dissolvable in water prior to and during the seed sowing process. Additionally, the disclosed films can be formulated to contain mulch within the film's composition and being formulated to range from rapid dissolution to slow to negligible dissolution depending on the humidity, rainfall, use of drip irrigation and moisture content of the soil and surrounding environment. The mulch film can be water-soluble independent of temperature and itself can form compost and therefore mulch for the soil because it can dissolve easily in the soil environment. Too, the use of cross-linked polysaccharide polymers as the film forming agent(s) in the film composition with or without solubility reducers can prolong the mulch film's field life, function as a weed barrier and retain soil moisture. The innovative films provide a real-world solution to the generation and disposal and/or recycling of non-petroleum-based plastic mulch. Additional forming agents for use in non-edible applications including, but not limited to detergent, cleaning, home and personal care, agricultural, industrial, manufacturing, and environmental/marking/bagging packaging are listed in Tables 2-3, supra

In one embodiment, the film composition of films for agricultural use and delivery can have at least one of 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming (FF) agent(s) based on dry film weight of the FF agent of at least one of CMC including salts and cross-linked forms thereof, pullulan, guar gum, alginates, and HPMC, HEC pectins and salts thereof, xanthan gum, casein, gelatin, CMS including salts and cross-linked forms thereof, and pb-PVOH; at least one of 15-45 1-60, 5-10, 5-35, 5-50, 5-60, 10-30, 10-35, 10-40, 10-50, 10-60, 15-25, 15-30, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) by dry film weight including, but not limited to, at least one of glycerol, sorbitol, xylitol, propylene glycol, polyethylene glycol, citric acid, glucose, fructose, malonic acid and ascorbic acid in the film composition of films for agricultural use and delivery. In one embodiment, the films for agricultural use and delivery can contain in the film composition at least one of 30-50, 20-50, 0.1-65, 10-65 wt. % of a solubility reducer of at least one of citric acid, acetic acid, maleic acid, folic acid, tartaric acid, fumaric acid, lactic acid, dilute phosphoric acid, sodium and potassium lactate salts, ascorbic acid, and sodium ascorbate. In addition, the following materials can also reduce/retard solubility: croscarmellose (cross-linked (Na+) CMC), sodium starch glycolate, lecithins extracted from soy, sunflower, rapeseed, cottonseed, eggs, milk, malonic acid, and the like, calcium salts including, but not limited to calcium lactate, calcium chloride and the like, and potentially a plant-based, cross-linked polyvinylpyrrolidone. The films for agricultural use and delivery can have a thickness of at least one of 0.01-3, 0.025-0.09, 0.03-0.12, 0.035-0.099, 0.04-0.25, 0.05-0.095, 0.05-0.12, 0.05-0.5, 0.06-0.085, 0.06-0.15, 0.07-2, 0.1-0.5, 0.12-0.35, 0.2-0.5, 0.25-1, 1-3, 2-5 mm and wherein the products and material of industry and manufacturing plus the agricultural use and delivery film packaging can have a total weight including, but not limited to, from 0.2 g, 0.3 g, 0.4 g, and 0.5 g to ≥1.0 g, 0.5-5.0 g, 1.0-3.0 g, 3-6 g, 8.0 g, 10.0 g, 7-15 g, 7-30 g, 15-150 g, ≥1 g to 20 g, ≥5 g to 15 g, ≥5 g to 50 g, ≥40 g to 100 g, ≥7 g to 150 g, ≥10 g to 200 g, ≥100 g to 500 g, ≥200 g to 1000 g, ≥1000 g to 10.0 kg, ≥10.0 kg to 100.0 kg and ≥100.0 kg to 1000.0 kg because the film packaging used for agricultural use and delivery can be torn, twisted or pulled open in a conventional way to access and retrieve contents encased by the film packaging for agricultural use and delivery and thereby provides consistent delivery of the contents and no waste from the film packaging which can be thrown away without creating landfill/plastic waste as the film can be composted.

Water-Soluble Container Products Produced Using the Disclosed Films

The disclosed films can be formulated to be shaped/formed into water-soluble bags and pouches intended to be used for water-dissolving uses. Examples of uses of the bags and pouches include, but are not limited to, laundry bags (with or without at least one of the detergent, stain removal, cleaning materials added to the film composition), bulk bags for dissolving chemicals for the purpose of cleaning large areas or safe handling in an industrial production setting, marking (with colorants, dyes, chemicals), for environmental supervision in aqueous environments (oceans, rivers, lakes), including, but not limited to, tracking and monitoring oil spills and other ecological events.

In one embodiment, the film composition of films for water-soluble container products, packaging and delivery can have at least one of 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, 90-99 wt. % of total biodegradable film forming (FF) agent(s) based on dry film weight of the FF agent of at least one of CMC including salts and cross-linked forms thereof, pullulan, guar gum, alginates, and HPMC, HEC, pectins and salts thereof, xanthan gum, casein, gelatin, CMS including salts and cross-linked forms thereof, and pb-PVOH; at least one of 15-45 1-60, 5-10, 5-35, 5-50, 5-60, 10-30, 10-35, 10-40, 10-50, 10-60, 15-25, 15-30, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, 50-70 wt. % of total biodegradable plasticizer(s) by dry film weight including, but not limited to, at least one of glycerol, sorbitol, xylitol, propylene glycol, polyethylene glycol, citric acid, glucose, fructose, maleic acid, malonic acid, and ascorbic acid in the film composition of films for i water-soluble container products, packaging and delivery. The films for water-soluble container products, packaging and delivery can have a thickness of at least one of 0.01-3, 0.025-0.09, 0.03-0.12, 0.035-0.099, 0.04-0.25, 0.05-0.095, 0.05-0.12, 0.05-0.5, 0.06-0.085, 0.06-0.15, 0.07-2, 0.1-0.5, 0.12-0.35, 0.2-0.5, 0.25-1, 1-3, 2-5 mm and wherein the products and material of industry and manufacturing plus the water-soluble container products, packaging and delivery the film packaging can have a total weight including, but not limited to, from 0.2 g, 0.3 g, 0.4 g, and 0.5 g to ≥1.0 g, 0.5-5.0 g, 1.0-3.0 g, 3-6 g, 8.0 g, 10.0 g, 7-15 g, 7-30 g, 15-150 g, ≥1 g to 20 g, ≥5 g to 15 g, ≥5 g to 50 g, ≥ 40 g to 100 g, ≥7 g to 150 g, ≥10 g to 200 g, ≥100 g to 500 g, ≥200 g to 1000 g, ≥1000 g to 10.0 kg, ≥10.0 kg to 100.0 kg and ≥100.0 kg to 1000.0 kg because the film packaging used for water-soluble container products, packaging and delivery can be torn, twisted or pulled open in a conventional way to access and retrieve contents encased by the film packaging for water-soluble container products, packaging and delivery and thereby provides consistent delivery of the contents and no waste from the film packaging which can be thrown away without creating landfill/plastic waste as the film can be composted.

### Methods

A. Lab Scale Film Formation for the Disclose Film forming compositions.

The basic method for making the disclosed film is to combine into a known volume of water about 50-80 wt. % of at least one film forming agent(s) supra with continuous stirring, ideally with a propeller-designed mixing shaft. The film forming agent(s) is added slowly to avoid clumping and to achieve uniform wetting. The mixing vessel is heated from below with the water having a temperature of between 70-90° C. to avoid bubbling and introducing air into the film forming composition. Following uniform dispersion of the film forming agent(s) the plasticizer is slowly added with continuous mixing until uniformly combined. The film forming composition can be allowed to cool with gentle stirring to a temperature of between 40-70° C. at which point any fillers, preservatives, disintegrants, effervescent additives, viscosity reducers, solubility modifiers, anti-foaming agents, anti-stickiness powders, emulsifiers, surfactants, softening agent; flavorings, colorings, fragrance agents, odor agents are added. Potentially heat-liable additives can be added at temperatures less than about 40° C. including, but not limited to vitamins, minerals, herbs, spices, prebiotics, probiotics, seeds and medications and pharmaceutical products. The inventors note that heating the film forming composition at an elevated temperature for an extended period has been shown to decrease the viscosity of the film forming agent(s). The viscosity reduction can be reversible or irreversible (depending on the material, additives and length of time at the high temperature).

The resulting film forming composition can be loaded into a syringe and using the lab scale casting method, injected into a polypropylene mold(s) at a solution temperature of about 40-70° C. Both film forming composition viscosity and gravity produces a film having uniform thickness of between about 40-100 m depending on the product application utilizing the film. The film is allowed to cool at ambient temperature for about 24 hours, cut to size and layered, folded or shaped to a final three-dimensional geometry before being filed with the product filling(s) and sealed on three, four or more or less sides or seams depending on the number of pouches and/or the desired shape of the packet, package, pod, pouch(s) and/or bags.

B. Industrial Film Formation for the Disclose Film forming compositions inventors note that at industrial scale manufacturing the film forming composition can be done by laying the film forming compositions upon a continually rolling substrate such as a carrier tape or stainless steel belt and air drying the film at elevated temperatures. Following drying the film can be rolled upon itself or on a carrier substrate for further automated forming and/or cutting at a later time/place, cut to desired size(s) and or shaped into a three-dimensional (3D) object and then filled and sealed. Such processes are known to the skilled artisan. The film can have a thickness of about: 0.01-0.09 mm, 0.01-0.5, 0.01-1, 0.01-3, 0.025-0.09, 0.03-0.08, 0.03-0.09, 0.03-0.12, 0.03-0.5, 0.03-2, 0.03-3, 0.035-0.099, 0.04-0.08, 0.04-0.09, 0.04-0.12, 0.04-0.25, 0.04-0.5, 0.04-2, 0.04-3, 0.05-0.08, 0.05-0.095, 0.05-0.1, 0.05-0.12, 0.05-0.25, 0.05-0.5, 0.05-2, 0.05-3, 0.06-0.085, 0.06-0.09, 0.06-0.1, 0.06-0.15, 0.06-0.25, 0.06-0.5, 0.06-2, 0.06-3, 0.07-0.1, 0.07-0.12, 0.07-0.15, 0.07-0.25, 0.07-2, 0.07-3, 0.08-0.12, 0.08-0.15, 0.08-0.5, 0.08-2, 0.08-3, 0.1-0.25, 0.1-0.5, 0.1-2, 0.1-3, 0.12-0.35, 0.2-0.5, 0.25-1, 0.5-2, 0.5-3, 1-3, 2-5, 3-5 mm, 3-15, and 5-18 mm. The film can be used as a wrap, in a single layer, using more than one layer, to form a jpackage, packaging, bag, mailer pouch, delivery tool, and in combinations thereof.

In one embodiment, the package can have one or more compartments and the compartments can have separate solubilities. The compartments can be created by film positioning including, but not limited to, layering an encased product or ingredient between film layers tuned to have separate solubilities, positioning tuned separate film configurations to be positioned perpendicular and/or at a diagonal of a first film to a second film to form a multi-dimension al shape e.g., a box with an exterior surface of a first solubility separate from the film(s) of a second, third or more solubility(s) separate which form one or more of an interior section(s), divider(s), layer(s) inside the box.

A modified method of producing softgel capsules using a rotary die can be used to produce such products on a larger scale. Prior to forming capsules, the film can be first produced and then humidified to give enough stretchability and stickiness for it to be fed to the softgel machine. Various automated manufacturing methods can be employed, including but not limited to solution casting, tape casting and other methods as known to the skilled artisan.

The inventors have developed processes for producing and shaping the disclosed films. The film composition comprising at least a film forming agent and plasticizer can be slowly added to a solvent, which generally is water and could also be another polar or hydrous liquid that enables dissolution of the ingredients. The gradual addition and previous mixing of the ingredients helps to avoid lump formation caused by too rapid hydration of the ingredients, in particular the film forming agent. Stirring and heating the solution can be applied for faster dissolution. Vacuum can be used to remove trapped air bubbles from the solution. Ideally, the viscosity of the film composition's slurry can be optimal for the machine used to produce/fabricate the film and can be dependent on the thickening properties of the ingredients, amount of solvent and the desired thickness of the resulting film. The film can be formed by solution casting the slurry and can be then dried at ambient or elevated temperatures. The thickness of the dry film can be from 5 μm to 400 μm, although thicknesses from 35 μm to 200 μm can be suitable for most applications. Additional film thickness can be from 0.01 mm to at least 3.0 mm as described supra. The film can be later laminated or coated to improve the properties of the film.

For films that may be rolled up following formation, to avoid a sticky or tacky film surface that could be averse to further handling or shaping and/or for ease of handling following cutting, i.e., for layering, shaping, laminating and the like, the film can be lightly spray coated, dusted or otherwise applied a powder such as corn starch, potato starch, tapioca (cassava starch), rice starch. For non-edible applications, talc can also be used.

In another method, the film can also be produced by other film producing methods, including, but not limited to, thermoplastic methods, extrusion, casting, and film blowing (for bag formation). Thermoplastic methods work better if the dry film ingredients can be mixed with a small amount of solvent or assisting additives including, but not limited to plasticizers and water, resulting in a decrease in the temperature needed to have the components melt/dissolve in the solvent as compared to the degradation temperature of each individual component, in particular the film forming agent/material. The film can also be formed by spraying the solution onto a substrate and letting it dry.”

Many methods, such as methods for making a film, film producing methods such as thermoforming a film and methods for shaping films are well known in the art. Films can be shaped to produce for example films with pouch configurations, multi-compartments. For example, U.S. Pat. No. 9,133,329 teaches these methods and is incorporated herein by reference.

C. Determination of Film Tensile Strength

The tensile strength of the disclosed films can be determined according to the recognized standards and testing methods including, but not limited to ISO 527-3: 1995, incorporated herein by reference.

D. Determination of Tear Resistance

The tear resistance of the disclosed films can be determined according to the recognized standards and testing methods including, but not limited to ASTM D1938-14, incorporated herein by reference.

E. Wash-Residue Test

A test to determine film dissolution and disintegration in washing applications is taught in for example, U.S. Pat. No. 9,133,329 teaches such methods and is incorporated herein by reference. This test can be used for detergent pods and the like as known to the skilled artisan.

F. Film Leak/Dissolution Test

A test to determine integrity of a film and its resistance to disintegration due to materials, e.g., detergent, encased in a film package can be assessed in a Film Leak a.k.a. Pinhole test. The Pinhole Test is taught in for example, U.S. Pat. No. 9,133,329 which is incorporated herein by reference. This test can be used for detergent pods and the like as known to the skilled artisan.

G. Film Sealing

Any suitable method of sealing a film pouch, packet, package as well as film objects having individual multi-compartments thereof may be utilized. Non-limiting examples of such means and methods include, but are not limited to, heat sealing, solvent welding, solvent or wet sealing, and utilizing processes including, but not limited to pressure, moisture, UV, infrared, laser light beam and combinations thereof as known to the skilled artisan. Typically, only the area which is to form the seal is treated. The sealing process can be applied by any method, typically on the closing material, and typically just to the areas which can form the seal. With wet or solvent sealing/welding methods, heat can also be applied. Preferred wet or solvent sealing/welding methods include selectively applying solvent onto the area between the molds, or on the closing material, by for example, spraying or printing this onto these areas, joining the film to be sealed and then applying pressure onto these areas, to form the seal and can then be cut to size. Sealing rolls and belts as known to the skilled artisan (optionally also providing heat) can also be used, for example.

H. Film(s) Constructed as Pads

Films of any thickness as disclosed supra can be layered, stacked, piled atop one another to form a “pad” as disclosed herein. The pad can comprise a plurality of film(s) and the film composition can have at least one of a pre-measured foodstuff including, but not limited to, an edible, nutritional supplement(s), wellness supplement(s), medicinal food(s), food supplement(s), pharmaceutical(s), nutraceutical supplement(s), coloring/flavoring agent(s), and fragrance/odor agent(s).

The assembled film(s) can be fused together in sequential, simultaneous, by application of pressure, in a vacuum press, by applied pressor including, but not limited to weight, heat and the like, and other means known to the skilled artisan.

### EXAMPLES

The disclosed films can be described in more detail by way of Examples. However, the present invention is not limited to these Examples.

### Example 1. Water-Solubility of the Disclosed Films

A strip of water-soluble film (45 mm×10 mm×70 m film thickness) was partially submerged into 10 ml of 50° C. water. The film composition was 67 wt. % low viscosity carboxymethyl cellulose sodium as the film forming agent (CAS No. 9004-32-4, Catalog No. C5678, Sigma-Aldrich, 50-200 cPs at 4% in H₂O, with the degree of substitution at 0.65-0.9) with 24 wt. % of xylitol (Sigma-Aldrich) as plasticizer and 9 wt. % beet juice powder (Essential Labs, Portland, Oreg.). The film was formed by “lab scale casting” as describe supra.

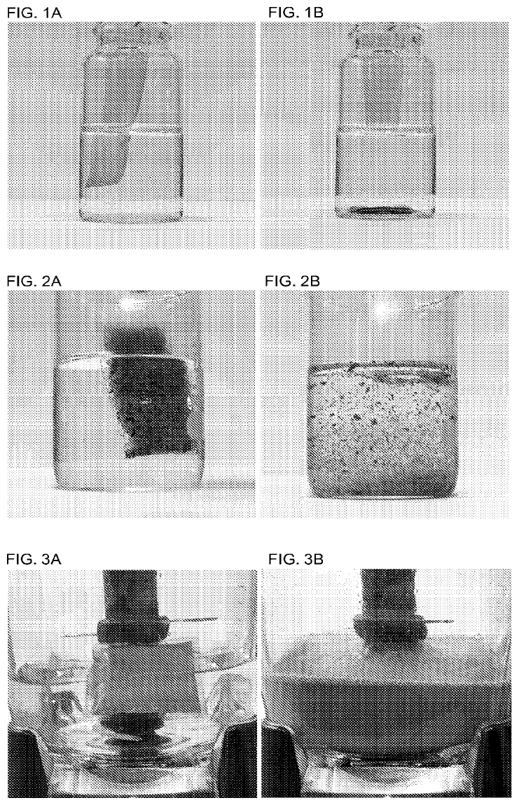

Half of the film was immersed in water (FIG. 1A). The dissolution of the submerged film was visible in just 15 sec. (FIG. 1B).

### Example 2. Water-Solubility of the Disclosed Flavoring Packet

The film composition was composed of 83 wt. % low viscosity carboxymethyl cellulose sodium film forming agent (CAS No. 9004-42-4, Catalog No. 21901, Sigma-Aldrich, 15-50 cPs at 4% in H₂O, with the degree of substitution at 0.6-0.95) and 17 wt. % glycerine (Sigma-Aldrich) as the plasticizer. The film was formed by “lab scale casting” as describe supra, cut to size (56 mm×43 mm×45 μm film thickness) and folded upon itself to form a flavouring packet (28 mm×43 mm). The packet was sealed on two sides using an Impulse 8-Inch Manual Hand Bag Sealer (iHotools, Part No. 01 BS-002U-81NB) and filled with 1.2 μm of a mixture of herbs, granulated spices, salt and black pepper and then sealed from the third side. The entire flavouring packet was then submersed into 45 ml 90° C. water (FIG. 2A). The sealed flavoring packet completely dissolved in after just 20 sec. (FIG. 2B) releasing the flavouring mixture into the water. No packaging waste was generated due to the edible, dissolvable properties of the disclosed film.

### Example 3. Blendability and Water-Solubility of the Disclosed Film as a Pre-Measured Superfood Package

The film composition was 66 wt. % amidated low methoxyl Pectin (CAS No. 9057-02-7, TIC Pretested® Pectin LM 35 Powder, TIC Gums, White Marsh, Md.) film forming agent plus 34 wt. % of xylitol (Sigma-Aldrich) as the plasticizer. The film was formed by “lab scale casting” as describe supra, two films were cut to size (55 mm×55 mm×70 μm film thickness). The two films were aligned and sealed on three sides as descripted in Example 2, then about 7 μm powdered superfood mixture (Amazing Grass Green Superfood Organic Powder with Wheat Grass and 7 Super Greens, Amazing Grass, Newport Beach, Calif.) was added into the open fourth side followed by sealing the fourth side to form a closed film package. It is noted that the film composition can also include colorants and nutritional additives which can be part of the superfood itself.

The resulting blendable pre-measured superfood package was placed in a countertop blender containing 450 ml water at 25° C. (FIG. 3A) and blended at a continuous “pulse” 10 seconds. After only 10 sec. the superfood package was completely dissolved and the contents dispersed into the water (FIG. 3B). All materials were completely edible and dissolved in the resulting blended superfood shake with no waste materials generated in the preparation.

### Example 4. Water-Solubility of the Disclosed Laundry Detergent Package

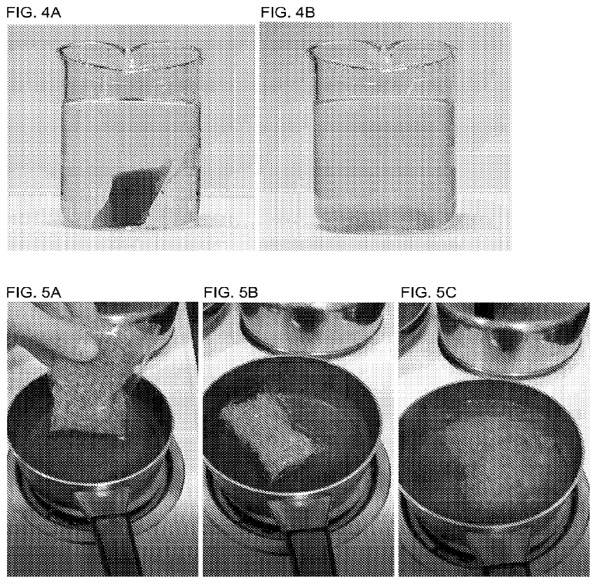

The film composition was composed of 55 wt. % medium viscosity carboxymethyl cellulose sodium (CMC, CAS No. 9004-42-4, Catalog No. AC332611000, 2300 cPs at 2% in H₂O, degree of substitution 0.65-0.9, Acros Organics, Gell, Belgium) as the film forming agent and 45 wt. % of sorbitol (Sigma-Aldrich) as plasticizer. The film was formed by “lab scale casting” as describe supra, cut to size (52 mm×50 mm, 80 μm film thickness), the film was then folded in half to form a rectangle (52 mm×25 mm×80 μm film thickness) and the package was sealed on two sides as descripted in Example 2. 5 μm gelled detergent (extracted from a Tide PODS containing Laundry Detergent Original Scent) was added into the open fourth side followed by sealing to form a film package. The entire detergent package was then submersed into 90 ml 25° C. water (FIG. 4A).

The disclosed laundry detergent package formed from the disclosed film substantially dissolved after just 60 sec. (FIG. 4B) releasing the laundry detergent into the water. The film can be totally dissolved during normal washing machine wash cycles (figure not shown). No residue would be expected to remain on the washed articles due to the rapid dissolution of the disclosed film and no packaging waste was generated due to the film's total dissolvable properties. Additionally, the CMC-Na is known to suspend in the wash water dirt and materials that soil dirty articles which leads to a more thorough removal of stains/soiled spots/areas from the washed articles.

### Example 5. High Moisture Fillers Packaged Inside the Disclosed Film as a Snack and/or Beverage Product

The film composition was 50 wt. % low viscosity carboxymethyl cellulose sodium as the film forming agent (CAS No. 9004-32-4, Catalog No. C5678, Sigma-Aldrich, 50-200 cPs at 4% in H₂O, with the degree of substitution at 0.65-0.9) plus 50 wt. % of citric acid (SKU MIL-CTRCACD-5-A, Milliard Pure Food Grade Citric Acid, Milliard, Lakewood, N.J.) as the plasticizer. The film was formed by “lab scale casting” as describe supra, cut to size (55 mm×50 mm×90 μm film thickness) and folded upon itself to form a Snack packet (55 mm×25 mm). The packet was filled with 2-3 gm yogurt (Cherry Activia, Groupe, Danone, The Dannon Company Inc., Pittston, Pa.) and sealed on three sides as descripted in Example 2. Alternatively, the film can be formed into hemispheres, filled with yogurt and the hemispheres joined and sealed to create spherical yogurt packages.

Despite the high water content of about 70-80 wt. % in the yogurt, the film's solubility was significantly reduced due to the acidity of the citric acid, which delays dissolution of the film packaging. Alternatively, using cross-linked CMC-Na and/or CMS-Na as the film forming agent alone or in combination could be used to produce the film having similar properties (packaging not shown).

### Example 6. Packaging of Sticky and High Tacticity Sweetener Inside the Disclosed Film as a Sweetener and/or Flavoring Product

The film composition was 75 wt. % Pullulan (CAS No. 9057-02-7, Product No. P0978, TIC America, White Marsh, Md.) film forming agent plus 25 wt. % of xylitol (Sigma-Aldrich) as the plasticizer. The film was formed by “lab scale casting” as describe supra, cut to size (70 mm×30 mm×70 m film thickness), then folded in half to form a rectangular 70 mm×15 mm package and sealed on two sides as descripted in Example 2. Alternatively, two identical films (55 mm×55 mm×70 m film thickness) were shaped into two hemispheres. The rectangular package shape was filled with about 6 gm honey (Market Pantry Pure Honey, Target Inc.) in the open fourth side followed by sealing and 2 gm honey was added to each hemisphere, the two hemispheres were joined at the equator to form a sphere and sealed. It is noted, that a modified method of producing softgel capsules using a rotary die can be used to produce spherical products on a larger scale.

The resulting honey package was completely soluble in hot coffee and tea as well as a cold beverage with no noticeable after-taste or residue left on the palate. All materials were completely edible and dissolved. Producing a single use honey package results in no waste materials generated by using the disclosed film for packaging.

### Example 7. Hot Water-Solubility of the Disclosed Film as a Pre-Measured Food Package

The film composition was composed of 70 wt. % low viscosity carboxymethyl cellulose sodium (CMC-Na) as the film forming agent (CAS No. 9004-32-4, Catalog No. C5678, Sigma-Aldrich, 50-200 cPs at 4% in water, with the degree of substitution at 0.65-0.9), 7 wt. % of maltodextrin (Maltodextrin Powder, Nutricost, Vineyard, Utah) and 23 wt. % of glycerin (Sigma-Aldrich) as the plasticizer. The film was made on an industrial film production casting machine and dried using bottom heating and hot air at about 80 C. The film was cut (140 mm×120 mm×100 m film thickness) and folded upon itself to form a packet (120 mm×70 mm). The packet was filled with 100 gm of a mixture of rice and flavorings and sealed on three sides as descripted in Example 2 (FIG. 5A). The entire packet was then submersed into a pot containing 500 ml boiling water (FIG. 5B).

The package was substantially dissolved in boiling water (FIG. 5C) after 15 seconds. After cooking the rice, there was no noticeable after-taste or residue left on the palate following eating the flavoured rice. All packaging and filling materials were completely edible and the resulting package had no waste materials generated during the food preparation.

While the principles of the disclosed films have been described in connection with specific embodiments, it should be understood clearly that these descriptions are made only by way of example and are not intended to limit the scope of the disclosed films. What has been disclosed herein has been provided for the purposes of illustration and description. It is not intended to be exhaustive or to limit what is disclosed to the precise forms described. Many modifications and variations will be apparent to the practitioner skilled in the art. What is disclosed was chosen and described in order to best explain the principles and practical application of the disclosed embodiments of the art described, thereby enabling others skilled in the art to understand the various embodiments and various modifications that are suited to the particular use(s) contemplated. It is intended that the scope of what is disclosed be defined by the following claims and their equivalence.

1. A film for packaging and delivering a foodstuff(s) or consumable(s) comprising:
35-85 wt. % biodegradable film forming agent(s), based on dry film weight;
5-60 wt. % biodegradable plasticizer(s), based on dry film weight;
wherein the film also contains the foodstuff(s) or consumable(s);
wherein the film has an essential absence of petrochemicals and non-biodegradable bioplastics;
wherein the film is soluble in one or more of a cold (1-25° C.), cool (25-35° C.), warm (35-50° C.), and hot (50-100° C.) hydro-liquid in 5 seconds to 120 seconds; and
wherein the film is compostable.

2. The film for packaging of claim 1, wherein the film forming agent and plasticizer are derived essentially from plant-based materials.

3. (canceled)

4. The film for packaging of claim 1, wherein the film encases the foodstuff(s) and/or consumable(s).

5. The film for packaging of claim 1, wherein the biodegradable film forming agent is at least one of pectin, carboxymethyl cellulose, alginate, a polysaccharide, hydrolyzed collagen, plant-based polyvinyl alcohol (pb-PVOH), casein, and derivatives and salts and modified forms thereof.

6. The film for packaging of claim 5, wherein the polysaccharide is at least one of pullulan, algin, guar gum, xanthan gum, carrageenan, starch, agar, hydroxyethyl cellulose, hydroxypropyl methyl cellulose (HPMC), and salts thereof.

7. The film for packaging of claim 1, wherein the biodegradable plasticizer is at least one of glycerol, sorbitol, xylitol, glucose, fructose, propylene glycol, trehalose, citric acid, ascorbic acid, isomalt, maltitol, steviol glycoside, maltodextrin, mannitol, erythritol, arabitol, lactitol, threitol, ribitol, galactitol, fucitol, iditol, inositol, volemitol, maltotetraitol, polydextrose, polyethylene glycol, triacetin, diethylene glycol, dipropylene glycol.

8. (canceled)

9. (canceled)

10. (canceled)

11. (canceled)

12. The film of claim 1, wherein the film composition optionally further comprises one or more of 1-15 wt. % and 0.1-55 wt. % of total anti-sticky/tacky powders on and/or within at least one surface of the film.

13. The film of claim 1, wherein the film composition comprises at least one of 40-75, 5-15, 5-25, 5-30, 5-35, 5-95, 5-99, 15-40, 15-95, 25-55, 25-75, 25-80, 25-95, 30-85, 30-90, 35-45, 35-55, 35-85, 35-80, 35-95, 40-60, 40-85, 40-90, 45-55, 45-70, 45-80, 45-85, 45-90, 50-60, 50-70, 50-85, 55-75, 60-70, 60-80, 70-80, 70-82, 70-85, 70-90, 70-95, 75-95, 80-90, 80-95, and 90-99 wt. % of total biodegradable film forming agent(s) based on dry film weight.

14. The film of claim 1, wherein the film composition comprises at least one of 15-45, 1-60, 5-10, 5-35, 5-50, 5-60, 10-30, 10-35, 10-40, 10-50, 10-60, 15-25, 15-30, 15-55, 18-25, 18-28, 18-40, 20-30, 20-35, 20-40, 20-50, 22-45, 22-60, 25-40, 26-55, 30-40, 30-45, 30-50, 30-60, 35-60, 40-55, 40-60, 45-60, and 50-70 wt. % of total biodegradable plasticizer(s) by dry film weight.

15. The film of claim 1, wherein the hydro-liquid is at least one of water, vegetable juice, fruit juice, milk, liquid yogurt, smoothie, cream, coffee, tea, vinegar, wine, beer, cider, spirits, soft drink, broth, stock, and soup.

16. (canceled)

17. The film of claim 1, wherein the film is edible.

18. (canceled)

19. The film of claim 1, wherein optionally, the film contains at least 0.1-55 wt. %, 0.1-70 wt. %, 20-51 wt. %, 10-35 wt. %, 5-40 wt. %, and 0-75 wt. % total of at least one foodstuff and/or consumable by dry film weight.

20. (canceled)

21. The film for packaging of claim 17, wherein the film composition further optionally contains 0.1-51 wt. %, 20-51 wt. %, 10-35 wt. %, 5-40 wt. %, and 0-75 wt. %+/−20 wt. % nutritional supplement(s), wellness supplement(s), food supplement(s), medicinal food(s), pharmaceutical(s), nutraceutical supplement(s) and 0.1-51 wt. %, 20-51 wt. %, 10-35 wt. %, 5-40 wt. %, and 0-75 wt. %+/−20% coloring/flavoring agent(s), fragrance/odor agent(s), based on dry film weight.

22. (canceled)

23. The film for packaging of claim 17, wherein the film package encases a foodstuff selected from at least one of a powder, dry ingredient, flavoring(s), sweetener(s), high moisture foodstuff(s), oil(s), grain(s), cereal(s), vegetable(s), fruit(s), meat(s), nut(s), food supplement(s), medicinal food(s), pharmaceutical(s), nutraceutical supplement(s).

24. (canceled)

25. The film for packaging of claim 1, wherein the packaging comprises at least one of a package, packet, pad, pouch, pillow, 3D shape, envelope, film, bag, geometric object, unit dose package and a capsule.

26. The film for packaging of claim 1, wherein the packaging comprises one or more compartments.

27. The film for packaging of claim 26, wherein an at least first film compartment has a first solubility and an at least second film compartment has a second solubility.

28. (canceled)

29. (canceled)

30. (canceled)

31. (canceled)

32. (canceled)

33. (canceled)

34. The film for packaging of claim 1, wherein the film packaging forms at least one of a blendable packet, superfood package, smoothie package, flavoring packet, sweetener packet, orally consumable package, premeasured foodstuff packet, and a beverage concentrate packet.

35. (canceled)

36. (canceled)

37. (canceled)

38. The film for packaging of claim 1, wherein the film thickness is at least one of 0.01-0.09 mm, 0.01-0.5, 0.01-1, 0.01-3, 0.03-0.08, 0.03-0.09, 0.03-0.12, 0.03-0.5, 0.03-2, 0.03-3, 0.04-0.08, 0.04-0.09, 0.04-0.12, 0.04-0.25, 0.04-0.5, 0.04-2, 0.04-3, 0.05-0.08, 0.05-0.1, 0.05-0.12, 0.05-0.25, 0.05-0.5, 0.05-2, 0.05-3, 0.06-0.09, 0.06-0.1, 0.06-0.15, 0.06-0.25, 0.06-0.5, 0.06-2, 0.06-3, 0.07-0.1, 0.07-0.12, 0.07-0.15, 0.07-0.25, 0.07-2, 0.07-3, 0.08-0.12, 0.08-0.15, 0.08-0.5, 0.08-2, 0.08-3, 0.1-0.25, 0.1-0.5, 0.1-2, 0.1-3, 0.5-2, 0.5-3, 1-3, 2-5 and 3-5 mm and multiples and combinations of films thereof.

39. (canceled)

40. (canceled)

41. (canceled)

42. The film for packaging of claim 1, wherein the package encases a powder of at least one of a superfood, fruit, vegetable, berry, mushroom, plant, protein, dried fruits, dried plants, dried vegetables, dried berries, dried mushrooms, seeds, nuts, vitamins, minerals, food supplements, smoothie, soft drink powder, drink, sports drink, concentrated beverage, concentrated beverage syrups, energy gels, honey, syrup, tea leaves, coffee, cocoa, herbs, spices, rice, pasta, food oils, mixes of spices and/or flavorings and/or food oils with grains.

43. (canceled)

44. (canceled)

45. The film for packaging of claim 1, wherein the foodstuff is one or more of a sticky or jellied food product, honey, syrup, sports gel, energy gels, beverage concentrates, flavorings, herbs/spices, sugar, salt/pepper, curry, food colorants and combinations thereof, superfood/smoothie/protein powders, juices, soft drinks, beverage powders, flavorings, oils selected from lemon, hazelnut, almond, and other nuts, colorants.
